(19) United States
(12) Patent Application Publication
(10) Pub. No.: US 2023/0061063 A1
(43) Pub. Date: Mar. 2, 2023

(54) CERAMIC FOAM-FIBER COMPOSITES, METHODS OF MAKING SAME, AND USES THEREOF

(71) Applicant: THE RESEARCH FOUNDATION FOR THE STATE UNIVERSITY OF NEW YORK, Amherst, NY (US)

(72) Inventors: Shenqiang REN, Williamsville, NY (US); Lu AN, Buffalo, NY (US)

(21) Appl. No.: 17/758,621

(22) PCT Filed: Jan. 11, 2021
(86) PCT No.: PCT/US2021/012998

§ 371 Date: Jul. 11, 2022

Related U.S. Application Data
(60) Provisional application No. 62/959,907, filed on Jan. 11, 2020.

(51) Int. Cl. C04B 35/80; C04B 38/00; C04B 38/02; C04B 35/10; C04B 35/14

(52) U.S. Cl. CPC C04B 35/80; C04B 38/0054; C04B 38/007; C04B 38/02; C04B 35/10; C04B 35/14; C04B 2235/3217; C04B 2235/3418; C04B 2235/5216

(57) ABSTRACT

Ceramic foam fiber composites, methods of making ceramic foam fiber composites, and uses of ceramic foam fiber composites. The ceramic foam fiber composites may be made by contacting one or more fiber(s); one or more ceramic precursor(s); one or more pore-forming gas-forming additive(s) (one or more inert gas-generating agent(s)); one or more catalyst(s); and, optionally, one or more additive(s), where the contacting is results in formation of an inert gas and the ceramic foam-fiber composite is formed. A ceramic foam-fiber composite may include a plurality of fibers, where at least a portion or all of the fibers individually comprise a ceramic foam disposed on at least a portion or all of a surface of the fiber. A ceramic foam-fiber composite may exhibit one or more or all of the following: thermal stability, mechanical strength, soundproof/acoustic insulation characteristics. A ceramic foam-fiber composite material may be used as a building material.

### CROSS REFERENCE TO RELATED APPLICATIONS

This application claims priority to U.S. Provisional Application No. 62/959,907, filed on Jan. 11, 2020, the disclosure of which is hereby incorporated by reference.

### STATEMENT REGARDING FEDERALLY SPONSORED RESEARCH

This invention was made with government support under contract no. DE-EE0008675 awarded by the U.S. Department of Energy. The government has certain rights in the invention.

### BACKGROUND OF THE DISCLOSURE

Flexible, high-temperature, and lightweight thermal insulation materials are ubiquitous in thermal management and protection systems, and space exploration. Ceramic aerogels promise high-temperature thermal insulation, but lack mechanical flexibility, while the fibrous materials with desirable mechanical elasticity display modest thermal insulation.

High-temperature thermal insulation materials (ceramic foams, mineral wool, and aerogels) are important for thermal management and protection systems. As one of the emerging insulation materials, ceramic aerogels composed of pearl necklace-like nanoparticles feature low density, high porosity, chemical inertness, and high specific surface area. However, its inadequate structural continuity leads to mechanical brittleness and flaw sensitivity, which limits high temperature flexible thermal insulation applications. Though fibrous thermal insulation materials promise mechanical flexibility, modest high-temperature thermal insulation, and flame retardance, it does not satisfy the requirement of thermal stability and material reliability. To meet the rapidly evolving needs of flexible thermal insulation under extreme conditions (e.g., high temperature), it is important to design insulation materials featuring a combination of high temperature thermal radiative, conduction, and convection resistance, while maintaining mechanical flexibility and lightweight.

The thermal conductivity and mechanical properties of insulation materials can be controlled by their nanoscale structure. Materials with low density, nanoporous structures (<68 nm), and radiation absorption elements that reduce the conduction in solids, reduce conduction and convection in air, and retard thermal radiation, respectively, could endow the favorable thermal superinsulation performance under a high-temperature environment. Previously, all-ceramic thermal insulation fiber composites were prepared to show compressive elasticity and anisotropic room temperature thermal conductivity due to the layer-by-layer assembly of aerogel-fiber composites. The desirable room temperature thermal insulation performance mainly results from the reduced thermal convection and conduction of solid and gaseous components in aerogel-fiber composites. However, it is still a challenging task to achieve flexible high-temperature thermal insulation performance.

### SUMMARY OF THE DISCLOSURE

In an aspect, the present disclosure provides methods of making ceramic foam-fiber composites. The composites have a ceramic foam disposed on at least a portion of the individual fibers of the composites. The ceramic foam may be a silica aerogel. The methods are based on in-situ generation of a pore-forming gas and reaction of the precursor(s), which may be in a sealed environment (e.g., reaction a greater than ambient pressure), which may be carried out in the presence of fibers. The ceramic foams or ceramic foam-fiber composites may be formed under hydrothermal conditions.

In various examples, a method for forming a ceramic foam-fiber composite (e.g., a silica aerogel-fiber composite) comprises: contacting (e.g., in a reaction mixture, which may be in a sealed environment, which may be a sealed vessel) a plurality of one or more types of fiber(s); one or more ceramic precursor; one or more pore-forming gas-forming additive(s) (one or more inert gas-generating agent(s)); one or more catalyst(s); and optionally, one or more additive(s), where the contacting results in formation of an inert gas (e.g., carbon dioxide and the like) and a plurality of fibers, each fiber having a ceramic foam layer disposed on at least a portion of the fiber. The ceramic foam may be formed under hydrothermal conditions. The ceramic foam-fiber composite may be subjected to ambient pressure drying (APD). After formation of the ceramic foam-fiber composite, the composite may be sintered. In various examples, a method further comprises post-ceramic foam formation modification of at least a portion of a surface of the ceramic foam of the ceramic-foam composite.

A ceramic foam material may be a composite material (e.g., a composite ceramic foam). The composite material may comprise a polymer material (which may be referred to as a hybrid composite material or hybrid ceramic foam) in a portion of or all of the pores of the ceramic foam.

Formation of the ceramic foam may comprise a thermal annealing step. The thermal annealing step may be carried out after the ceramic foam is formed, washed, dried, etc.

A method of the present disclosure may further comprise forming composite sheets. In various examples, a composite sheet is made by forming a mixture which may be referred to as a pulp mixture, and may be the reaction mixture in which the ceramic aerogel-fiber composites are formed after the composite is formed) comprising one or more ceramic foam-composite and water are mixed and spread across a large mesh screen, to remove the water for the formation of wet sheets.

In an aspect, the present disclosure provides ceramic foam-fiber composites. The ceramic foam-fiber composites comprise a plurality of fibers, where at least a portion or all of the fibers individually comprise a ceramic foam disposed on at least a portion or all of a surface of the fiber. The ceramic foams of the ceramic-foam composites may be ceramic foam films. The films may be continuous or formed from a plurality of particles. The ceramic foams may be referred to as ceramic aerogels. A ceramic foam may be a silica aerogel. Non-limiting examples of ceramic foams are provided herein. A ceramic foam material (e.g., a ceramic foam composite material) comprises a ceramic foam. A ceramic foam comprises matrix of ceramic material. A ceramic foam may be made by a method of the present disclosure.

The ceramic foam may be in the form of a layer. The layer may be continuous or discontinuous.

The ceramic foam of the ceramic foam-fiber composite is porous and exhibits a hierarchical, gradient pore structure. A ceramic foam of a ceramic foam-fiber composite may be a composite material (e.g., a composite ceramic foam).

The ceramic foam-composite material may be in the form of a sheet. The ceramic foam of the ceramic foam-composite may be infiltrated in a substrate formed from a plurality of fibers.

In an aspect, the present disclosure provides uses of ceramic foam-fiber composite(s) of the present disclosure. The ceramic foam-fiber composites can be used in a variety of applications. A ceramic foam-fiber composite may be a superinsulation material or provide superinsulation. In an example, a ceramic foam-fiber composite is used as an insulating material (e.g., a building material or soundproofing material). In an example, a ceramic foam-fiber composite is used as a template or the support substrates for coating with other functional materials as the composites in the applications for the catalyst, membrane, separation, and the like.

### BRIEF DESCRIPTION OF THE FIGURES

For a fuller understanding of the nature and objects of the disclosure, reference should be made to the following detailed description taken in conjunction with the accompanying figures.

FIG. 1 shows schematic illustrations of the synthesis of fiber-silica aerogel paper via (A) silica precursor approach and (B) silica aerogel approach.

FIG. 2 shows (A) optical image of paper with EcoTouch® PINK® Fiberglas™. Dimension: 30*30*0.3 cm. (B) Optical image of paper with Unifrax® C-08. Dimension: 30*30*2.7 cm.

FIG. 3 shows structure characterization of fiber-silica aerogel paper. (a) XRD pattern of silica aerogel, fiber aerogel paper mats with and without heat treatment (400° C.). (b) Typical TEM image of silica aerogel, inset is the diffraction pattern showing amorphous structure. (c) Out of plane SEM images of fiber-aerogel paper via precursor approach. (d) Out of plane SEM images of fiber-aerogel paper via aerogel approach. (e) In plane of SEM image of fiber-aerogel layer stacks. Contact angel for (f) Out of plane and (g) in plane of fiber-aerogel paper after coating, and the insert is the water uptake before and after coating.

FIG. 4 shows (A) a SEM image that shows intercalation between gel and Unifrax® E-08 under high resolution around 5 micros. (B) A SEM image that shows intercalation between gel and EcoTouch® PINK® Fiberglas™.

FIG. 5 shows relationship between thermal conductivity (tested under ASTM C518 standard) and reaction time of gel (SDS).

FIG. 6 shows mechanical properties of fiber-aerogel papers. (a) Multiple uniaxial compression on out of plane direction of 41 wt % fiber-aerogel papers with recoverable strain after 400° C. sintering. (b) A 100 cycle fatigue test with compressive strain of 50%. (c) Young modulus, the strength, and relative height for 100 compression cycles. (d) Strength vs. sintering temperature T for 41 wt % fiber-aerogel papers. (e) Compressive strength vs. fiber concentration and density vs. fiber concentration. (f) In-plane compression stress vs. strain curve of 41 wt. % fiber-aerogel paper.

FIG. 7 show thermal properties of fiber-aerogel paper mats. (a) Thermal conductivity and R-value vs. fiber concentration. (b) Thermal conductivity and R-values vs. sintering temperature. (c) In-Plane thermal conductivity vs. sintering temperature for 41 wt. % fiber paper mat. (d) Thermal conductivity of humidity cycling measurement at 60% and 80% humidity environment.

FIG. 8 shows (a) soundproof performance of different fiber-aerogel papers with 15 wt %, 41 wt % and 82 wt % fibers under sound frequency from 500 Hz to 3000 Hz. (b) Soundproof performance of fiber-aerogel papers under frequencies of 2000 Hz. (c) Soundproof performance plot of sound intensity of 500 Hz, 800 Hz, 2000 Hz and 3000 Hz.

FIG. 9 shows an example of a R2R process of the present disclosure coupled with in-situ APD manufacturing low-cost silica aerogel.

FIG. 10 shows scanning electron microscopy (SEM) images of an example of a silica aerogel of the present disclosure.

FIG. 11 shows SEM images of an example of a silica aerogel of the present disclosure.

FIG. 12 shows EDX images of an example of a silica aerogel of the present disclosure.

FIG. 13 shows EDX images of an example of a silica aerogel of the present disclosure.

FIG. 14 shows thermal images of an example of a silica aerogel produced using the method described in Example 1.

FIG. 15 shows an image of an example of a silica aerogel produced using the method described in Example 2 being heated demonstrating fire-retardant property of the silica aerogel.

FIG. 16 shows an image of an example of a silica aerogel of the present disclosure and an image of a carbon-material coated silica aerogel of the present disclosure.

FIG. 17 shows images of examples of silica aerogels produced using the method described in Example 2 ((A) is a white silica aerogel produced using TEOS as the silica precursor and (B) is a transparent silica aerogel produced using MTMS as the silica precursor) and images (C) and (D) of thermally treated white silica aerogel (B) under different conditions. The thermal treatment was carried out in a tube furnace.

FIG. 18 shows thermal conductivity data for examples of silica aerogel produced using the method described in Example 2 (and TEOS as the silica precursor). The equation used for heat resistance is: q=P/A*d/AT, where P/A was recorded by the FluxTap, d is the thickness of the sample, and ΔT is calculated by minus the readings of the two temperature sensor.

FIG. 19 shows an SEM image of an example of a white silica aerogel produced using the method described in Example 2 (and TEOS as the silica precursor). The image shows the porous structure on the white silica aerogel surface.

FIG. 20 shows an SEM image of an example of a white silica aerogel produced using the method described in Example 2 (and TEOS as the silica precursor). The image shows the porous structure on the white silica aerogel side surface.

FIG. 21 shows an SEM image of an example of a white silica aerogel produced using the method described in Example 2 (and TEOS as the silica precursor). The image shows the porous structure on the white silica aerogel surface.

FIG. 22 shows an SEM image of an example of a white silica aerogel produced using the method described in Example 2 (and TEOS as the silica precursor). The image shows the porous structure on the white silica aerogel surface. The pore structure includes smaller pores and larger pores.

FIG. 23 shows an SEM image of an example of a white silica aerogel produced using the method described in Example 2 (and TEOS as the silica precursor).

FIG. 24 shows an SEM image of an example of a transparent silica aerogel produced using the method described in Example 2 (and MTMS as the silica precursor). The image shows the porous structure on the white silica aerogel surface.

FIG. 25 shows an SEM image of an example of white silica aerogel produced using the method described in Example 2 (and TEOS as the silica precursor) which was heated at 400° C. for 3 hours. The image shows the porous structure on the white silica aerogel surface.

FIG. 26 shows images describing mechanical testing of silica aerogel samples of the present disclosure.

FIG. 27 shows mechanical test data for example of white silica aerogel produced using the method described in Example 2 (and TEOS as the silica precursor). The material has a Young's modulus of 7.6054 MPa.

FIG. 28 shows porosity data obtained using a pycnometer for example of white silica aerogel produced using the method described in Example 2 (and TEOS as the silica precursor). The material has porosity of 89.587%.

FIG. 29 shows porosity data obtained using a pycnometer for example of transparent silica aerogel produced using the method described in Example 2 (and MTMS as the silica precursor). The material has porosity of 83.925.

FIG. 30 shows an image of an example of a white silica aerogel produced using the method described in Example 2 (and TEOS as the silica precursor) being heated to 2000° C. demonstrating fire-retardant property of the silica aerogel.

FIG. 31 shows (a) a schematic illustration of the synthesis process of silica PGAeros with three steps: 1. Formation of micelles assisted by CTAB in urea aqueous solution, 2. Hydrolysis of TEOS at the interfaces of CTAB micelles, 3. Decomposition of urea with the release of NH₃ and CO₂. (b) Optical image of a typical silica foam with 6 cm in diameter. (c) Polished silica PGAero sample with a thickness 0.6 cm. d) Typical SEM image of silica PGAeros indicating a clear pore gradient. Insert shows the increased average pore size from bottom to top. (e), (f) The high-resolution SEM images with (e) large and (f) small pores corresponding to the top and bottom area in FIG. 31d, respectively. (g) Low-resolution and (h) high-resolution TEM images of the particles from the silica networks of PGAeros.

FIG. 32 shows SEM images of silica PGAeros with reaction time of (a) 48 h, and (b) 72 h. Insert figures show the corresponding size distribution of pores. (c) Thermal conductivities of the silica PGAeros synthesized by different periods of reaction time.

FIG. 33 shows (a)-(f) SEM images of silica PGAeros synthesized by varying the amount of precursors referred as to PGAero-1, 5, 6, 7, 8, and 9, respectively. (g) The thermal conductivities of the series of PGAeros dependent on average pore size and porosity.

FIG. 34 shows (a) Mechanical property of silica PGAero before and after annealing treatment at 400° C. Inserts show the SEM images before (up) and after (bottom) annealing. (b) Schematic figure shows heat and sound reduced by gradient structure of silica PGAero. (c) Soundproof performance of silica PGAero compare to polyurethane, kavlar and two different types of ceramic fiber blankets from Unifrax (Ceramic fiber 1: PC-Max 2000i, Ceramic fiber 2: Saffil Alumina) under sound frequency from 500 Hz to 1800 Hz. (d) Soundproof performance of silica PGAero and reference polystyrene foam under frequencies of 2000 Hz. (e) Soundproof performance plot of sound intensity and soundproof coefficients at frequency of 500 Hz, 800 Hz, and 2000 Hz.

FIG. 35 shows (a), (b) large scale and zoom in SEM image of the PGAero-2 sample.

FIG. 36 shows porosity changing along the reaction time.

FIG. 37 shows tuning detail of sample PGAero-1, PGAero-5-10.

FIG. 38 shows (a)-(g) average pore size distribution of sample PGAero-1, PGAero-5-PGAero-10.

FIG. 39 shows (a), (b) photo photographs of mechanical test.

FIG. 40 shows (a) stress strain curve of original sample PGAero-1 under 6 lbs. (b) Stress strain curve of original sample compressed to broken. (c) Stress strain curve of 400° C. annealed sample under 20 lbs.

FIG. 41 shows a photo of a sample which was annealed at 1000° C. for 24 h.)

FIG. 42 shows sound intensity difference of blank, polystyrene foam and Silica PGAero between 20 Hz to 5000 Hz frequency.

FIG. 43 shows sound intensity difference of (a) 500 Hz and (b) 800 Hz.

FIG. 44 shows humidity aging cycling measurement under 60% and 80% of silica foam.

FIG. 45 is a schematic showing that the opaque and transparent phase changing with increasing concentration of surfactant. (a) For surfactant CTAB, the opaque phase becoming more with increasing concentration of CTAB, due to hydrophilic particle is the majority in the precursor. (b) For surfactant SDS, the transparent phase becoming more with increasing concentration of SDS, due to hydrophobic particle is the majority in the precursor. (c) micelle formation changing for SDS with increasing concentration of SDS. Micelle formation becoming more organized and each micelle particle becoming smaller with increasing concentration of SDS.

FIG. 46 shows (a) optical image of gel part. (b), (c) SEM and TEM shows the micro structure of gel part. (d) Gel part density and porosity changing with concentration of SDS. (e) thermal conductivity and average pore size and density relationship. (F) shows BET result of gel part.

FIG. 47 shows (a), (b), (c) SEM images show structure of white part transformation change from open pore to close pore. (d) Optical image of white part. (e) Density and porosity change with concentration of SDS. (f) Thermal conductivity and density, average pore size relationship.

FIG. 48 shows (a) strain stress curve shows high mechanical strength. Mechanical strength becomes lower with increasing concentration of SDS. (b) Young's modulus decreasing with increasing density due to increasing concentration of SDS. (c) optical images of 3.33% SDS sample before and after mechanical compressive test.

FIG. 49 shows (a) soundproof performance of different concentration of SDS under high sound frequency from 3000 Hz to 8500 Hz. (b) Soundproof performance of different concentration of SDS under sound frequency of 500 Hz. (c) Soundproof performance of different concentration of SDS under sound frequency of 800 Hz.

FIG. 50 shows HT-Aero composites preparation and structures. (a) Manufacturing scheme of the thermally compressed aerogel-fiber composite paper. The inset is a composite paper sheet with high flexibility. The scale bar is 5 cm. (b) TEM image of ceramic fibers bonded with silica aerogels networks where the scale bar is 100 nm. The inset is the zoomed TEM image of the bonded silica aerogel layer onto the fiber surface with a scale bar of 10 nm. (c) FTIR spectrum of different samples. (d) Water uptake and the inserted superhydrophobic performance of in-situ coating of paper sheet with water contact angle of 145°. € Comparison of thermal conductivity and density for this work and other reported thermal insulation materials.

FIG. 51 shows room- and high-temperature thermal performance of thermally compressed HT-Aero composites. (a) Thermal conductivity vs. thermal compression temperature for composite and thermal conductivity vs. fiber concentration. (b) Thermal conductivity vs. density for composite with different aerogel concentration after thermal compression with a temperature of 150° C. (c) Fire retardant performance for thermal compressed composite. The scale bar is 2 cm. (d) The scheme of candle soot. (e) The demonstration of a thermal compressed composite sheet with candle soot and the superhydrophobic performance with the water contact angle of 152°. The scale bar is 2 cm. (f) The SEM image of a porous carbon coating on a composite paper sheet. The inset is the magnified microstructure of porous carbon. (g) Top surface temperature vs. the bottom heating temperature for thermally compressed composite paper sheets with and without carbon soot. The inserted FUR image of composite paper sheets with candle soot, demonstrated the high-temperature resistance with porous carbon coat. (h) Thermal conductivity vs. temperature for the high-temperature thermal insulation of composite paper sheets.

FIG. 52 shows soundproof property of thermally compressed HT-Aero composites. (a) Cross-section SEM images of the composite without thermal compression (top) and with thermal compression (bottom), where the fiber-aerogels are compressed densely. (b) Sound intensity of blank, 30, 45, and 72 wt % thermally compressed composite paper sheets under the frequency ranging from 500 to 3000 Hz. (c) Sound intensity of blank, 30, 45, and 72 wt % thermally-compressed composite paper sheets under the frequency of 3000 Hz. (d) Sound intensity vs frequency of different sheets and their soundproof coefficient.

FIG. 53 shows mechanical performance of thermally compressed HT-Aero composites. (a) The demonstration of the uniaxial tensile process of a composite sheet with a scale bar of 2 cm. The breakage happens in the middle of the samples. Stress vs. strain curves for thermally compressed composites with different density for (b) 30 wt %, (c) 45 wt %, and (d) 72 wt % ceramic fibers. (e) The mechanical mechanism illustration of the aerogel-fiber composite under tensile stress. (f) Maximum strength vs. density for samples with different concentrations of fibers.

FIG. 54 shows (a) BET analysis of silica aerogel where the N₂ adsorption/desorption isotherms display H1-type hysteresis loops, indicating the mesopores characteristics of silica aerogel, and the insert is the TEM image of silica aerogel networks (b) SEM image of thermal compression induced in-plane fiber-aerogel composite, where the silica aerogels are bonded to fibers.

FIG. 55 shows (a) thermal conductivity vs. density of HT-Aero composites with 20, 30, and 57 wt %. For different fiber concentrations, there exist the optimal thermal insulation performance with tunable density. (b) Thermal conductivity of HT-Aero composites with and without candle soot coating. Porous carbon coating further improves the thermal insulation performance. Temperature measurement setup and IR images of (c) HT-Aero composite without coating, and (d) HT-Aero composite with candle soot coating under different heating temperatures. From IR images, the hotplate temperature increases from 95 to 174° C. and the top surface temperature contour is much uniform in the center with a much lower value. The data are collected in FIG. 51.

FIG. 56 shows (a) fire retardance of HT-Aero by alcohol flame, (b) fire retardance of HT-Aero by hydrogen flame and (c) the corresponding SEM image showing the microstructure intact.

FIG. 57 shows (a) SEM image of candle soot carbon networks. (b) The magnified SEM image of porous carbon networks via candle soot.

FIG. 58 shows soundproofing data of HT-Aero composites with 30, 45, and 72 wt % and the blank reference under the sound frequency of (a) 500 Hz, and (b) 2000 Hz.

FIG. 59 shows (a) stress vs. strain curves for HT-Aero with 45 wt % fibers compressed under different temperatures. As the temperature increases, the maximum stress of HT-Aero increases because of the enhanced interfacial bonding between fibers and aerogels. (b) Comparison of tensile stress curves for HT-Aero with 20 and 45 wt % fibers. (c) Tensile stress vs. strain curves of HT-Aero with 35 wt % fibers with different densities. (d) The yield strength vs. density of HT-Aeros with different fiber concentrations. The power scaling relationship is ranging from 1 to 2.6.

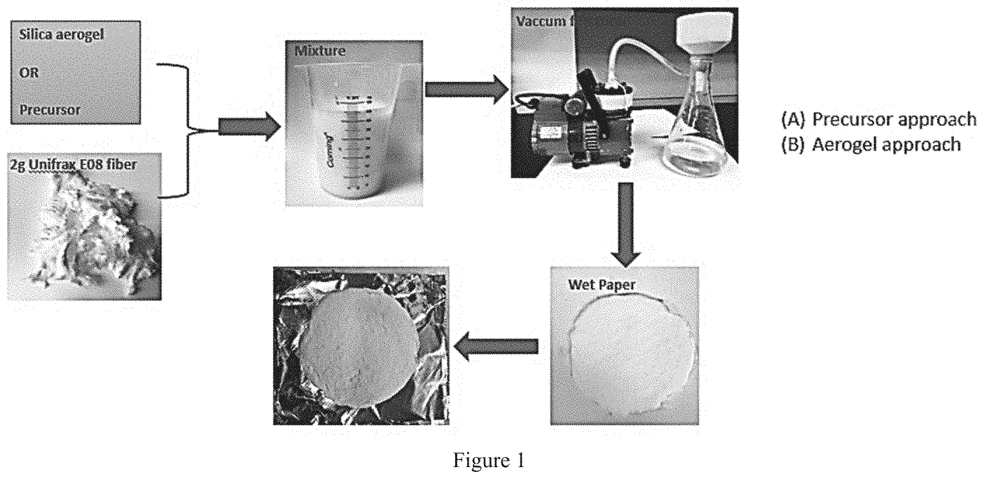

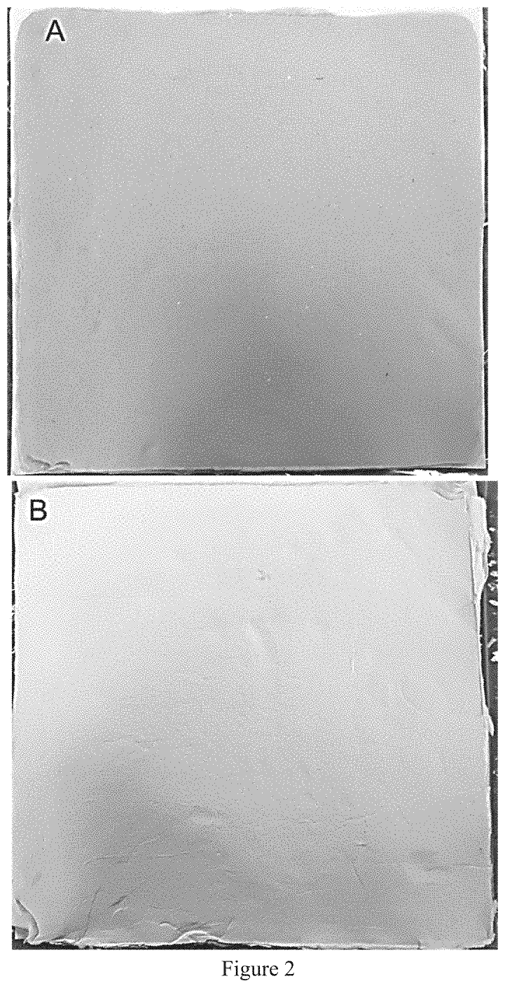

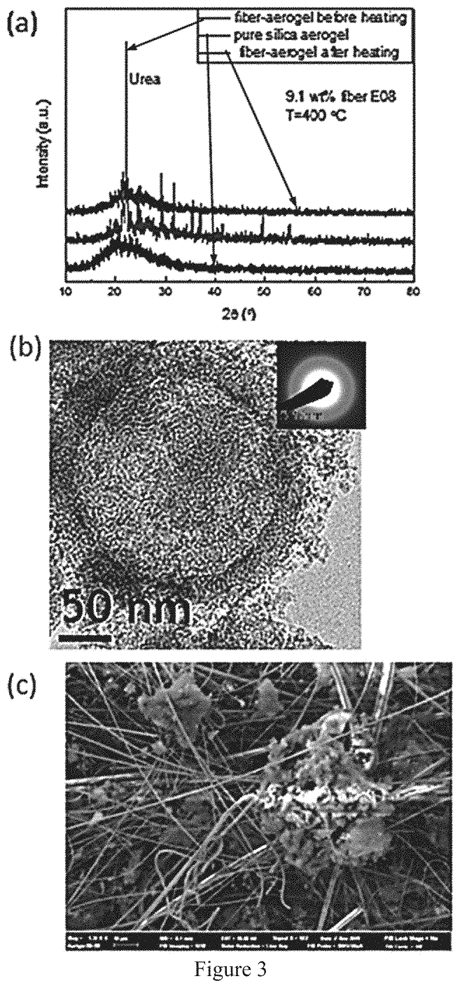

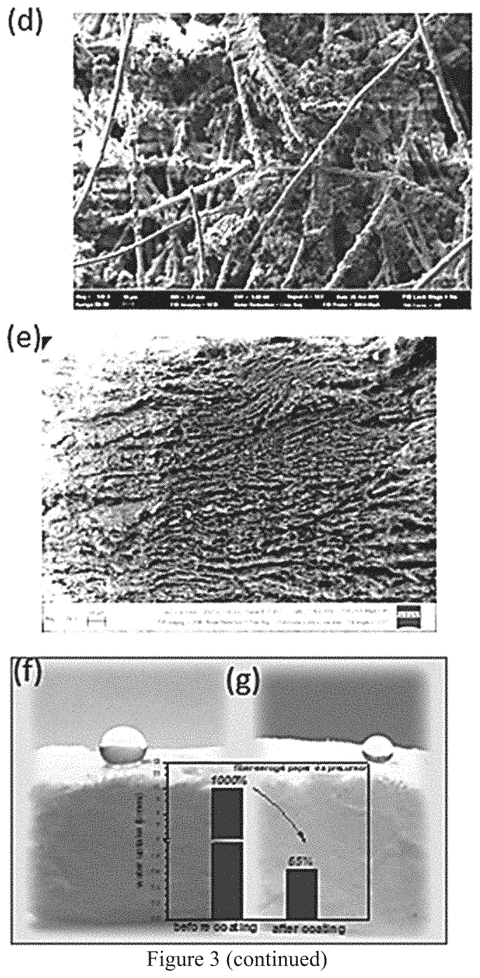

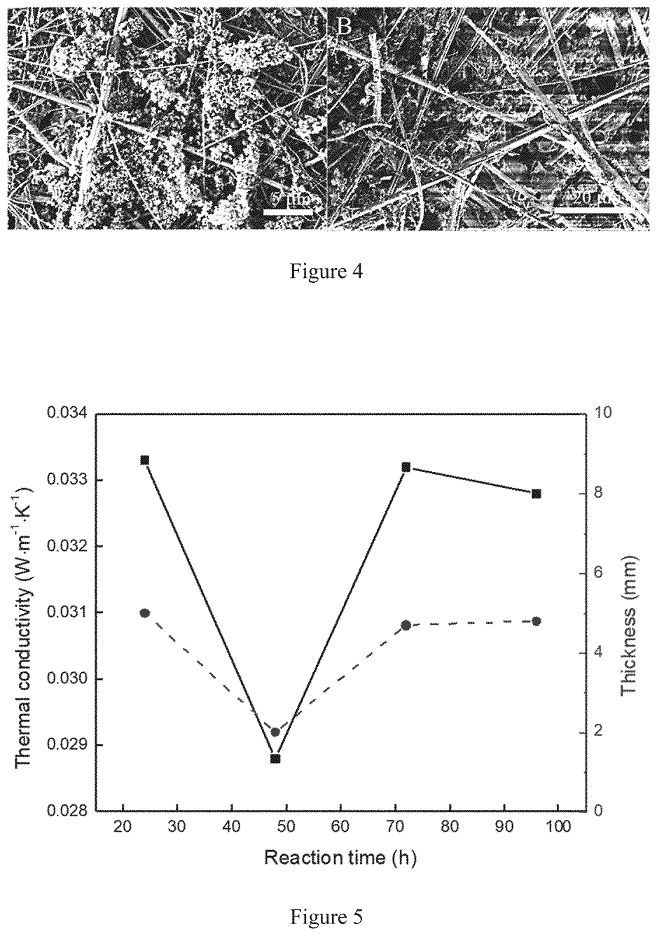

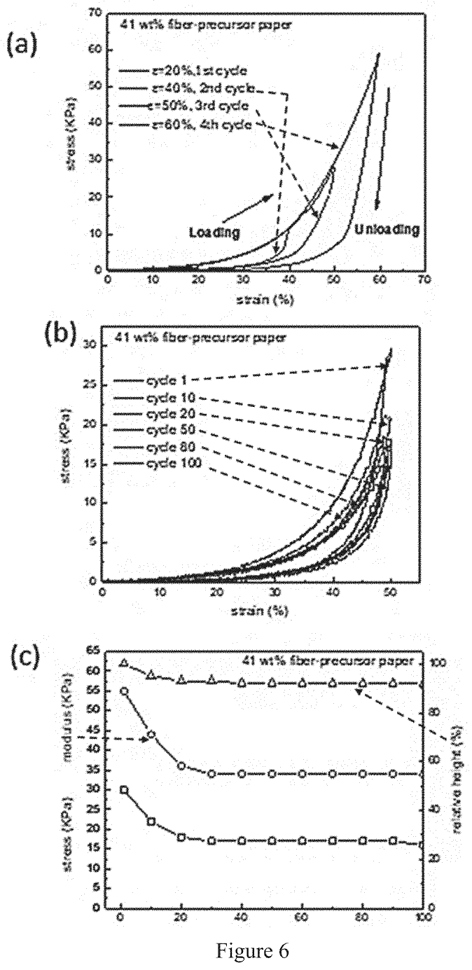

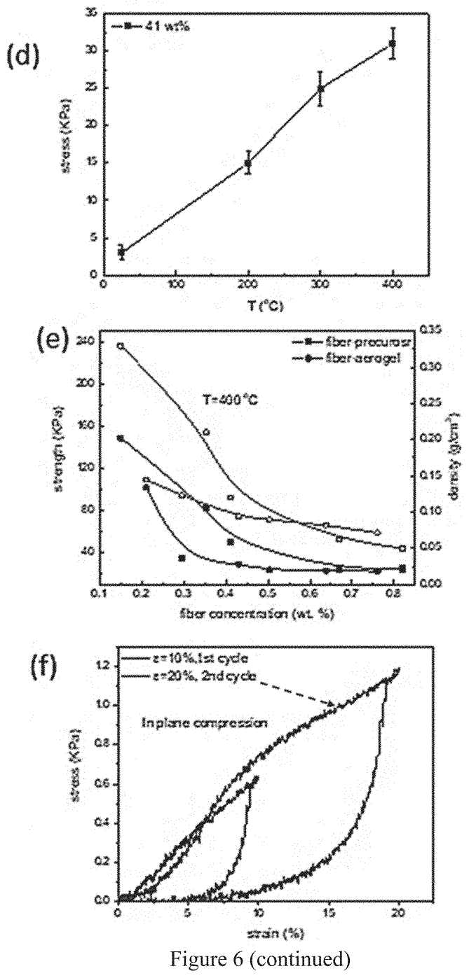

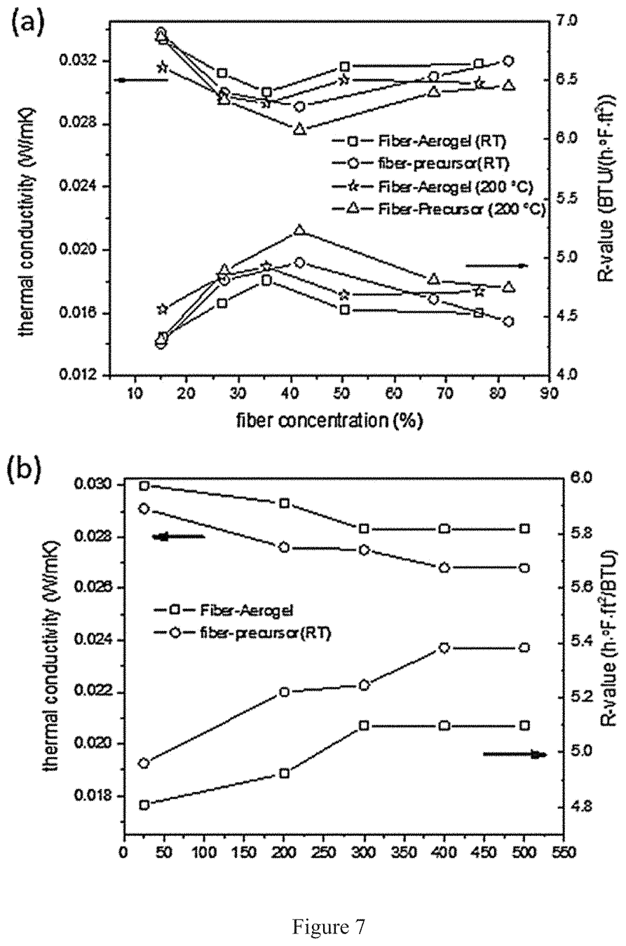

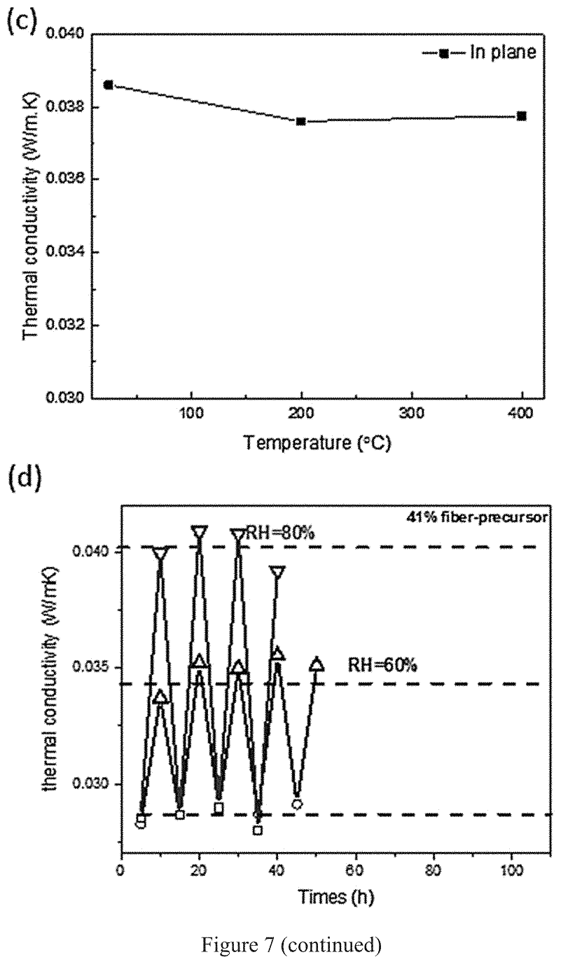

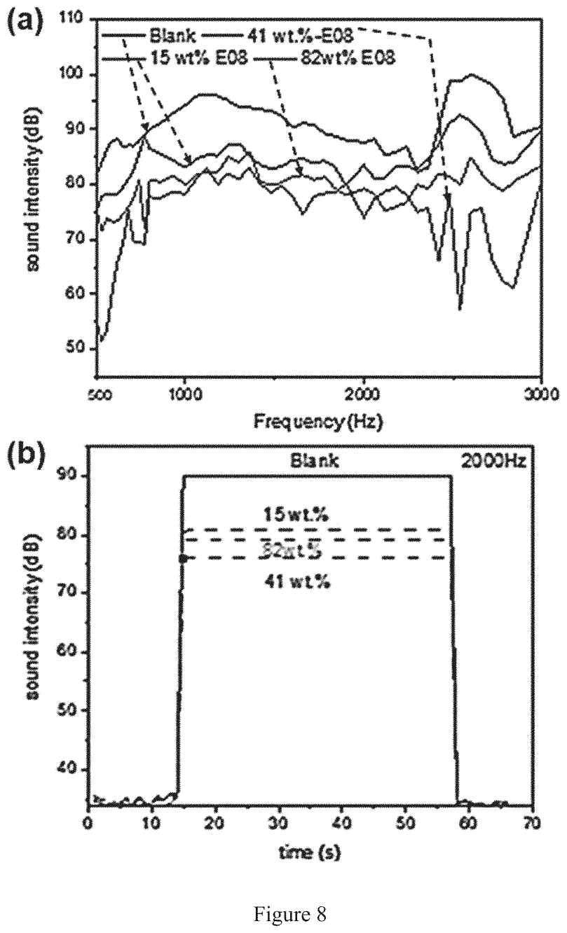

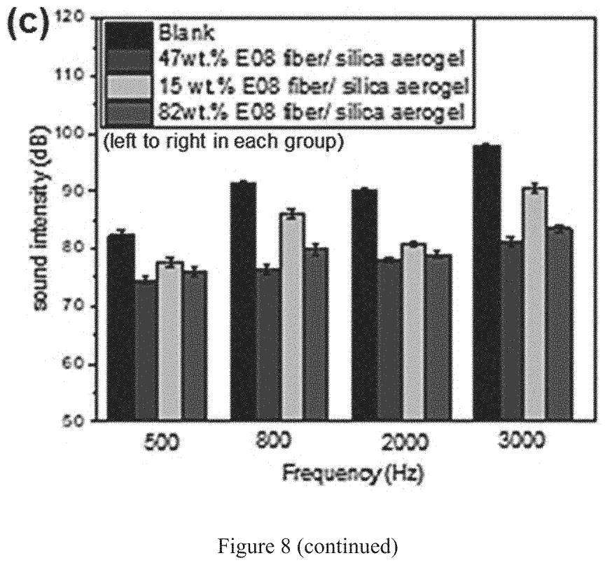

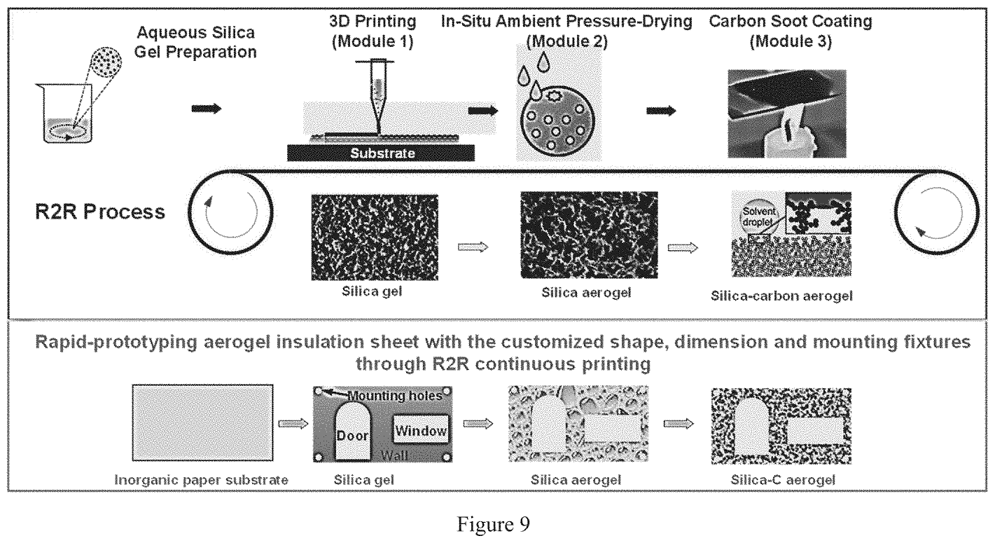

### DETAILED DESCRIPTION OF THE DISCLOSURE

Although claimed subject matter will be described in terms of certain embodiments and examples, other embodiments and examples, including embodiments and examples that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

As used herein, unless otherwise stated, the term “group” refers to a chemical entity that has one terminus or two or more termini that can be covalently bonded to other chemical species. The term “group” includes radicals. Examples of groups include, but are not limited to:

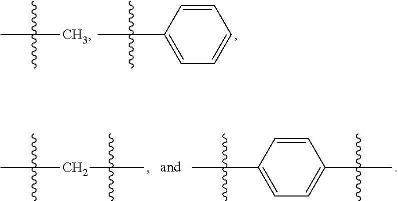

As used herein, unless otherwise indicated, the term “alkyl” refers to branched or unbranched saturated hydrocarbon groups. Examples of alkyl groups include, but are not limited to, methyl groups, ethyl groups, propyl groups, butyl groups, isopropyl groups, tert-butyl groups, and the like. For example, the alkyl group is a C₁ to C₆ alkyl group (e.g., a C₁, C₂, C₃, C₄, C₅, or C₆ alkyl group). The alkyl group may be unsubstituted or substituted with one or more substituent. Examples of substituents include, but are not limited to, halogens (—F, —Cl, —Br, and —I), aliphatic groups (e.g., alkyl groups, alkenyl groups, and alkynyl groups), aryl groups, alkoxide groups, carboxylate groups, carboxylic acids, ether groups, and the like, and combinations thereof.

As used herein, unless otherwise indicated, the term “alkoxy” refers to —OR groups, where R is an alkyl group as defined herein. Examples of alkoxy groups include, but are not limited to, methoxy groups, ethoxy groups, n-propoxy groups, i-propoxy groups, n-butoxy groups, i-butoxy groups, s-butoxy groups, and the like. In an example, an alkoxy group comprises a C₁-C₆ alkyl group (e.g., a C₁, C₂, C₃, C₄, C₅, or C₆ alkyl group).

The present disclosure provides ceramic foam-fiber composites. The present disclosure also provides methods of making ceramic foam-fiber composites and uses of ceramic foam-fiber composites.

The present disclosure, in various examples, provides uses of sol-gel chemistry (e.g., silica aerogel chemistry) coupled with ambient pressure drying, which may be in-situ ambient pressure drying. The methods can replace the current supercritical extraction step—a complex process employing low-surface-tension organic solvents and high pressure supercritical drying, by using ambient pressure—by, for example, drying with in-situ generated pore-supporting gas bubbles (such as, for example, carbon dioxide, ammonia, and the like). The processes described herein can significantly reduce, for example, one or more of energy input, time, and cost for producing ceramic foams (e.g., silica aerogels), with, for example, controlled porosity and/or pore size below 60 nm.

In an aspect, the present disclosure provides methods of making ceramic foam-fiber composites. The composites have a ceramic foam disposed on at least a portion of the individual fibers of the composites. The ceramic foams may be referred to as ceramic aerogels or ceramic-aerogel-like foams (e.g., silica-aerogel-like foams). The ceramic foam may be a silica aerogel. The methods are based on in-situ generation of a pore-forming gas and reaction of the precursor(s), which may be in a sealed environment (e.g., reaction a greater than ambient pressure), which may be carried out in the presence of fibers. The ceramic foams or ceramic foam-fiber composites may be formed under hydrothermal conditions. In an example, a method does not comprise use of any supercritical gas species. Non-limiting examples of methods are provided herein.

In various examples, a method for forming a ceramic foam-fiber composite (e.g., a silica aerogel-fiber composite) comprises: contacting (e.g., in a reaction mixture, which may be in a sealed environment, which may be a sealed vessel) a plurality of one or more types of fiber(s); one or more ceramic precursor; one or more pore-forming gas-forming additive(s) (one or more inert gas-generating agent(s)); one or more catalyst(s); and optionally, one or more additive(s), where the contacting results in formation of an inert gas (e.g., carbon dioxide and the like) and a plurality of fibers, each fiber having a ceramic foam layer disposed on at least a portion of the fiber. The ceramic foam may be formed under hydrothermal conditions. The reactants (e.g., fibers, ceramic precursor(s), pore-forming gas-forming additive(s), catalyst(s); and optionally, additive(s)) may be added/contacted in any order. The reactants may be contacted in a single vessel. The ceramic foam-fiber composite may be subjected to ambient pressure drying (APD).

The reaction may be carried out in a sealed environment. The reaction may be carried out in a sealed vessel or sealed mold. As an illustrative, non-limiting example, the reaction is carried out in an autoclave. The pressure in the vessel may be autogenous pressure (e.g., resulting from the closed nature of the vessel and the state of the reactants) or the pressure may be also be increased externally, by for example, pressurizing the sealed vessel to a desired pressure (e.g., 1 to 100 psi, including all 0.1 psi values and ranges therebetween). A vessel may be pressurized by addition of exogenous gas(es) (e.g., inert gases such as, for example, argon, nitrogen, and the like, and combinations thereof).

In an example, a method for forming a ceramic foam-fiber composite (e.g., a silica aerogel-fiber composite) comprises: contacting (e.g., in a reaction mixture), a plurality of fibers, ceramic precursor(s) (e.g., silica precursor(s)) chosen from TEOS, MTMS, water glass/sodium silicate, and combinations thereof (e.g., 57 mL of TEOS or MTMS or 1:3 to 3:1 mixture of TEOS:MTMS); urea (e.g., 33.33 g) as the pore-forming gas-forming additive (an inert gas-generating agent); acetic acid, which may be in the form of an aqueous solution (e.g., 100 mL of a 1 mmol/L solution), as the catalyst; and CTAB or SDS (e.g., 3.33 g) as a surfactant additive, where the contacting results in formation of an inert gas (e.g., carbon dioxide, ammonia, or the like) and the ceramic foam-fiber composite (e.g., the silica aerogel-fiber composite) is formed. In various examples, one or more or all of the values in this example are varied by up to and including 5% or up to and including 10%. In various examples, one or more additional additive are contacted (e.g., included in the reaction mixture).

Various ceramic precursors can be used. The precursors may sol-gel precursors. Suitable sol-gel precursors are known in the art. Non-limiting examples of precursors include silica precursors, alumina precursors, transition-metal oxide precursors, and combinations thereof. In various examples, the silica precursor(s) is/are chosen from tetraalkoxysilanes (e.g., TMOS, TEOS, and the like) (e.g., C₁-C₅ alkoxy tetraalkoxysilanes), alkyltrialkoxysilanes (e.g., methyltrimethoxysilane (MTMS) and the like) (e.g., C₁-C₅ alkyl, C₁-C₅ alkoxy alkyltrialkoxysilanes), sodium metasilicates (e.g., water glass), and combinations thereof. In various examples, the alumina precursor(s) is/are chosen from aluminum alkoxides (e.g., C₁ to C₆ aluminum alkoxides), alumatrane, or tris(alumatranyloxy-i-propyl)amine, and the like, and combinations thereof. In various examples, the transition-metal oxide precursor(s) is/are chosen from transition metal alkoxides (e.g., transition metal alkoxides having the formula M(OR)ₓ, wherein M is a transition metal (for example, Al, Ti (e.g. titanium(IV)-iso-propoxide, and the like), Zr, W, Cr, Mo, and the like) and R is at each occurrence an alkyl group and x is, for example, 1, 2, 3, 4, or 5), and the like. The transition metal can have various oxidation states (e.g., ⁺1, ⁺2, ⁺3, ⁺4, or ⁺5)).

In an example, water glass is used as a silica precursor (alone or in combination with one or more additional silica precursors). Water glass is also referred to as sodium silicate or soluble glass. In an example, water glass is a material comprising sodium oxide (Na₂O) and silica (e.g., silicon dioxide, SiO₂, and the like) that forms a glassy solid.

Combinations of ceramic precursors may be used. For example, binary, ternary, and higher order mixed oxide ceramic foams can be made using mixtures of precursors. As an illustrative example, a mixed oxide ceramic foam such as, for example, a ceramic foam having a nominal composition corresponding to a desired ratio of Al₂O₃ and TiO₂ can be made using a combination of one or more Al₂O₃ sol-gel precursor (e.g., aluminum alkoxides (e.g., C₁ to C₆ aluminum alkoxides), alumatrane, or tris(alumatranyloxy-i-propyl)amine, and the like, and combinations thereof) and TiO₂ sol-gel precursor (e.g., titanium(IV)-iso-propoxide and the like). One skilled in the art will appreciate that a ceramic foam having a desired nominal composition can be formed by choice of appropriate ceramic precursor(s) and/or relative amounts of precursors.

After formation of the ceramic foam-fiber composite, the composite may be sintered. For example, the ceramic foam is sintered at a temperature of 200 to 800° C. (e.g., 350 to 450° C. or about 400° C.), including all 0.1° C. values and ranges therebetween. The ceramic foam may be sintered in air and/or ambient pressure (e.g., 1 atm). Without intending to be bound by any particular theory, it is considered that the sintering may improve the properties of the ceramic foam. The improvement may result from carbonization of residual organic residue, if present.

The network (e.g., Si, Al, transition metal(s), or a combination thereof-oxygen network) of a ceramic foam (e.g., a silica aerogel) of a ceramic foam-composite may be formed in the presence of the pore-forming gas. Pore-forming gas may be generated in the presence of ceramic foam (e.g., silica) precursors and, optionally, the fibers (e.g., pore forming gas is generated during silica network formation). In an example, substantially all network formation is complete in the presence of the pore forming gas. By substantially all network formation it is meant that no additional processing is required to form the network of the ceramic foam (e.g., silica aerogel). In various examples, 50% or greater, 60% or greater, 70% or greater, 80% or greater of the ceramic foam precursor(s) (e.g., silica precursor(s)) is/are reacted in the presence of the pore-forming gas.

In various examples, a method further comprises post-ceramic foam formation modification of at least a portion of a surface of the ceramic foam of the ceramic-foam composite. An example of a post-ceramic foam formation modification is formation of a layer of a carbon containing material on at least a portion a surface (e.g., all of a surface or all of the surfaces of a ceramic foam). The carbon containing material may provide a superhydrophobic exterior surface. For example, carbon soot coating formed by burning a candle underneath a ceramic foam sample to enable soot coating or by post-thermal annealing.

Advanced surface modification, including trimethylchlorosilane treatment and carbon coating, can be used to engineer the capillarity and superhydrophobicity. A surface modification may replace at least a portion of the hydroxyl groups with methyl groups on the silica gel surface via formation of (CH₃)₃—Si—Si—O—, followed by continuous carbon-material coating. These modification steps are expected to control the pore size and surface chemistry to achieve the desired thermal insulation performance and durability.

For example, trimethylchlorosilane, (CH₃)₃SiCl, coupled with the continuous carbon-material coating can meet the target of surface modification by methyl group formation and nanocrystalline carbon coating to reduce both capillarity and the radiative transport mode heat transfer at higher temperature. The surface-modified silica would lead to a smaller pore size, stronger mechanical integrity, higher moisture and fire resistance, and lower thermal conductivity.

As another example of post-ceramic foam formation modification includes decorating or coating at least a portion of a surface or all of the surfaces of the ceramic foam with nanoparticles.

In various examples, a method further comprises use of post-aerogel formation modified silica aerogels. An example of a post-aerogel formation modified silica aerogels is silica aerogels comprising a layer of a carbon containing material on at least a portion a surface (e.g., all of a surface or all of the surfaces of an aerogel). The carbon containing material may provide a superhydrophobic exterior surface. For example, carbon soot coating formed by burning a candle underneath of a silica aerogel sample to enable soot coating or by post-thermal annealing.

A ceramic-foam precursor may be formed from/using ceramic foam particles. The ceramic foam particles may be pre-formed. In various examples, a ceramic-foam composite is formed by contacting a ceramic foam powder (e.g., a powder with an average particle size of 50 nm and an average pore size of 5 nm) with a plurality of fibers (e.g., in water to create the powder-fiber mixture slurry or pulp). This results in formation of a plurality of fibers, each fiber having a ceramic foam layer disposed on at least a portion of the fiber.

A ceramic foam powder may be formed from a pre-formed ceramic foam. The ceramic foam may be used as synthesized. A pre-formed ceramic foam may be mechanically treated (e.g., using a milling process) to form a ceramic foam powder.

The ceramic foams may be referred to as ceramic aerogels. The ceramic foam may be a silica aerogel. Non-limiting examples of ceramic foams are provided herein. A ceramic foam material (e.g., a ceramic foam composite material) comprises a ceramic foam. A ceramic foam comprises a matrix of ceramic material. A ceramic foam may be made by a method described herein.

The ceramic foam may be an oxide. Non-limiting examples of oxides include silicon oxide (e.g., silica), aluminum oxides (e.g., alumina), transition metal oxides, and the like, and combinations thereof. The ceramic foams may be stoichiometric or non-stoichiometric.

The ceramic foam may be a mixture of oxides. The ceramic foam may be a binary oxide, a ternary oxide system, or a higher order oxide system. Non-limiting illustrative examples of ceramic foams include aluminosilicate foams, an aluminotitanate foams, and the like.

In an example, a ceramic foam and/or a ceramic foam material does not have any fluorine atoms (e.g., any detectible by conventional methods known in the art). The fluorine atoms may be fluorine atoms bonded to silicon atoms (e.g., —Si—F).

The ceramic foam may have various forms. For example, the ceramic foam is a monolith, a film, or a powder.

The ceramic foam is porous and exhibits a hierarchical, gradient pore structure. The ceramic foam may be described as comprising hierarchical hollow structures with micropores, which may be referred to as macropores, as the interior (e.g., voids in the ceramic matrix) and mesopores inside the shells (e.g., the matrix). At least a portion or all of the pores may be interconnected. The pores may be mesopores and/or macropores. The pores may be mesopores as defined by IUPAC.

The pores of the ceramic foam, which may be micropores or macropores and are not mesopores of the ceramic matrix, can have various sizes. For example, the size (e.g., the average size and/or 90%, 95%, 99%, 99.9%, or 100%) of the pores is from 500 microns to 1 micron, including all 0.1 micron values and ranges therebetween. A size may be at least one dimension (e.g., a diameter), as measured in a plane parallel to an axis of the pore. For example, the pores have a size (e.g., at least one dimension (e.g., a diameter), as measured in a plane parallel to an axis of the pore) and/or at least one dimension (e.g., a height) as measured in a plane perpendicular to an axis of the pore) of 500 microns to 1 micron (e.g., 200 microns to 10 microns, 200 microns to 1 micron, or 100 microns to 1 micron). The size of the pores generally decrease or increase along a dimension moving from a first surface of the ceramic foam to a second surface that is opposite the first surface. The gradient may be a linear gradient or a non linear gradient.

The ceramic matrix of a ceramic foam may be mesoporous (e.g., comprise mesopores, which may be mesopores as defined by IUPAC). For example, the ceramic matrix has a plurality of pores having a diameter of 2 nm to 100 nm (e.g., 2 to 60 nm, 10 to 60 nm, or 10 to 100 nm), including 0.1 nm values and ranges therebetween. For example, the ceramic matrix has a plurality of pores having an average diameter of 2.5 nm to 30 nm (e.g., 2.5 to 10 nm or 15 to 30 nm), including 0.1 nm values and ranges therebetween. The pore size distribution may be bimodal. For example, the ceramic matrix has a plurality of pores having average diameter 2 nm to 100 nm (e.g., 2 nm to 100 nm (e.g., 2 to 60 nm, 10 to 60 nm, or 10 to 100 nm) (which may be multimodal, such as, for example, bimodal) and a plurality of pores having an average diameter of 2.5 nm to 30 nm (e.g., 2.5 to 10 nm or 15 to 30 nm).

The pore size and/or pore size distribution of the ceramic foam and/or ceramic matrix can be determined using methods known in the art. For example, the pore size and/or pore size distribution is determined using BET analysis.

The ceramic foam can have desirable properties. For example, a ceramic foam has a Young's modulus of 2-100 MPa (e.g., 2 to 8 MPa), including all integer MPa values and ranges therebetween.

The ceramic foam may be a porous silica aerogel. For example, the silica aerogel has a plurality of pores having a diameter of 2 nm to 100 nm (e.g., 2 to 60 nm, 10 to 60 nm, or 10 to 100 nm), including 0.1 nm values and ranges therebetween. For example, the silica aerogel has a plurality of pores having an average diameter of 2.5 nm to 30 nm (e.g., 2.5 to 10 nm or 15 to 30 nm), including 0.1 nm values and ranges therebetween. The pore size distribution may be bimodal. For example, the silica aerogel has a plurality of pores having average diameter 2 nm to 100 nm (e.g., 2 to 60 nm, 10 to 60 nm, or 10 to 100 nm) (which may be multimodal, such as, for example, bimodal) and a plurality of pores having an average diameter of 2.5 nm to 30 nm (e.g., 2.5 to 10 nm or 15 to 30 nm) nm. The pore size and/or pore size distribution can be determined using methods known in the art. For example, the pore size and/or pore size distribution is determined using BET analysis.

A ceramic foam material may be a composite material (e.g., a composite ceramic foam). The composite material may comprise a polymer material (which may be referred to as a hybrid composite material or hybrid ceramic foam) in a portion of or all of the pores of the ceramic foam. The polymer may be formed by an in-situ polymerization in the ceramic foam. Additionally, or alternatively, a composite material may comprise a carbon coating on the ceramic foam, which may be referred to as ceramic-carbon aerogel. For example, a ceramic foam (e.g., a ceramic foam monolith or ceramic foam film) is at least partially (or completely) coated with a carbon material.

In various examples, a method for forming a ceramic foam comprises: contacting (e.g., in a reaction mixture, which may be in a sealed environment, which may be a sealed vessel) one or more ceramic precursor(s); one or more pore-forming gas-forming additive(s) (one or more inert gas-generating agent(s)); one or more catalyst(s); and optionally, one or more additive(s), where the contacting results in formation of an inert gas (e.g., carbon dioxide and the like) and the ceramic foam (e.g., silica aerogel) is formed. The ceramic foam may be formed under hydrothermal conditions. The reactants (e.g., ceramic precursor(s), pore-forming gas-forming additive(s), catalyst(s); and optionally, additive(s)) may be added/contacted in any order. The reactants may be contacted in a single vessel.

The reaction may be carried out in a sealed environment. The reaction may be carried out in a sealed vessel or sealed mold. As an illustrative, non-limiting example, the reaction is carried out in an autoclave. The pressure in the vessel may be autogenous pressure (e.g., resulting from the closed nature of the vessel and the state of the reactants) or the pressure may be also be increased externally, by for example, pressurizing the sealed vessel to a desired pressure (e.g., 1 to 100 psi, including all 0.1 psi values and ranges therebetween). A vessel may be pressurized by addition of exogenous gas (e.g., inert gases such as, for example, argon, nitrogen, and the like, and combinations thereof).

In an example, a method for forming a ceramic foam (e.g., silica aerogel-like foam) comprises: contacting (e.g., in a reaction mixture) in a sealed vessel TEOS, MTMS, waterglass, or a combination thereof silica precursor(s) (e.g., 57 mL of TEOS or MTMS or 1:3 to 3:1 mixture of TEOS:MTMS); urea (e.g., 33.33 g) as the pore-forming gas-forming additive (an inert gas-generating agent); acetic acid, which may be in the form of an aqueous solution (e.g., 100 mL of a 1 mmol/L solution), as the catalyst; and CTAB (e.g., 3.33 g) as an additive, where the contacting results in formation of an inert gas (e.g., carbon dioxide, ammonia, or the like) and an the silica aerogel-like foam is formed. In various examples, one or more or all of the values in this example are varied by up to and including 5% or up to and including 10%. In various examples, one or more additional additive are contacted (e.g., included in the reaction mixture).

Various ceramic precursors can be used. The precursors may sol-gel precursors. Suitable sol-gel precursors are known in the art. Non-limiting examples of precursors include silica precursors, alumina precursors, transition-metal oxide precursors, and combinations thereof. In various examples, the silica precursor(s) is/are chosen from tetraalkoxysilanes (e.g., TMOS, TEOS, and the like) (e.g., C₁-C₅ alkoxy tetraalkoxysilanes), alkyltrialkoxysilanes (e.g., methyltrimethoxysilane (MTMS) and the like) (e.g., C1-C5 alkyl, C₁-C₅ alkoxy alkyltrialkoxysilanes), sodium metasilicates (e.g., water glass), and combinations thereof. In various examples, the alumina precursor(s) is/are chosen from aluminum alkoxides (e.g., C₁ to C₆ aluminum alkoxides), alumatrane, or tris(alumatranyloxy-i-propyl)amine, and the like, and combinations thereof. In various examples, the transition-metal oxide precursor(s) is/are chosen from transition metal alkoxides (e.g., transition metal alkoxides having the formula M(OR)_{X}, wherein M is a transition metal (for example, Al, Ti (e.g. titanium(IV)-iso-propoxide, and the like), Zr, W, Cr, Mo, and the like) and R is at each occurrence an alkyl group and x is, for example, 1, 2, 3, 4, or 5), and the like. The transition metal can have various oxidation states (e.g., +1, +2, +3, +4, or +5).

In an example, water glass is used as a silica precursor (alone or in combination with one or more additional silica precursors). Water glass is also referred to as sodium silicate or soluble glass. In an example, water glass is a material comprising sodium oxide (Na₂O) and silica (e.g., silicon dioxide, SiO₂, and the like) that forms a glassy solid.

Combinations of ceramic precursors may be used. For example, binary, ternary, and higher order mixed oxide ceramic foams can be made using mixtures of precursors. As an illustrative example, a mixed oxide ceramic foam such as, for example, a ceramic foam having a nominal composition corresponding to a desired ratio of Al₂O₃ and TiO₂ can be made using a combination of one or more Al₂O₃ sol-gel precursor (e.g., aluminum alkoxides (e.g., C₁ to C₆ aluminum alkoxides), alumatrane, or tris(alumatranyloxy-i-propyl)amine, and the like, and combinations thereof), and TiO₂ sol-gel precursor (e.g., titanium(IV)-iso-propoxide and the like). One skilled in the art will appreciate that a ceramic foam having a desired nominal composition can be formed by choice of appropriate ceramic precursor(s) and/or relative amounts of precursors.

After formation of the ceramic foam, the ceramic foam may be sintered. For example, the ceramic foam is sintered at a temperature of 200 to 800° C. (e.g., 350 to 450° C. or about 400° C.), including all 0.1° C. values and ranges therebetween. The ceramic foam may be sintered in air and/or ambient pressure (e.g., 1 atm). Without intending to be bound by any particular theory, it is considered that the sintering may improve the properties of the ceramic foam. The improvement may result from carbonization of residual organic residue, if present.

In various examples, a method further comprises post-ceramic foam formation modification of at least a portion of a surface of the ceramic foam. An example of a post-ceramic foam formation modification is formation of a layer of a carbon containing material on at least a portion a surface (e.g., all of a surface or all of the surfaces of a ceramic foam). The carbon containing material may provide a superhydrophobic exterior surface. For example, carbon soot coating formed by burning a candle underneath a ceramic foam sample to enable soot coating or by post-thermal annealing.

Advanced surface modification, including trimethylchlorosilane treatment and carbon coating, can be used to engineer the capillarity and superhydrophobicity. This replaces surface hydroxyl groups with methyl groups on the silica gel surface via formation of (CH₃)₃—Si—Si—O—, followed by continuous carbon-material coating. These modification steps control the pore size and surface chemistry to achieve the desired thermal insulation performance and durability.

For example, trimethylchlorosilane, (CH₃)₃SiCl, coupled with the continuous carbon-material coating can meet the target of surface modification by methyl group formation and nanocrystalline carbon coating to reduce both capillarity and the radiative transport mode heat transfer at higher temperature. The surface-modified silica would lead to a smaller pore size, stronger mechanical integrity, higher moisture and fire resistance, and lower thermal conductivity.

As another example of post-ceramic foam formation modification includes decorating or coating at least a portion of a surface or all of the surfaces of the ceramic foam with nanoparticles.

Formation of the ceramic foam may comprise a thermal annealing step. The thermal annealing step may be carried out after the ceramic foam is formed, washed, dried, etc. For example, the thermal annealing is the last step in producing the ceramic foam. In various examples, the thermal annealing is carried out at 300° C. to 600° C., including all integer ° C. values and ranges therebetween and may carried out for a varied amount of time (e.g., 1 hour to 6 hours, including all integer minute values and ranges therebetween).

The ceramic network (e.g., a silica network, alumina network, aluminosilicate network, transition metal oxide network, or a combination thereof), which may be referred to as the ceramic matrix, may comprise ceramic nanoparticles (e.g., silica nanoparticles) (e.g., having a size, which may be a largest or smallest dimension, of 20 to 200 nm (e.g., 150 to 200 or about 200 nm), including all integer nm values and ranges therebetween, or an average size, which may be an average largest or smallest dimension, of 20 to 200 nm (e.g., 150 to 200 or about 200 nm), including all integer nm values and ranges therebetween, of the ceramic aerogel may be formed in the presence of the pore-forming gas. The ceramic nanoparticle may have a narrow size distribution with 90% or more, 95% or more, 99% or more, or all of the ceramic nanoparticles having a size and/or average size of 20 to 200 nm (e.g., 150 to 200 or about 200 nm), including all integer nm values and ranges therebetween. Pore-forming gas may be generated in the presence of ceramic precursors (e.g., pore forming gas is generated during silica network formation). In an example, substantially all ceramic matrix formation is complete in the presence of the pore forming gas. By substantially all ceramic matrix formation it is meant that no additional processing is required to form the ceramic matrix of the ceramic foam. In various examples, 50% or greater, 60% or greater, 70% or greater, 80% or greater of the silica precursor(s) is/are reacted in the presence of the pore-forming gas.

In an example, the ceramic foam is formed using TEOS and is white. In another example, the ceramic foam is formed using MTMS and exhibits desirable transparency. For example, a ceramic foam formed using MTMS exhibits 85% or greater, 90% or greater, 95% or greater, or 98% or greater transmittance of visible light wavelengths (e.g., light wavelengths of 400-800 nm such as, for example, 530 nm) (e.g., measured at a sample thickness of 2-3 mm (e.g., 2.7 mm). In yet another example, the ceramic foam is formed using TEOS and MTMS and has one or more white and one or more transparent domains (e.g., exhibiting 90% or greater, 95% or greater, or 98% or greater transmittance of visible light wavelengths (e.g., light wavelengths of 400-800 nm)).

In an example, a ceramic foam or ceramic foam-material does not comprise any exogenous materials (e.g., any detectible exogenous materials, which may be detected by conventional methods known in the art). Exogenous materials include, but are not limited to, materials used in forming building materials from silica materials (e.g., ceramic foam materials). Non-limiting examples of exogenous materials include binders (e.g., polymer binders), polymers, and the like.

A variety of fibers can be used to form a ceramic-foam composite. Without intending to be bound by any particular theory, it is considered that fibers provide reinforcement for mechanical flexibility and deformable and compressible nature of silica aerogel-fiber composites. The fibers may be solid fibers and/or hollow fibers. The fibers may be fibers used in the textile industry. A fiber having a silica aerogel layer disposed on at least a portion of the fiber may be referred to as silica-aerogel composite. Combinations of structurally and/or compositionally distinct fibers may be used. Non-limiting examples of fibers include ceramic fibers, polymers (such as, for example, nylon, polyaramid, cellulose, and the like), and combinations thereof. The fibers may be present in the form of a substrate (e.g., a textile). Fibers or various sizes can be used. For example, a least a portion or all of the fibers have a width (e.g., diameter), which may range from 100 nm to 15 micron, including all 0.1 nm values and ranges therebetween, and a length (e.g., a longest dimension), which may range from 100 microns to 10 cm, including all 0.1 micron values and ranges therebetween. Suitable examples of fibers are known in the art and can be obtained commercially or made by methods known in the art.

Various amounts of fibers can be used (e.g., in the reaction mixture). In various examples, the amount of fibers used (e.g., in the reaction mixture) corresponds to (e.g., provides) 10-90% by weight (based on the total weight of the ceramic foam-fiber composite), including all 0.1% by weight values and ranges therebetween, based on 90%, 95%, 99% or 100% conversion of the ceramic precursor(s) (e.g., silica precursor(s)). In various examples, the amount of fibers used (e.g., in the reaction mixture) corresponds to (e.g., provides) 30-50% by weight or 35-45% by weight, or about 40% by weight (based on the total weight of the ceramic foam-fiber composite) based on 90%, 95%, 99% or 100% conversion of the ceramic precursor(s) (e.g., silica precursor(s)).

A method of the present disclosure may comprise a thermal annealing step. This may be an ambient pressure drying step. The thermal annealing step may be carried out after the ceramic foam-fiber composite (e.g., silica aerogel-fiber composite) is formed, washed, dried, etc. For example, the thermal annealing is the last step in producing the ceramic foam-fiber composite (e.g., silica aerogel-fiber composite). In various examples, the thermal annealing is carried out at 300° C. to 600° C., including all integer ° C. values and ranges therebetween and may carried out for a varied amount of time (e.g., 1 hour to 6 hours, including all integer minute values and ranges therebetween), and optionally, at ambient pressure (e.g., the pressure during thermal annealing is not modified from the ambient pressure).

The ceramic foam-fiber composites may be used to form sheets. The ceramic-foam-fiber composites or fibers may be disposed in a matrix of ceramic foam. A composite sheet comprises a plurality of ceramic foam-fiber composites. The sheets may be in the form of mats or paper sponges. The sheets can have various thicknesses. In various examples, a sheet has a thickness of 1 mm to 100 mm, including all 0.1 mm values and ranges therebetween. The composite sheets may be formed by methods (such as, for example, paper making methods) known in the art.

A method of the present disclosure may further comprise forming composite sheets. In various examples, a composite sheet is made by forming a mixture which may be referred to as a pulp mixture, and may be the reaction mixture in which the ceramic aerogel-fiber composites are formed after the composite is formed) comprising one or more ceramic foam-composite and water are mixed and spread across a large mesh screen, to remove the water for the formation of wet sheets. The wet sheets can then be annealed, for example, at 60° C. for overnight, to dry the paper sheets. In various examples, no additive(s) or binder(s) are used in a sheet making method. This approach provides a simple, low-cost method for forming composite sheets and can be scalable manufacturing.

A method may be a continuous method. For example, a method is a roll-to-roll (R2R) continuous manufacturing method. R2R enables near-net-shape manufacturing and dimension customization of ceramic foam formation on, for example, low-cost and high thermal insulation inorganic paper substrate carrier.

Using roll-to-roll continuous manufacturing it is expected that an improved R-value aerogel-based insulation material will be formed at low cost using, for example, a tetraethoxysilane or waterglass silica aerogel precursor mixed with inorganic ceramic or fiberglass fiber carrier through R2R manufacturing process that enables shape and dimension customization on, for example, an inorganic ceramic fiber paper substrate carrier (Fiberfrax® by Unifrax), leading to a desirable material cost of silica aerogel.

In an aspect, the present disclosure provides ceramic foam-fiber composites. The ceramic foam-fiber composites comprise a plurality of fibers, where at least a portion or all of the fibers individually comprise a ceramic foam disposed on at least a portion or all of a surface of the fiber. The ceramic foams of the ceramic-foam composites may be ceramic foam films. The films may be continuous or formed from a plurality of particles. The ceramic foams may be referred to as ceramic aerogels. A ceramic foam may be a silica aerogel. Non-limiting examples of ceramic foams are provided herein. A ceramic foam material (e.g., a ceramic foam composite material) comprises a ceramic foam. A ceramic foam comprises matrix of ceramic material. A ceramic foam may be made by a method of the present disclosure.

A ceramic foam-fiber composite may have various amounts of fibers. In various examples, the amount of fibers in the ceramic foam-fiber composite is 10-90% by weight (based on the total weight of the ceramic foam-fiber composite), including all 0.1% by weight values and ranges therebetween. In various examples, the amount of fibers in the ceramic foam-fiber composite is 30-50% by weight or 35-45% by weight, or about 40% by weight (based on the total weight of the ceramic foam-fiber composite).

A fiber of a ceramic foam-fiber composite may have a ceramic foam disposed on at least a portion (e.g., 10 to 100%, including all 0.1% values and ranges therebetween) of a surface of the fiber. In various examples, such as, for example, where the composite is formed in situ, 70% or more, 80% or more, 90% or more, 95% or more, 99% or more of the surfaces, which may interior and or exterior surfaces of the fiber have a ceramic foam disposed thereon. In various examples, such as, for example, where a ceramic foam powder is used to form the composite is formed in situ, 10% or more, 20% or more, 30% or more, 40% or more, 50% or more, 60% or more, 70% or more, or 80% or more of the surfaces, which may interior and or exterior surfaces of the fiber have a ceramic foam disposed thereon.

The ceramic foam may be in the form of a layer. The layer may have a thickness of 10 mm to 10 microns, including all 0.1 mm values and ranges therebetween. The layer may be continuous or discontinuous.

The ceramic foam may be in the form of a plurality of particles. The particles may have a size (e.g., longest dimension, such as, for example, a diameter) or an average size (e.g., an average longest dimension, such as, for example, an average diameter) of 20 nm to 100 nm, including all 0.1 nm values and ranges therebetween.

The ceramic foam of the ceramic foam-fiber composite may be an oxide. Non-limiting examples of oxides include silicon oxide (e.g., silica), aluminum oxides (e.g., alumina), transition metal oxides, and the like, and combinations thereof. The ceramic foams may be stoichiometric or non-stoichiometric.

The ceramic foam of the ceramic foam-fiber composite may be a mixture of oxides. The ceramic foam may be a binary oxide, a ternary oxide system, or a higher order oxide system. Non-limiting illustrative examples of ceramic foams include aluminosilicate foams, an aluminotitanate foams, and the like.

In an example, a ceramic foam and/or a ceramic foam material of the ceramic foam-fiber composite does not have any fluorine atoms (e.g., any detectible by conventional methods known in the art). The fluorine atoms may be fluorine atoms bonded to silicon atoms (e.g., —Si—F).

The ceramic foam of the ceramic foam-fiber composite is porous and exhibits a hierarchical, gradient pore structure. The ceramic foam may be described as comprising hierarchical hollow structures with micropores, which may be referred to as macropores, as the interior (e.g., voids in the ceramic matrix) and mesopores inside the shells (e.g., the matrix). At least a portion or all of the pores may be interconnected. The pores may be mesopores and/or macropores. The pores may be mesopores as defined by IUPAC.

The pores of the ceramic foam of the ceramic foam-fiber composite, which may be referred to as micropores or macropores and are not mesopores of the ceramic matrix, can have various sizes. For example, the size (e.g., the average size and/or 90%, 95%, 99%, 99.9%, or 100%) of the pores is from 500 microns to 1 micron, including all 0.1 micron values and ranges therebetween. A size may be at least one dimension (e.g., a diameter), as measured in a plane parallel to an axis of the pore. For example, the pores have a size (e.g., at least one dimension (e.g., a diameter), as measured in a plane parallel to an axis of the pore) and/or at least one dimension (e.g., a height) as measured in a plane perpendicular to an axis of the pore) of 500 microns to 1 micron (e.g., 200 microns to 10 microns, 200 microns to 1 micron, or 100 microns to 1 micron). The size of the pores generally decrease or increase along a dimension moving from a first surface of the ceramic foam to a second surface that is opposite the first surface. The gradient may be a linear gradient or a non linear gradient.

The ceramic matrix of a ceramic foam of the ceramic foam-fiber composite may be mesoporous (e.g., comprise mesopores, which may be mesopores as defined by IUPAC). For example, the ceramic matrix has a plurality of pores having a diameter of 2 nm to 100 nm (e.g., 2 to 60 nm, 10 to 60 nm, or 10 to 100 nm), including 0.1 nm values and ranges therebetween. For example, the ceramic matrix has a plurality of pores having an average diameter of 2.5 nm to 30 nm (e.g., 2.5 to 10 nm or 15 to 30 nm), including 0.1 nm values and ranges therebetween. The pore size distribution may be bimodal. For example, the ceramic matrix has a plurality of pores having average diameter 2 nm to 100 nm (e.g., 2 to 60 nm, 10 to 60 nm, or 10 to 100 nm) (which may be multimodal, such as, for example, bimodal) and a plurality of pores having an average diameter 2.5 nm to 30 nm (e.g., 2.5 to 10 nm or 15 to 30 nm).

The silica aerogel of a ceramic foam-fiber composite is porous. For example, the silica aerogel has a plurality of pores having a diameter of 2 nm to 100 nm (e.g., 2 to 60 nm, 10 to 60 nm, or 10 to 100 nm), including 0.1 nm values and ranges therebetween. For example, the silica aerogel has a plurality of pores having an average diameter of 2.5 nm to 30 nm (e.g., 2.5 to 10 nm or 15 to 30 nm), including 0.1 nm values and ranges therebetween. The pore size distribution may be bimodal. For example, the silica aerogel has a plurality of pores having average diameter 2 nm to 100 nm (e.g., 2 to 60 nm, 10 to 60 nm, or 10 to 100 nm) (which may be multimodal, such as, for example, bimodal) and a plurality of pores having an average diameter of 2.5 nm to 30 nm (e.g., 2.5 to 10 nm or 15 to 30 nm). The pore size and/or pore size distribution can be determined using methods known in the art. For example, the pore size and/or pore size distribution is determined using BET analysis.

The pore size and/or pore size distribution of the ceramic foam and/or ceramic matrix of the ceramic foam-fiber composite can be determined using methods known in the art. For example, the pore size and/or pore size distribution is determined using BET analysis.

A ceramic foam of a ceramic foam-fiber composite may be a composite material (e.g., a composite ceramic foam). The composite material may comprise a polymer material (which may be referred to as a hybrid composite material or hybrid ceramic foam) in a portion of or all of the pores of the ceramic foam. The polymer may be formed by an in-situ polymerization in the ceramic foam. Additionally, or alternatively, a composite material may comprise a carbon coating on the ceramic foam, which may be referred to as ceramic-carbon aerogel. For example, a ceramic foam (e.g., a ceramic foam monolith or ceramic foam film) is at least partially (or completely) coated with a carbon material.

The ceramic foam-composite material may be in the form of a sheet. The ceramic foam of the ceramic foam-composite may be infiltrated in a substrate formed from a plurality of fibers.

An insulating material may comprise a ceramic foam-composite material of the present disclosure (e.g., a ceramic foam-composite made by a method of the present disclosure). The insulating material may be thermally insulating, acoustically insulating, or both.

It is expected that methods of the present disclosure or the ceramic-foam composites will provide a low-cost building insulation material. A building insulation material may comprise one or more ceramic fiber-composite(s) of the present disclosure and/or one or more ceramic fiber-composite(s) made by a method of the present disclosure.

It is expected that that the methods of the present disclosure will provide inexpensive large-scale production and installation of high R-value building insulation material (ceramic foam-composite material) that can impact a broad range of building envelope applications, such as, for example, roof and wall in existing buildings and future construction. A cost reduction by 90% or more relative to current technology is expected by, for example, replacing supercritical dried ceramic foam (e.g., Spaceloft®, July 2018), with a ceramic foam of the present disclosure. Also, it is expected that building energy efficiency of insulation with a ceramic foam of the present disclosure will be at least 45%. An insulation with a ceramic foam of the present disclosure may have R-value and thermal conductivity comparable to commercial ceramic foam at room temperature. However, an insulation with a ceramic foam of the present disclosure may have an increased R-value at high temperature (e.g., relative to commercial ceramic foam and may reduce the unit cost significantly. The complex processing and volatile organic solvents involved in producing ceramic foam by conventional high-pressure supercritical drying make its use by building insulation material manufacturers cost-prohibitive.

A building insulation material may be a thermal insulation sheet. The thermal insulation sheet may be used in commercial or residential applications. The thermal insulation sheet may be formed using R2R production method. The thermal insulation sheet may be used to retrofit an existing building. In various examples, a thermal insulation sheet comprising a ceramic foam of the present disclosure is an R15/inch thermal insulation sheet, which may have a thermal conductivity of 0.01 W/mK or less.

In an example, a ceramic foam-composite does not comprise any exogenous materials (e.g., any detectible exogenous materials, which may be detected by conventional methods known in the art). Exogenous materials include, but are not limited to, materials used in forming building materials from silica materials (e.g., ceramic foam materials). Non-limiting examples of exogenous materials include binders (e.g., polymer binders), polymers, and the like.

A ceramic foam-composite may have desirable sound transmission/sound isolation/acoustic insulation properties. In various examples, a ceramic foam has at least 10%, at least 15%, at least 20%, or at least 25% improvement in soundproofing (e.g., increased soundproof coefficient) relative to a given thickness of another material (e.g., an organic polymer foam, such as, for example, PS foam, a PU foam, or the like, or ceramic fibers, or the like) in one or more, substantially all, or all of the frequencies from 500 to 2000 Hz. In another example, a silica aerogel-like foam (e.g., silica PGAeros) with a thickness of 0.014 m has better soundproof performance comparing with the reference PS foam at different frequencies of 500 Hz, 800 Hz, and 2,000 Hz, showing the noise reductions of 10.9%, 12.0%, and 28.4%, respectively.

In an aspect, the present disclosure provides uses of ceramic foam-fiber composite(s) of the present disclosure. The ceramic foam-fiber composites can be used in a variety of applications. A ceramic foam-fiber composite may be a superinsulation material or provide superinsulation. For example, the material has a thermal conductivity of 0.01 W/mK or less.

In an example, a ceramic foam-fiber composite is used as an insulating material (e.g., a building material or soundproofing material). The insulating material may exhibit desirable thermal management and/or soundproofing properties.

In an example, a ceramic foam-fiber composite is used as a template or the support substrates for coating with other functional materials as the composites in the applications for the catalyst, membrane, separation, and the like.

The steps of the methods described in the various embodiments and examples disclosed herein are sufficient to carry out the methods of the present disclosure. Thus, in an example, a method consists essentially of a combination of steps of the methods disclosed herein. In another example, a method consists of such steps.

The following Statements describe various examples of ceramic foam-fiber composites and methods of making ceramic foam-fiber composites:

Statement 1. A method for forming a ceramic foam-fiber composite (which may comprise a fiber hierarchical pore gradient ceramic foam or a silica aerogel) comprising: contacting (e.g., in a reaction mixture), which may be in a sealed environment (e.g., a sealed reaction vessel) one or more fiber(s); one or more ceramic precursor(s); one or more pore-forming gas-forming additive(s) (one or more inert gas-generating agent(s)); one or more catalyst(s); and optionally, one or more additive(s), where the contacting is results in formation of an inert gas (e.g., carbon dioxide, nitrogen or a combination thereof) and the ceramic foam-fiber composite (e.g., a plurality of fibers, each fiber having a ceramic foam layer disposed on at least a portion of the fiber, are formed). The ceramic foam may be a hierarchical pore gradient ceramic foam. A method may comprise a sintering step, where the ceramic foam-fiber composite is sintered.
Statement 2. A method according to Statement 1, where the contacting is carried out at an initial pressure of 1-100 psi (e.g., the reaction vessel is pressurized to 1-100 psi), including 0.1 psi values and ranges therebetween, before substantial reaction (e.g., reaction of 5%, 1%, or 0.1%) of the one or more ceramic precursor(s) and/or the pore-forming gas-forming additive(s) and/or, if present, the additive, has reacted.
Statement 3. A method according to Statement 1 or 2, where the ceramic precursor(s) is/are selected from silica precursors, alumina precursors, transition-metal oxide precursors, and combinations thereof.
Statement 4. A method according to Statement 3, where the silica precursor(s) is/are chosen from tetraalkoxysilanes (e.g., TMOS, TEOS, and the like) (e.g., C₁-C₅ alkoxy tetraalkoxysilanes), alkyltrialkoxysilanes (e.g., methyltrimethoxysilane (MTMS) and the like) (e.g., C₁-C₅ alkyl, C₁-C₅ alkoxy alkyltrialkoxysilanes), sodium metasilicates (e.g., water glass), and combinations thereof.
Statement 5. A method according to Statement 3 or 4, where the alumina precursor(s) is/are chosen from aluminum alkoxides (e.g., C₁ to C₆ aluminum alkoxides), alumatrane, tris(alumatranyloxy-i-propyl)amine, and the like, and combinations thereof.
Statement 6. A method according to Statement 3 or 4, where the transition-metal oxide precursor(s) is/are chosen from transition metal alkoxides (e.g., transition metal alkoxides having the formula M(OR)ₓ, where M is a transition metal (for example, Al, Ti (e.g. titanium(IV)-iso-propoxide and the like), Zr, W, Cr, Mo, and the like), and R is at each occurrence an alkyl group and x is 1, 2, 3, 4, or 5) and the like. The transition metal can have various oxidation states (e.g., ⁺1, ⁺2, ⁺3, ⁺4, or ⁺5)).
Statement 7. A method according to any one of the preceding Statements, where the catalyst is a base catalyst (e.g., ammonia, ammonium fluoride, ammonium hydroxide, urea, cetyltrimethylammonium bromide, and the like, and combinations thereof).
Statement 8. A method according to any one of Statements 1-6, where the catalyst is an acid catalyst (e.g., protic acids (e.g., acetic acid and the like), hydrohalic acids, and the like, and combinations thereof).
Statement 9. A method according to any one of the preceding Statements, where the pore-forming gas-forming additive (inert gas-generating agent) is chosen from sodium bicarbonate, urea, and combinations thereof (e.g., where the pore-forming gas-forming additive (inert gas-generating agent) provides a sub-critical amount (e.g. pressure) of inert gas). The pore-forming gas (inert gas) may be carbon dioxide and/or nitrogen and/or ammonia.
Statement 10. A method according to any one of the preceding Statements, where in the one or more additive(s) is/are selected from surfactants (e.g., cetyltrimethylammonium bromide (CTAB)), urea, and combinations thereof. The surfactants may aid in pore formation. The surfactant(s) may also provide surface functionalization.
Statement 11. A method according to any one of the preceding Statements, where the ceramic precursor(s) (e.g., silica precursor(s)), the pore-forming gas-forming additive(s), and optionally, the one or more additive(s)) are contacted and then the catalyst is contacted with the ceramic precursor(s) (e.g., silica precursor(s)), pore-forming gas-forming additive(s) and, optionally, the one or more additive(s)).
Statement 12. A method according to any one of the preceding Statements, where the contacting comprises mixing: one or more fiber(s); one or more ceramic precursor(s), which may be disposed (e.g., dissolved in) water, a solvent (e.g., alcohol, such as, for example, ethanol, and the like), or a combination thereof, one or more pore-forming gas-forming additive(s) (one or more an inert gas-generating agent(s)), which may be disposed (e.g., dissolved in) in water, a catalyst, which may be disposed (e.g., dissolved in) in water. The ceramic precursor(s), pore-forming gas-forming additive(s) (inert gas-generating agent(s)), catalyst(s), and, optionally, additive(s) may be combined in any order. In an example, the catalyst(s) or the fibers is/are the last component added.
Statement 13. A method according to one of the preceding Statements, where the ceramic precursor(s) is/are each present at 2 to 10% by weight (based on the total weight of ceramic precursor(s), catalyst(s), inert gas-generating agent(s), and, if present, additive(s)). Statement 14. A method according to any one of the preceding Statements, where the inert gas-generating agent(s) is/are present at 0.4 to 2% by weight (based on the total weight of ceramic precursor(s), catalyst(s), inert gas-generating agent(s), and, if present, additive(s)). For example, the ceramic precursor(s) is/are at least 5 times larger weight than that of the pore-forming gas-forming additive(s) (the inert gas-generating agent(s)).
Statement 15. A method according to any one of the preceding Statements, where the catalyst is present at 1 to 2% by weight (based on the total weight of ceramic precursor(s), catalyst(s), inert gas-generating agent(s), and, if present, additive(s)).
Statement 16. A method according to any one of the preceding Statements, where one or more additive(s) is/are present at 200 to 1000% by weight, including all 0.1% by weight values and ranges therebetween, (based on the total weight of ceramic precursor(s), catalyst(s), and inert gas-generating agent(s)). For example, the additive(s) is/are are 2 times to 10 times greater by weight than the ceramic precursor(s). For example, the one or more additive(s) is/are present at 10 times the weight of the silica precursor(s), catalyst(s), inert gas-generating agent(s) (based on the total weight of silica precursor(s), catalyst(s), inert gas-generating agent(s)).
Statement 17. A method according to any one of the preceding Statements, where the ratio of 5:1:1:50 (ceramic precursor(s):inert gas agent(s)/pore-forming gas-forming additive(s):catalyst(s):additive(s)) (e.g., 5:1:10 (ceramic precursor(s):inert gas agent(s)/pore-forming gas-forming additive(s):catalyst(s)). In various examples, one or more of these values ranges by 10% or 20%.
Statement 18. A method according to any one of the preceding Statements, where the contacting is carried out at a temperature of room temperature (e.g., 18-23° C.) to 70° C. and/or for 1 minute to 96 hours.
Statement 19. A method according to any one of the preceding Statements, further comprising exchanging (e.g., removing solvent(s)) from the ceramic foam-fiber composite.
Statement 20. A method according to any one of the preceding Statements, further comprising washing the ceramic foam-fiber composite. The washing step may be an exchange step, where undesirable materials (e.g., solvent(s), unreacted ceramic reaction components, and the like) are removed. In various examples, 90% or greater, 95% or greater, 99% or greater, or all observable undesirable materials are removed from the film.
Statement 21. A method according to Statement 20, where the washing comprises contacting the ceramic foam-fiber composite with an aqueous solution (e.g., an aqueous alcohol solution).
Statement 22. A method according to any one of the preceding Statements, further comprising washing the ceramic foam-fiber composite with an alcohol (e.g., ethanol) and/or drying (e.g., APD) the ceramic foam-fiber composite. E.g., subjecting the ceramic foam-fiber composite (e.g., heating the ceramic foam-fiber composite) to a temperature of room temperature (e.g., 18-23° C.) to 100° C. (e.g., 30-60° C.), where the subjecting (or heating) may be under ambient conditions (e.g., ambient pressure conditions, such as, for example, about 1 atm). For example, the hydrophobic coating is compatible with the ceramic foam structure.
Statement 23. A method according to any one of the preceding Statements, further comprising forming a layer (e.g., a film) of hydrophobic carbon-containing material disposed on at least a portion or all of a surface of the ceramic foam. In an example, the ceramic foam (e.g., silica aerogel) is contacted with a silane (e.g., trialkylhalosilanes, such as, for example, trimethylchlorosilane (TMCS), carbon material (e.g., carbon soot), or a combination thereof).
Statement 24. A method according to any one of the preceding Statements, where the fiber is a solid fiber or a hollow fiber.
Statement 25. A method according to any one of the preceding Statements, where the fiber is a textile.
Statement 26. A method according to any one of the preceding Statements, where the fiber is a ceramic fiber, a polymer (e.g., a polymer fiber), or a combination thereof.
Statement 27. A method according to any one of the preceding Statements, further comprising decorating or coating at least a portion or all of a surface (e.g., an exterior surface) of the ceramic foam.
Statement 28. A method according to Statement 27, where the ceramic foam is decorated or coated with a material (e.g., nanoparticles, which may be metal oxide nanoparticles) (e.g., iron oxide nanoparticles, which may be magnetic nanoparticles). E.g., the ceramic foam is decorated or coated using an in-situ reaction by impregnating the foam with material (e.g., nanoparticle precursors, which may metal oxide nanoparticle precursors, and followed by solid state sintering from 200 to 1000° C., including all integer ° C. values and ranges therebetween.
Statement 29. A method according to Statement 28, where the nanoparticles are formed by impregnating the ceramic foam with a nanoparticle precursor (e.g., CuCl₂, FeCl₃, and like, and combinations thereof) and nanoparticles are formed from reaction of the nanoparticle precursor (e.g., heating the impregnated ceramic foam to form nanoparticles) and a nanocomposite material is formed.
Statement 30. A ceramic foam-fiber composite of the present disclosure (e.g., a ceramic foam-fiber composite comprising a plurality of fibers and a ceramic foam) (e.g., a ceramic foam-fiber composite formed from a method of any one of the preceding Statements).
Statement 31. The ceramic foam-fiber composite of Statement 30, where the ceramic foam of the composite is a silica aerogel.
Statement 32. The ceramic foam-fiber composite according to Statement 30 or 31, where the ceramic foam is disposed on a least a portion of a surface of at least a portion (or all) of the fibers of the composite.
Statement 33. The ceramic foam-fiber composite according to any one of Statements 30-32, where the ceramic foam of the composite has a hierarchical pore gradient. At least a portion or all of the pores may be interconnected. The size of the pores (e.g., macropores) generally decrease or increase along a dimension moving from a first surface of the ceramic foam to a second surface opposite the first surface. The gradient may be a linear gradient. The ceramic foam may comprise mesopores and/or macropores. The mesopores may be mesopores as defined by IUPAC.
Statement 34. A ceramic foam-fiber composite according to any one of Statements 30-33, where the ceramic foam comprises a ceramic matrix. The ceramic matrix may be formed from ceramic nanoparticles. The ceramic matrix may be mesoporous.
Statement 35. A ceramic foam-fiber composite according to any one of Statements 30-34, where the ceramic foam comprises pores (e.g., macropores) having a size (e.g., at least one dimension (e.g., a diameter), as measured in a plane parallel to an axis of the pore) and/or at least one dimension (e.g., a height) as measured in a plane perpendicular to an axis of the pore) of 500 microns to 1 micron (e.g., 200 microns to 1 micron or 100 microns to 1 micron).
Statement 36. A ceramic foam-fiber composite according to any one of Statements 30-35, where the ceramic foam is silica aerogel-like and is transparent.
Statement 37. A ceramic foam-fiber composite according to any one of Statements 30-36, where the ceramic foam is 90-99% air (e.g., at least 90%, at least 95%, or at least 98% air), high porosity (<100 nm), low density (˜0.003 g/cm³), and very low thermal conductivity (typically, ˜0.017 W/mK).
Statement 38. A ceramic foam-fiber composite according to any one of Statements 30-37, where the ceramic foam comprises a layer of carbon-containing material disposed on at least a portion or all of a surface (e.g., an exterior surface) of the ceramic foam. E.g., where the thickness (e.g., a dimension perpendicular to a surface of the ceramic foam) is 10 nm or less (e.g., 0.1 to 10 nm). Non-limiting examples of carbon-containing materials include carbon soot, alkyl silane groups, additive (e.g., surfactant) residues (which may be produced by thermal annealing). The layer may be a continuous layer and/or a conformal layer and/or may have a desirably low number of defects (e.g., no observable, which may be visually observable, defects). The layer may be a molecular layer (e.g., a molecular layer of groups, which may be hydrophobic groups). The layer may provide a hydrophobic exterior surface. A carbon-material (e.g., carbon soot) layer may be formed by combustion of a carbon source.
Statement 39. A ceramic foam-fiber composite according to any one of Statements 30-38, where the ceramic foam further comprises nanoparticles disposed on at least a portion of a surface of the ceramic foam.
Statement 40. A ceramic foam-fiber composite according to any one of Statements 30-39, where the ceramic foam-fiber composite is a monolith, a free-standing film, or a film disposed on at least a portion of or all of a substrate. In an example, the ceramic foam-fiber composite is a free-standing film (e.g., a sheet). In an example, the film does not comprise a binder (e.g., a polymer binder). Examples of binders (e.g., polymer binders) for ceramic foam (e.g., silica aerogel materials) are known in the art.
Statement 41. A ceramic film-fiber composite according to Statement 40, where the film has a thickness of ¼ inch to 2 inch.
Statement 42. A ceramic foam-fiber composite according to Statement 40 or 41, where the film is disposed on at least a portion of a surface of a substrate (e.g., aluminum foil, thermal insulation paper, fiber, or the like).
Statement 43. A ceramic foam-fiber composite according to any one of Statements 30-42, where the ceramic foam-fiber composite exhibits one or more or all of the following:
Thermal stability (e.g., thermal stability at least to 2000° C.)
Mechanical strength (e.g., mechanical strength of at least 100 MPa)
Soundproof/acoustic insulation characteristics
   Statement 44. A ceramic foam-fiber composite according to any one of Statements 30-43, where the each individual fiber of the plurality of fibers is a solid fiber or a hollow fiber.
   Statement 45. A ceramic foam-fiber composite according to any one of Statements 30-44, where at least a portion of or all of the plurality of fibers is a textile.
   Statement 46. A ceramic foam-fiber composite according to any one of Statements 30-45, where the each individual fiber of the plurality of fibers is a ceramic fiber or a polymer.
   Statement 47. A ceramic foam-fiber composite according to any one of Statements 30-46, where the amount of fibers is 10-90% by weight (based on the total weight of the ceramic foam-fiber composite).

The following examples are presented to illustrate the present disclosure. These examples are not intended to be limiting in any matter.

### Example 1

This example provides description of examples of ceramic foam-fiber composites of the present disclosure, methods of making the composites, and uses of the composites.

The following fibers were used.
1. Owens Corning® EcoTouch® PINK® Fiberglas™ Insulation with PureFiber® (R-13, Fiber diameter around 10 μm)
2. Unifrax® E-class and C-class fiber. (Fiber diameter around 0.8 μm)

Fiber-Aerogel Paper Fabrication:

Silica Aerogel Precursor Preparation using Water Glass: Firstly, prepare the gas-forming solution (Solution A). Add in 3 mol L⁻¹ Urea (Sigma-Aldrich), 0.3 mol L⁻¹ CTAB (VWR), dissolved with distilled water to 100 ml in beaker Stirring for 3 h (hour(s)) till to all transparent solution. Secondly, Prepare Solution B. 11 mL reagent grade sodium silicate solution (Sigma-Aldrich) was diluted with water by 1:4 volume ratio and then add 2 mol L⁻¹ HCl into the diluted sodium silicate solution until the solution begins semitransparency. Immediately, add the solution A into solution B, and stir for 10 minutes to mix them well as the silica aerogel precursor, which is regarded as one piece of precursor.

Add the commercial fibers into 1000 mL DI water and stir for 3 mins (minutes) to disperse the fibers homogeneously and then add a certain amount of silica precursor prepared in section 1.1. The ratios are listed in Table 1. The wet fiber-precursor paper mats were firstly prepared through vacuum filtration of the mixture solution of Unifrax E08 fibers and silica aerogel precursor. Afterwards, the top and bottom of the wet paper mats would be covered by two rigid papers respectively and sealed in the Zip plastic bag and kept in Oven under 60° C. for 2 days, during which the precursor would react with fibers and strength the bonding between the final aerogel and fibers. Then the flexible fiber-aerogel paper mats are well prepared after slowly drying for 2 days in oven covered by the two thick rigid papers. The different fiber concentrations are tuned by the ratios between fiber weight and the amount of silica precursor. The details are listed in Table 1. The scalable up could be done through tuning the amount of fibers and precursor.

TABLE 1
fiber and precursor ratio

| | | Silica | Fiber | | |
|---|---|---|---|---|---|
| | Fiber | precursor | concentration | Thickness | Diameter |
| # | (g) | (piece) | (wt. %) after drying | (mm) | (mm) |
| 1 | 2 | 1 | 82.3 | 4 | 100 |
| | 2 | 2 | 67.6 | 6 | 100 |
| 2 | 2 | 4 | 41.7 | 8 | 100 |
| 3 | 2 | 6 | 27.2 | 6.2 | 100 |
| 4 | 2 | 12 | 14.98 | 6 | 100 |

Silica Aerogel Preparation through Water Glass: The silica precursor solution prepared above was transferred to a plastic bottle, and the container was tightly sealed. Then place the container into the oven which preheated to 60° C. for 3 days. After completing this process, sample powders were transferred out from the container to distilled water preheated to 60° C. for two days. During this washing process, water was changed several times to remove ammonia and extra CTAB. In this method, the commercial fibers and silica aerogel prepared are simply mixed together without any further reaction. The wet paper mats by vacuum filtration were dried directly in oven for 1-2 days with the thick rigid paper covers.

Silica Gel Preparation through Tetraethyl Orthosilicate: Add in 3 mol L⁻¹ g Urea (Sigma-Aldrich), 0.3 mol L⁻¹ CTAB/SDS, Cetyltrimethylammonium bromide (VWR), 1 mmol Acetic Acid (EMD Millipore Corporation) was dissolved with distilled water to 100 ml in beaker stirring for 3 hours till the solution became all transparent. Then 1.4 mol L⁻¹ tetraethyl orthosilicate (TEOS, Sigma-Aldrich) was added to the solution. Stirring was continued for 10 minutes, the solution turns to homogeneous semi-transparent. Then the solution was transferred to an aluminum vessel, and the container was tightly sealed. The container was placed in an oven (which preheated to 60° C.) for 4 days for gelation. After this gelation process, the sample (gel) was removed from the container and placed in a container filled with distilled water preheated to 60° C. for two days. During this washing process, water was changed several times until the supernatant water was clear and all ammonia was removed. Then the sample (gel) was stored in a sealed container for further application. The blender was set to a certain speed and blending certain amount of DI water in a container. Gradually fiber chopped into small pieces was added and blended for 1 minute (for Unifrax® E-class and C-class fiber), 3 minutes (for Owens Corning® EcoTouch® PINK® Fiberglas™) After the fiber was uniformly dispersed in water, pre-prepared gel was added into the mixture and blended for 1 minute. After the solution become homogeneous, the solution was poured into a sealed caster with a fine grid sheet in middle while a vacuum pump sucked out a large proportion of water, which formed a paper on the grid in the middle of the caster. The paper then was placed into a preheated oven at 60° C. for 24 hours for drying purpose right after the paper was made.

Thermal, Mechanical and Acoustic Characterization:

1. Thermal conductivity measurement customized following the ASTM C518 standard thermal conductivity procedure. Using heat flux sensor bought from Fluxtaq Company calibrated with reference polystyrene commercial heat insulation material.
2. Acoustic test—customized sound box with sound insulation material inside and sound detector brought from Kasuntest. Different fiber-aerogel paper mats test under different frequency generate by the sound source.
3. Mechanical test—both original fiber-aerogel paper mats and sintered mats samples with compression test under different load with multiple cycling times.
4. Humidity aging cycling test measures the thermal conductivity of the sample. The sample was placed under each humidity environment for 5 hours and dried in the preheated oven for another 5 h and repeat the cycling.

### Example 2

This example provides a description of making silica aerogel materials of the present disclosure and characterization of same.

1 g sodium bicarbonate was mixed with 7.08 ml DI water. Added in was 4.59 ml Tetraethyl orthosilicate (TEOS) and 22.34 ml pure ethanol. 1 ml catalyst was also added to speed up the gel formation. The catalyst is a mixture of 1.457 ml ammonium hydroxide (28%), 0.1 g ammonium fluoride and 4.35 ml DI water. After 3 min (min=minute(s)), the gel was washed by DI water and then added in was 500 ml pure ethanol with soaking and stirring for 24 h (h=hour(s)). After soaking, the ethanol was removed. Then 10 ml TMCS (98%) was dropped into the solution. Pure ethanol was also added. CO₂ coming out was observed continuously for next 24 h. At last, the gel was dried in 60° C. ambient environment with ethanol for 24 h to get aerogel product.

### Example 3

This example provides a description of making silica aerogel materials of the present disclosure and characterization of same.

3.3 g of cetyl trimethylammonium bromide (CTAB) and 33.3 g of urea were dissolved in acetic acid aqueous solution (1 mM, 100 mL) following by 20 min stirring. Then, 56.7 mL of Tetraethyl orthosilicate (TEOS) was added. The solution was stirred vigorously for 30 min to form a uniform bubble emulsion which was sealed and then transferred into a preheated oven with 60° C. for 2-day reaction. The as-prepared aerogel was washed by water and dried at room temperature. The resulting aerogel has a light density (around 0.15 g/cm³) and good thermal insulation.

### Example 4

This example provides a description of silica aerogel materials of the present disclosure and characterization of same.

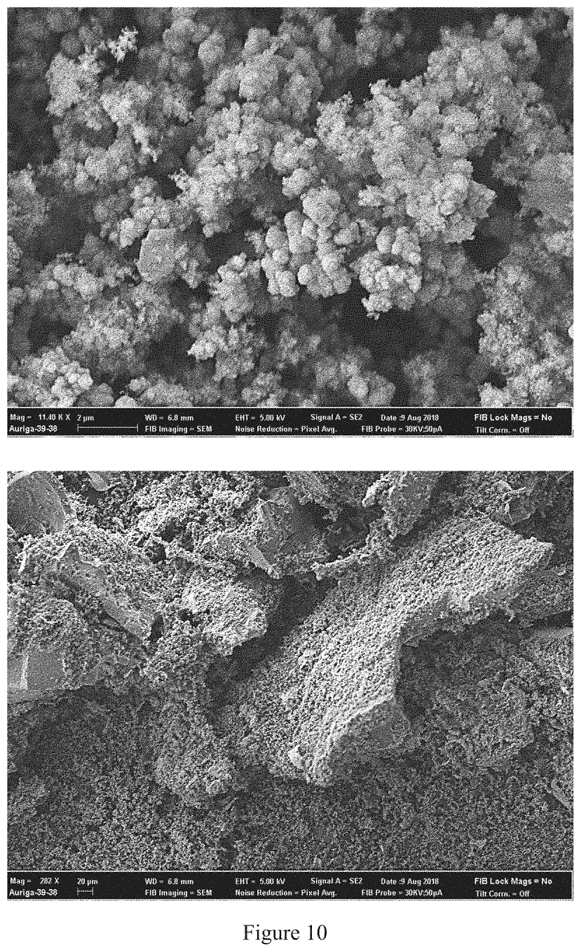

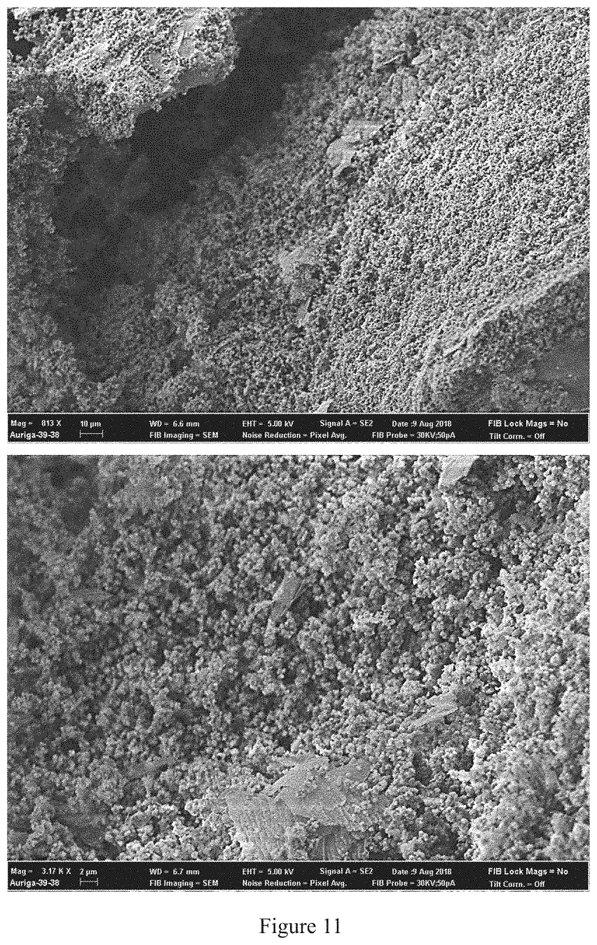

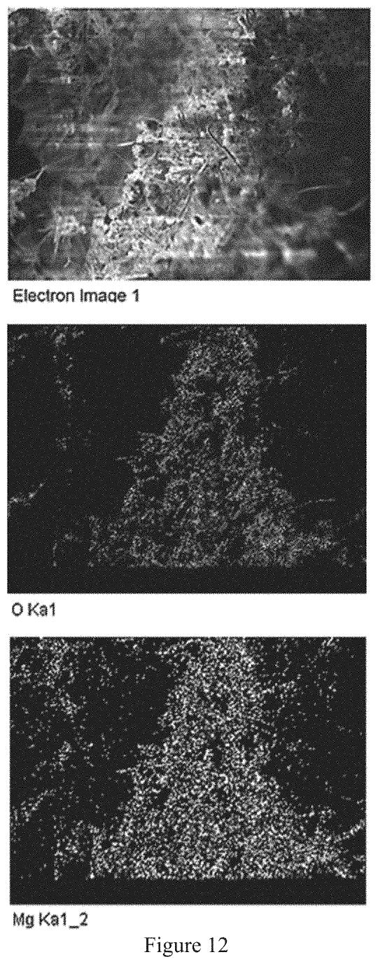

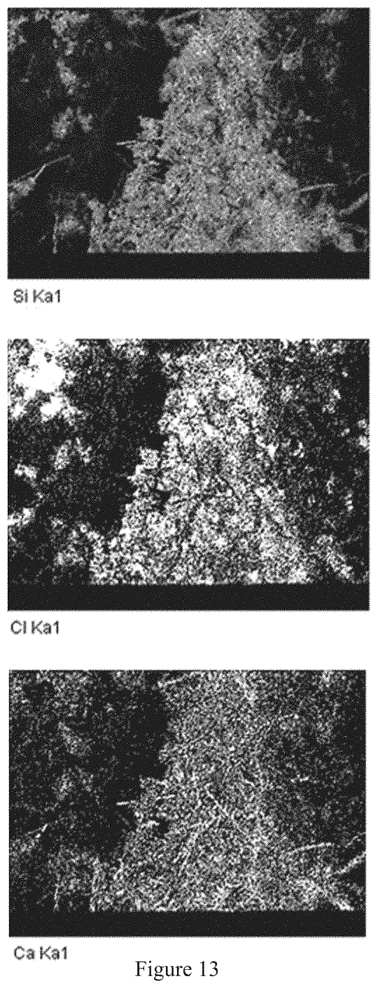

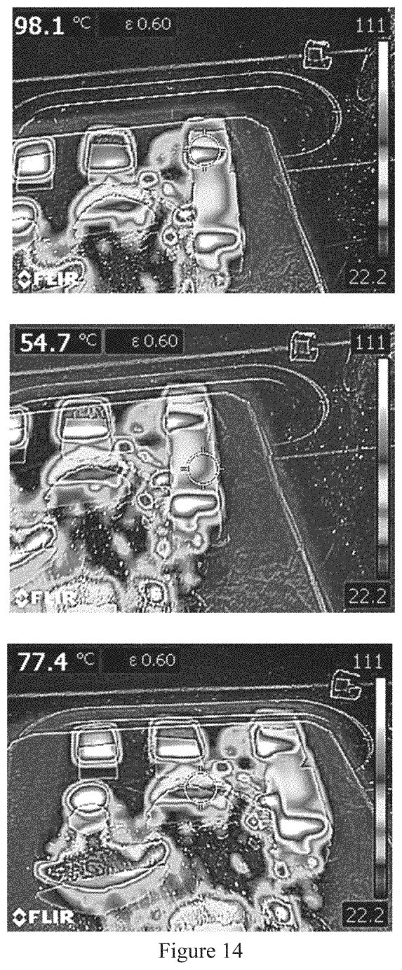

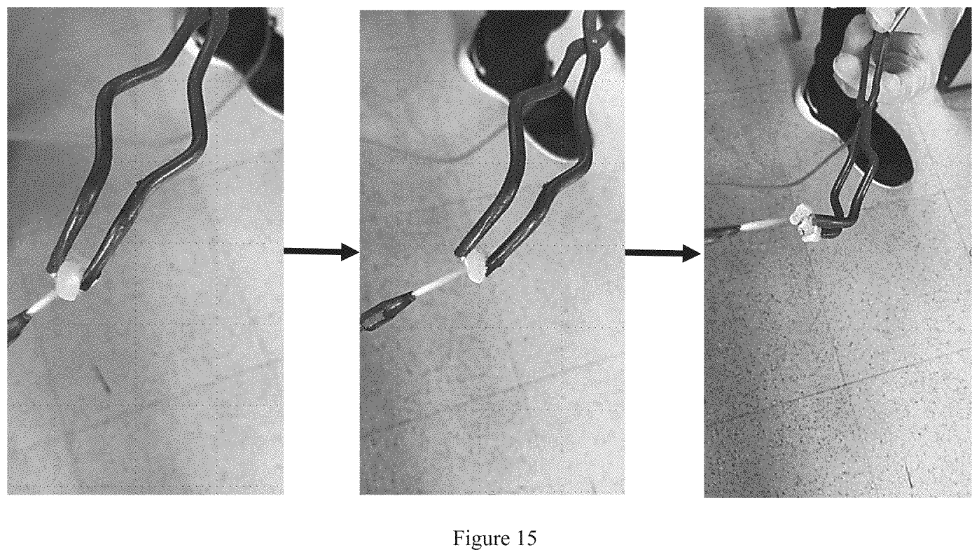

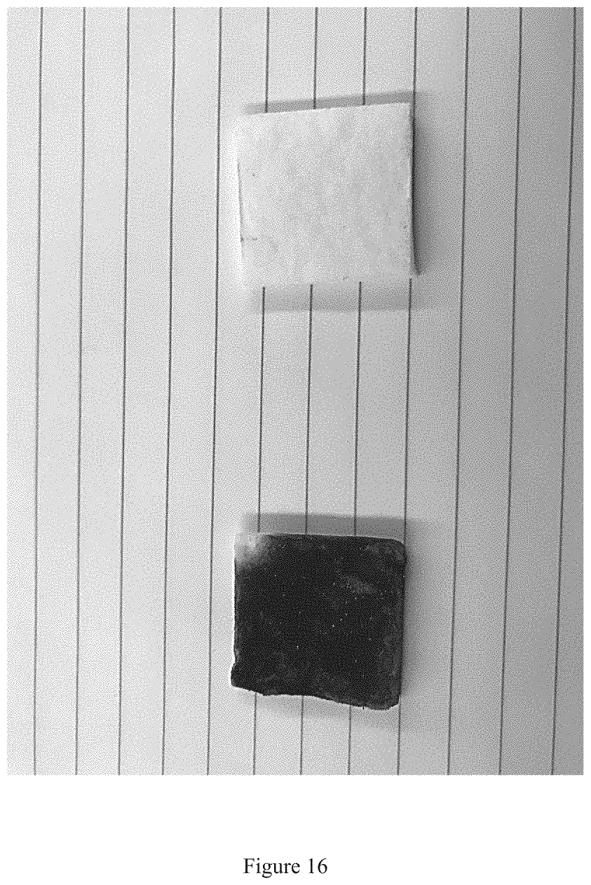

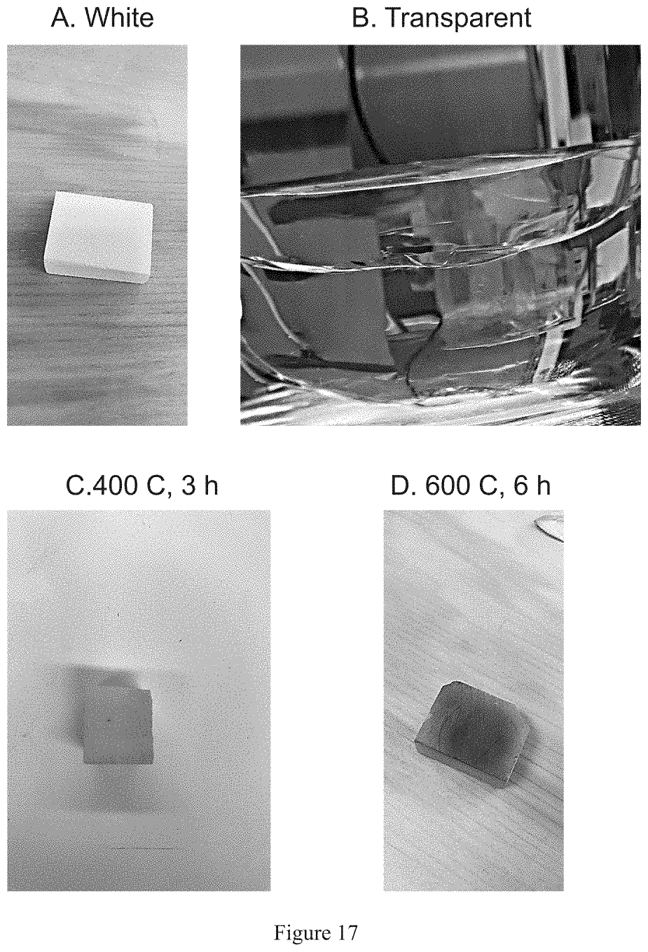

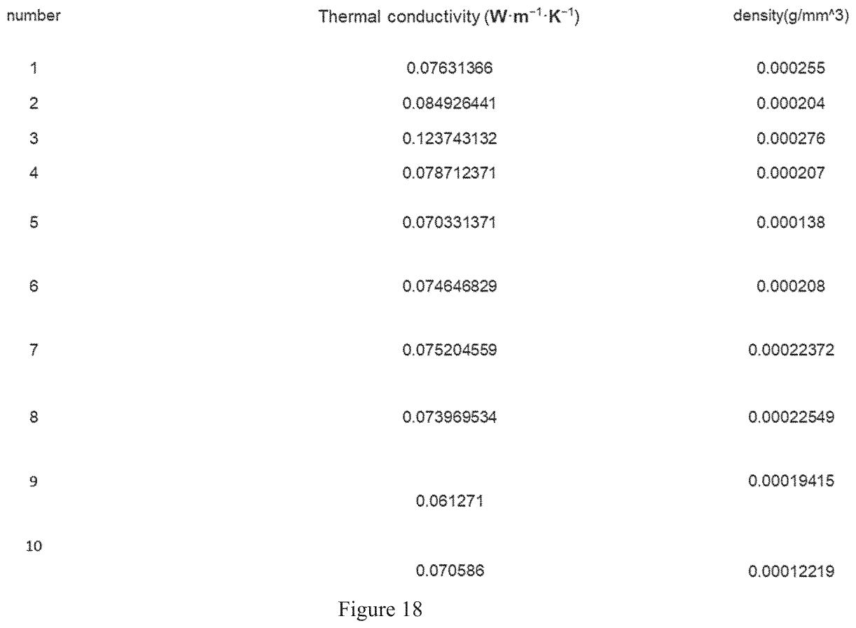

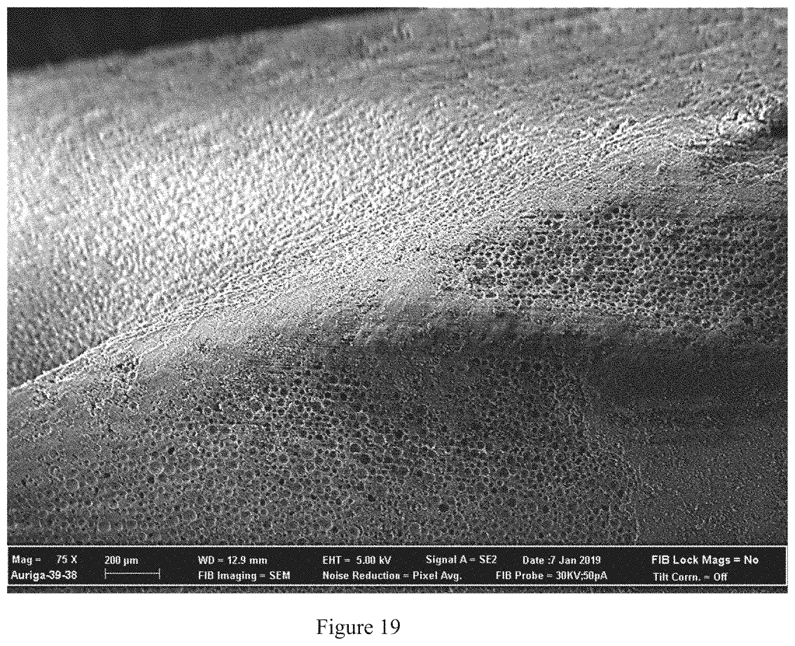

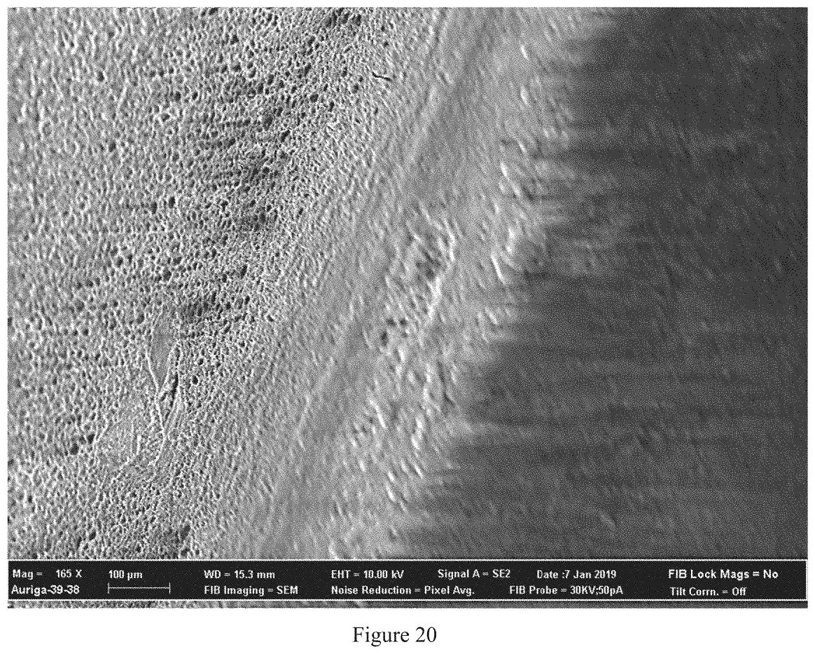

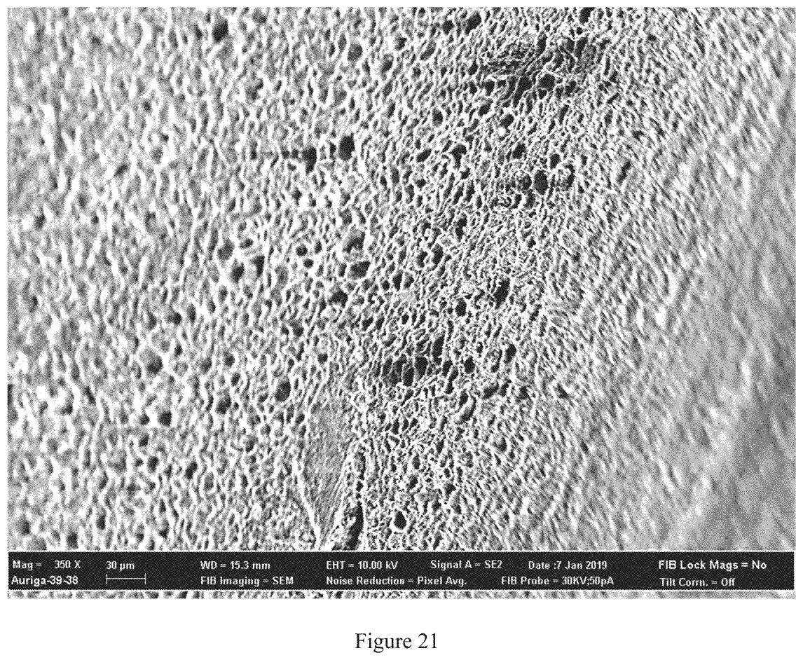

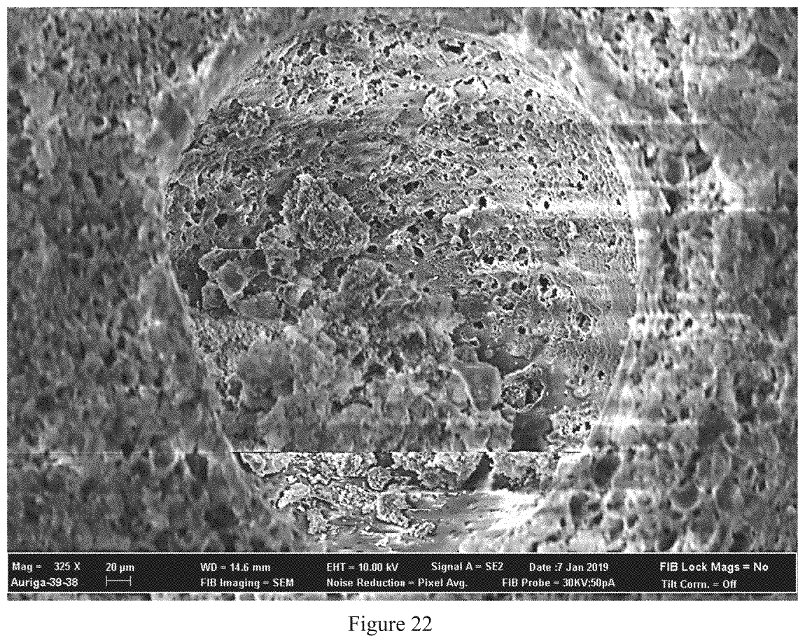

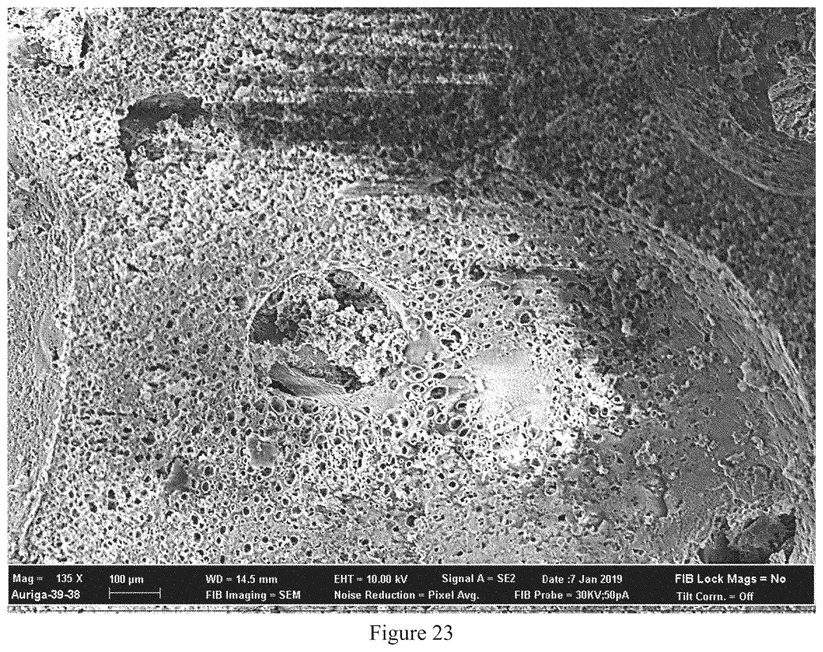

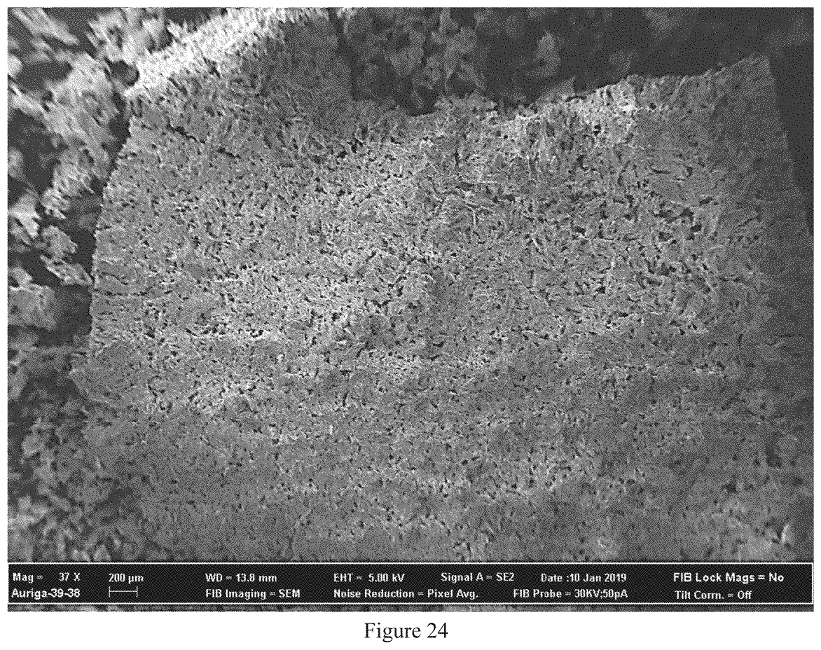

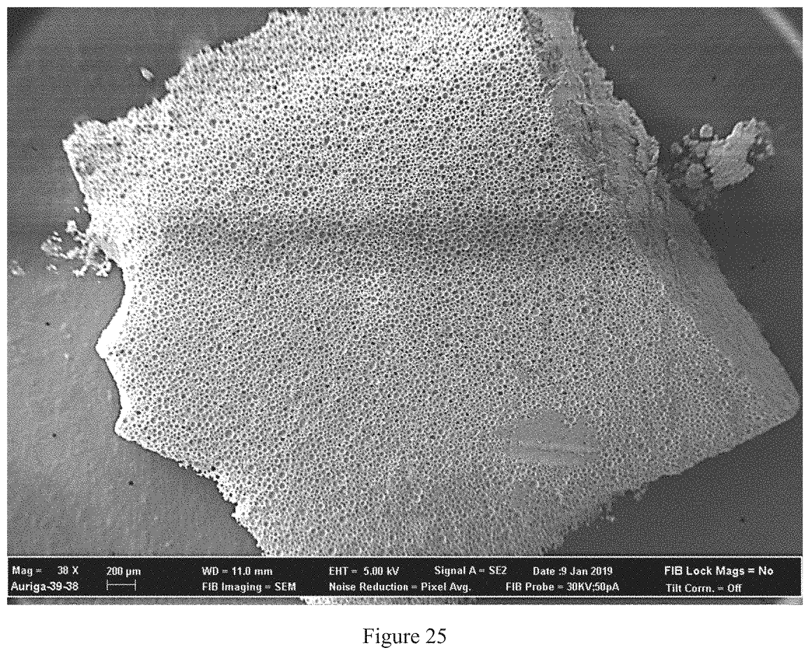

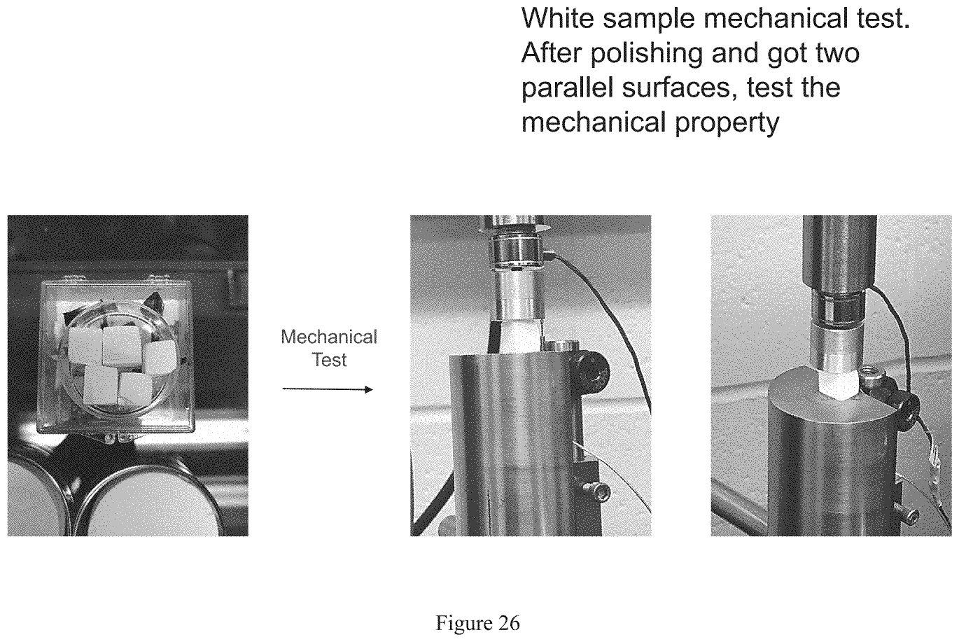

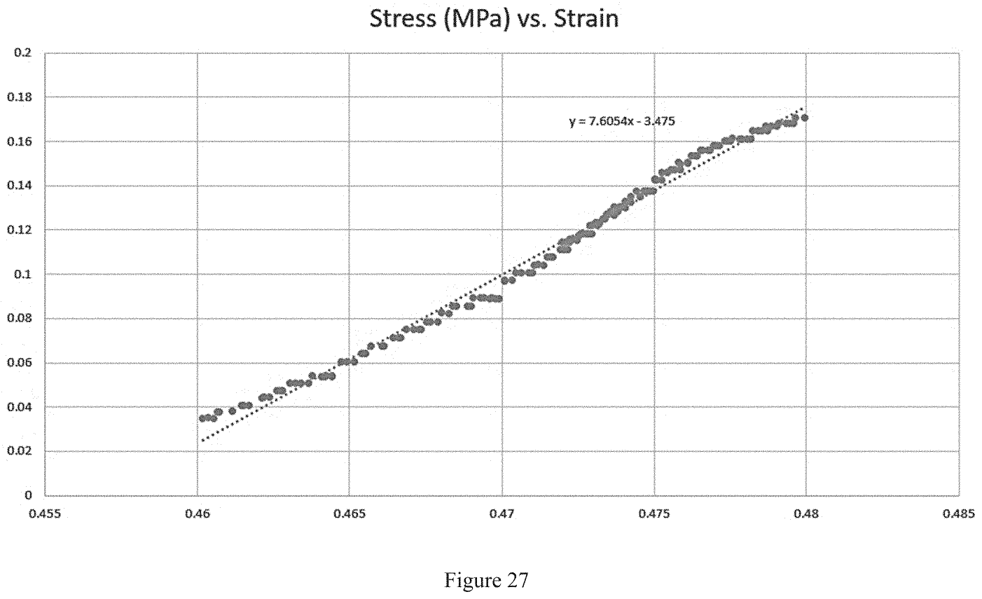

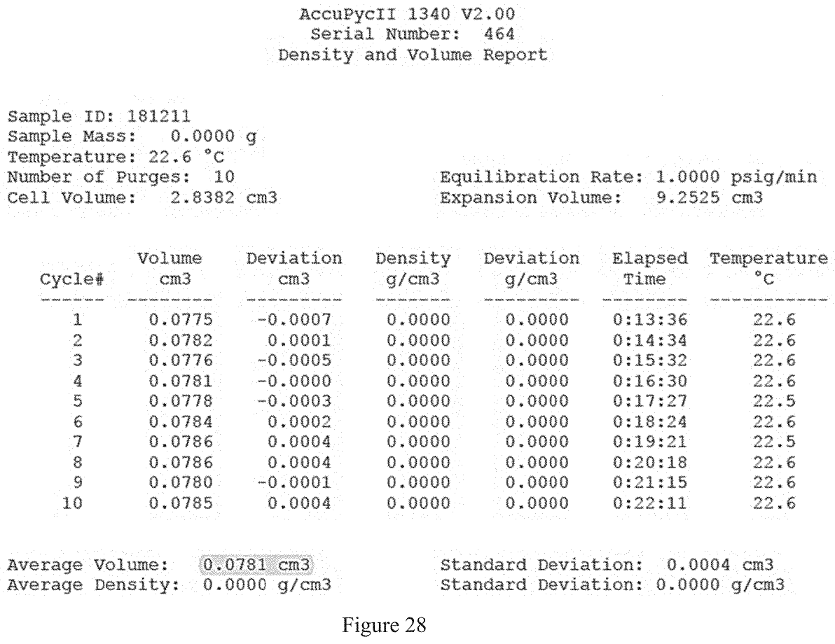

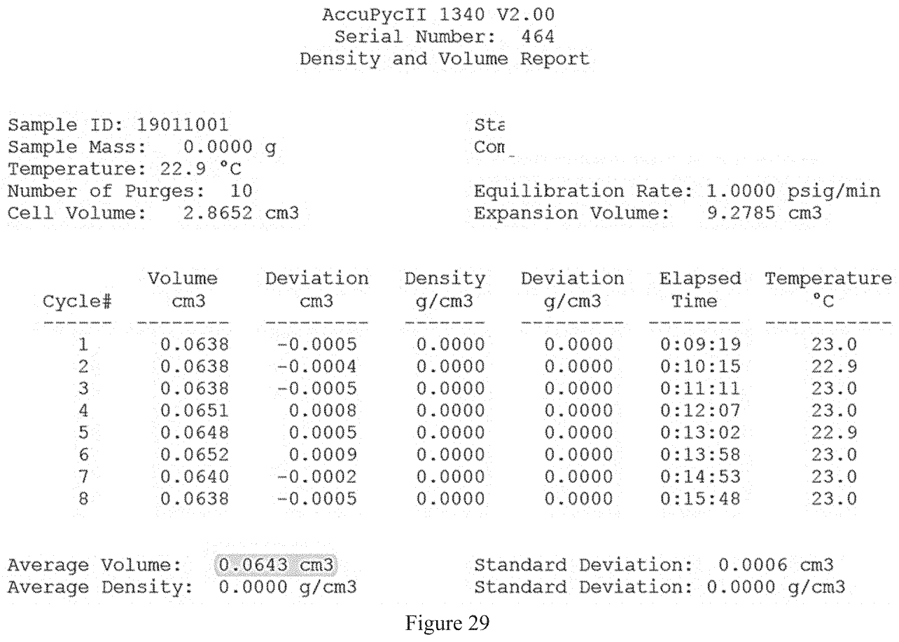

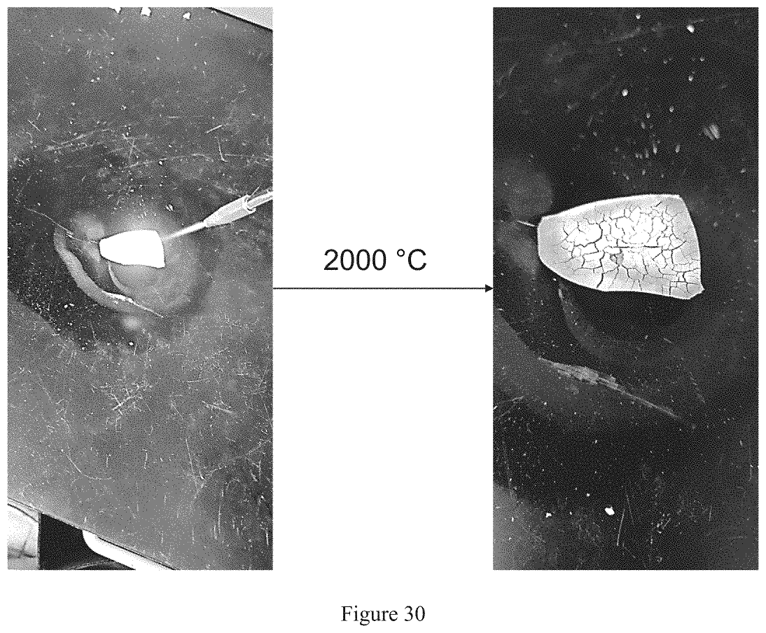

The sample was prepared by running the reaction with a substrate (Unifrax paper) in contact with the reaction mixture. This can be referred to an in-situ infiltration. SEM; energy dispersive x-ray spectroscopy (EDX); and thermal imaging were obtained (FIGS. 10-14).

### Example 5

This example provides a description of methods of making silica aerogel materials of the present disclosure and characterization of same.

Trimethylchlorosilane (TMCS), (CH₃)₃SiCl, were used for surface modification of silica gels, producing HCl as a byproduct, which spontaneously reacted with sodium bicarbonate to generate the pore-supporting carbon dioxide in situ. The carbon dioxide formed is trapped in the wet silica gel, with the pressure in the resulting bubbles opposing capillary pressure, which prevents pore shrinkage and collapse during the ambient pressure-drying step. The silica gel precursors used were aqueous tetraethoxysilane (TEOS, Si(OC₂H₅)₄) and sodium bicarbonate (NaHCO₃), and trimethylchlorosilane used for surface modification.

The low-cost production of aerogel insulation material is expected with in situ APD and R2R manufacturing. The well prescribed gel will be R2R deposited on an inorganic paper substrate carrier. Central to the fabrication of aerogel materials using R2R manufacturing is the formulation of a gel precursor that is robust in printing. The rheological behavior of silica gel plays a critical role for continuous deposition in R2R process, which requires a non-Newtonian liquid with shear thinning behavior. The Weber number (We) and Ohnesorge (Oh) number (or inverse number Z) are used to predict if a stable deposition is achieved:

We=ρv\hat{ }2d/and Z=1/Oh=√ρdσ/μ,

where v is the fluid velocity, d is the nozzle diameter, a is the surface tension and μ is the viscosity. A Brookfield Viscometer was employed to measure the gel viscosity. Surface tension is measured by capillary rise, γ=½ rhρ, where r is the radius of capillary tube, h is the fluid height, and ρ is fluid density.

Nitrogen physisorption was used, with fitting by the Brunauer-Emmett-Teller technique to explore the pore distribution of silica aerogel. The N₂ adsorption-desorption isotherm plot of silica aerogel, indicated the existence of hierarchical pores and relatively sharp pore distribution (the dominant pore size <60 nm).

The mechanical properties are important for building silica aerogel. A honeycomb aerogel structure was fabricated to study stress-strain curves. Compressive strength σ* is strongly influenced by overall density ρ* of sample as seen from equation

σ\hat{ }*/σ_(ts,strut)=C [symbol] (ρ\hat{ }*/ρ_strut) [symbol] \hat{ }c,

where σ\hat{ }* is compressive strength, σ_(ts,strut) is the compressive strength of the strut composing the honeycomb. Thus, the compressive strength of the aerogel is a function of the porosity, thickness and length. The thickness is tailored through R2R printing. The porosity can be tuned by gel concentration and shrinkage.

Thermal insulation performance is a key metric for silica aerogels. The thermal insulation capability of 3D manufactured silica aerogel was investigated. Thermographic analysis showed that the silica aerogel serves as an excellent thermal insulator. Depending on its thickness, thermal insulation of silica aerogel varies. The effective thermal conductivity can be calculated according to the effective medium percolation theory,

λ_eff=¼{[λ_p(3v_p−1)+λ_s(3v_s−1)]+ [symbol] Q [symbol] [λ_p(3v_p−1)+λ_s(3v_s−1)] [symbol] \hat{ }2+8λ_pλ_s) [symbol] \hat{ }(½)}

where λ_s and λ_p are the solid and pore conductivity, and v_s, v_p are their volume fraction, respectively. The thermal conductivity of silica aerogel in this case can be estimated as 0.016 W/mK.

### Example 6

This example provides a description of making ceramic foams materials of the present disclosure and characterization of same.

Pore-gradient silica aerogel-like foam monoliths (PGAeros) were designed and synthesized, where the hierarchical hollow structures and a gradient pore size are controlled by the hydrolysis of tetraethyl orthosilicate (TEOS) in the presence of acetic acid, urea, and cetrimonium bromide (CTAB). The CTAB micelle networks and in-situ gas bubble formation from the thermal decomposition of urea guide the formation of hierarchical pores and pore gradient in PGAeros, respectively. The as-synthesized silica insulation materials show a superior thermal and acoustic insulation and fire-resistant performance with a thermal conductivity as low as 0.040 W m⁻¹ K⁻¹ and high mechanical integrity of the compressive strength of 100.56 MPa, which enables the further shaping and customization for a desired shape and geometry. The acoustic performance is also tested under different frequencies indicating a better soundproof property (sound reduction by 28.3%, or 22.3 db at a thickness of 15 mm at frequency of 2000 Hz) over the reference insulating foam.

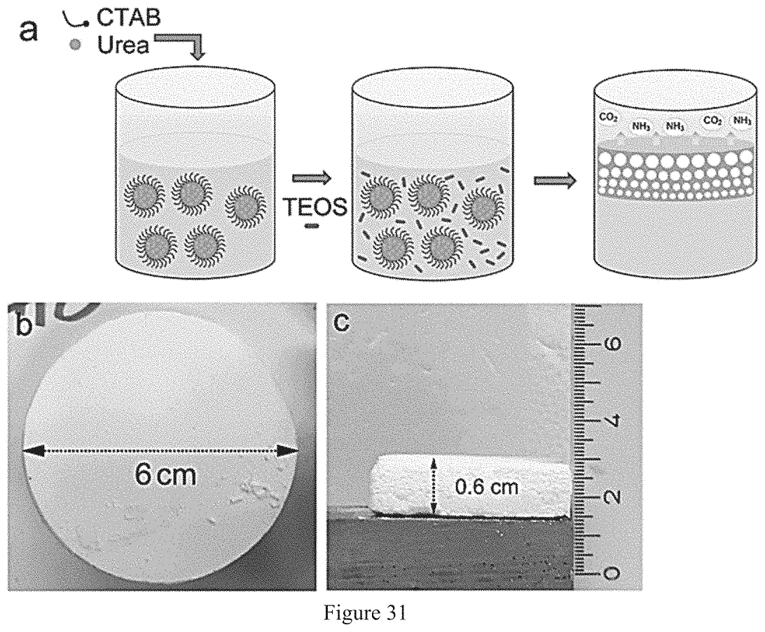

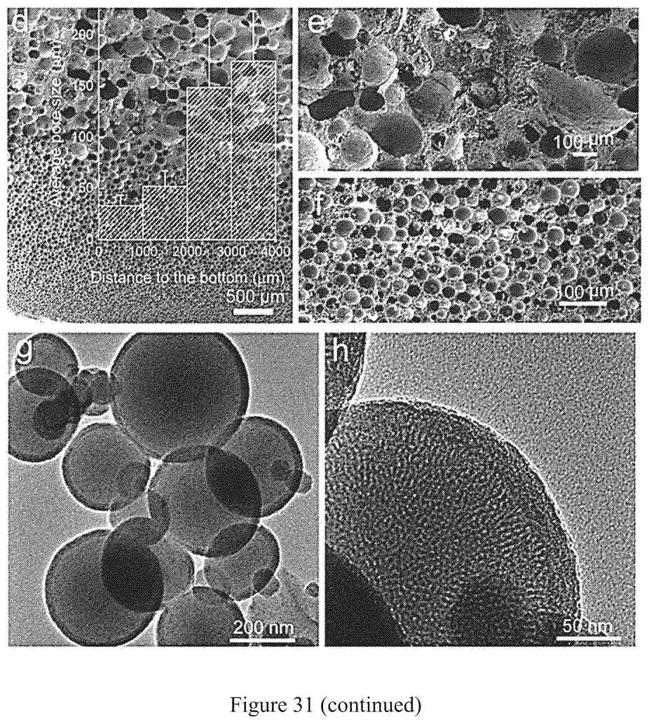

Results and discussion. The scheme in FIG. 31a shows the formation of the hierarchical hollow-structured silica PGAeros which is achieved by a facile one-pot synthesis. The surfactant CTAB is used to form the micelles in the mixture solution of TEOS and water. The hydrolysis of TEOS is proceeded at the shell of the as-formed micelles, which serve as templates leading to the formation of silica shells. The urea addition accelerates the polymerization of silicon alkoxides by raising the solution pH, while it can work as in-situ foaming agent due to its thermal hydrolysis into ammonia (NH₃) and carbon dioxide (CO₂). The as-formed silica PGAeros float on the water surface due to its low mass density. Continuous decomposition of urea and thereafter release of in-situ carbon dioxide and ammonia gas bubbles build a high pressure in the upper part of the reaction chamber, which leads to the foaming process from the top to the bottom resulting in the pore gradient in PGAeros. FIG. 31b shows the typical photograph of the as-grown opaque silica PGAeros, which can be cut and polished into a desired shape for the further studies (as shown in FIG. 31c). The pore gradient can be readily observed from the scanning electron microscopy (SEM) image (FIG. 31d), exhibiting an increase of average pore size from the top to the bottom, where the dimension of pore is dependent on the reaction conditions, such as the chemical concentrations, reaction temperature and time (These are discussed in the following sections). The average pore size of PGAeros from the bottom to the top regions was calculated indicating an increase from 33.3 μm to 174.8 μm at the ratio of TEOS:CTAB:Urea=27.8:1:60.7 (Insert in FIG. 31d). The high-resolution SEM images of PGAeros at the large-pore and small-pore regions are shown in FIGS. 31e and 31f, respectively. In addition, the as-synthesized silica PGAeros show a porosity of 94.1% by Pycnometer and low density of 0.128 g cm⁻³. The solid networks of PGAeros is constructed by nanoscale silica particles which were further characterized by transmission electron microscopy (TEM). As shown in FIGS. 31g and h, a large number of micropores in each particle was clearly observed presumably due to the template effect of CTAB molecules. Therefore, silica PGAeros were obtained with high porosity and low density due to the hierarchical hollow structures with gradient macroscale pores and mesopores inside the silica networks, which can be expected to render the as-synthesized silica PGAero with confined gas thermal conduction and high phonon scattering resulting in a high insulting performance.

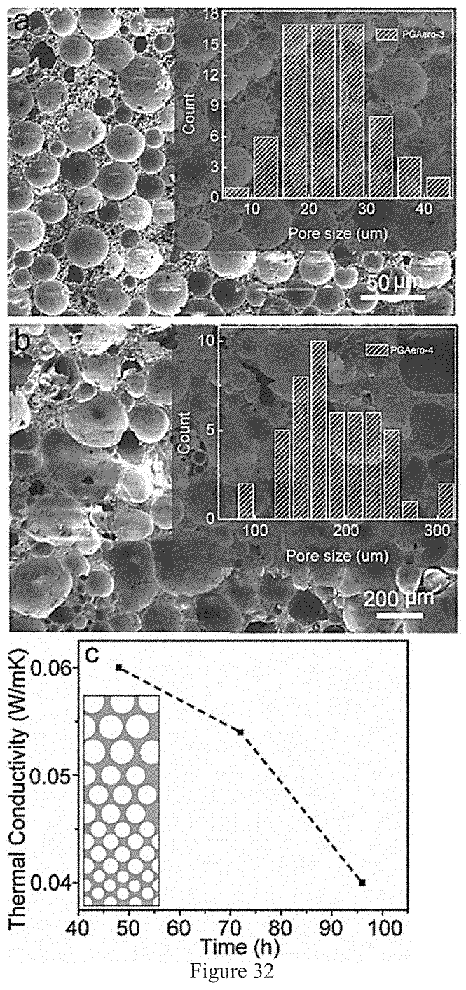

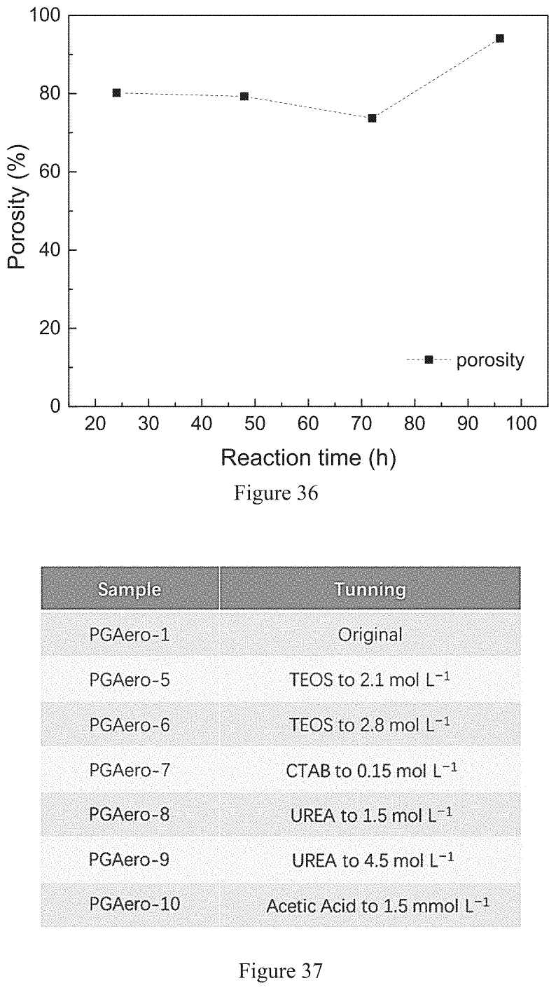

To understand and control the pore gradient formation in PGAeros, a series of experiments were designed to synthesize PGAeros with less reaction periods of 24 h, 48 h, and 72 h (nominated by PGAero-2, PGAero-3, PGAero-4, respectively). Compared with the original sample synthesized by the reaction time of 96 h with a pore gradient (referred as PGAero-1), the silica PGAeros by 24 h has a uniform pore size of 27.5 μm and a standard deviation of 9.4 μm (FIG. 35 a, b). With the increase of the reaction time to 48 h, the gradient pore of PGAeros is gradually formed resulting in a larger pore deviation as shown in FIG. 32a. When the reaction time is increased to 72 h, the pore size of PGAeros shows a wide range from 15 μm to 300 μm with a much larger deviation of 85.3 μm (FIG. 32b). The porosities of silica PGAeros maintain around 80% with a slight decrease by increasing the reaction time due to continuous growth of silica (FIG. 36). The pore gradient with increased pore size and decrease of porosity show the competition effects on the insulation performance. The decrease of porosities of silica PGAeros synthesized from 24 h to 48 h primarily results in an increased of thermal conductivity from 0.049 W m⁻¹ K⁻¹ to 0.060 W m⁻¹ K⁻¹. In the meantime, the pore gradient with the increased pore size dominates the insulating performance, leading to a lower thermal conductivity of 0.054 W m⁻¹ K⁻¹. Further increasing the reaction time renders the silica PGAero with a lowest thermal conductivity of 0.040 W m⁻¹ K⁻¹ (FIG. 32c).

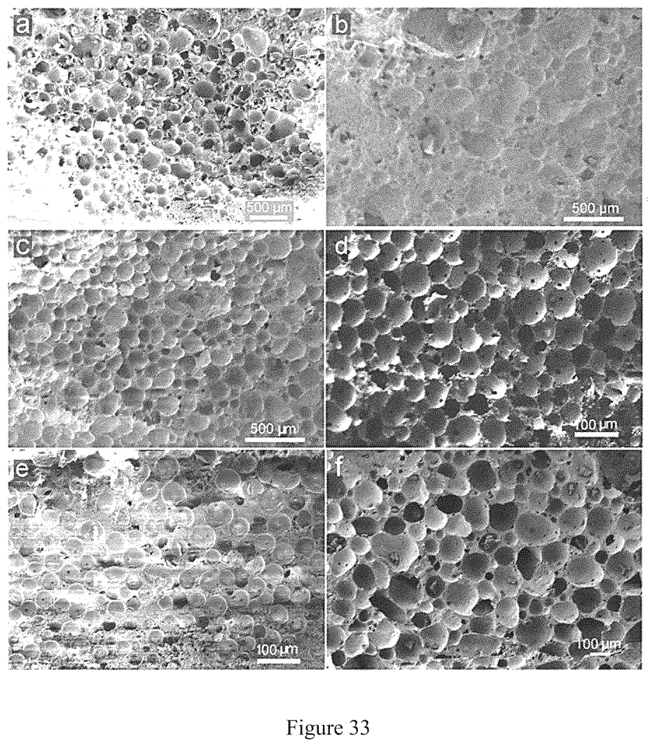

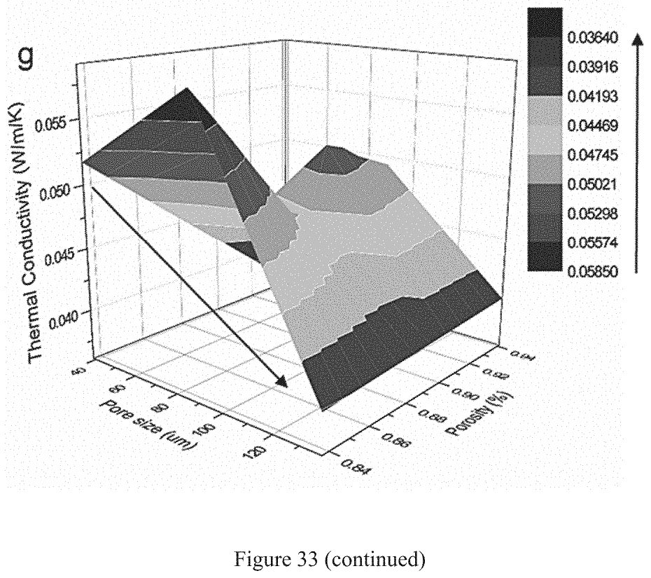

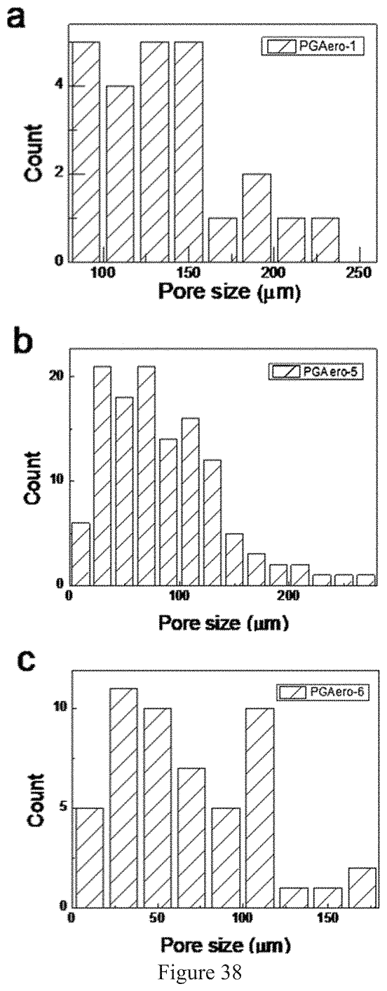

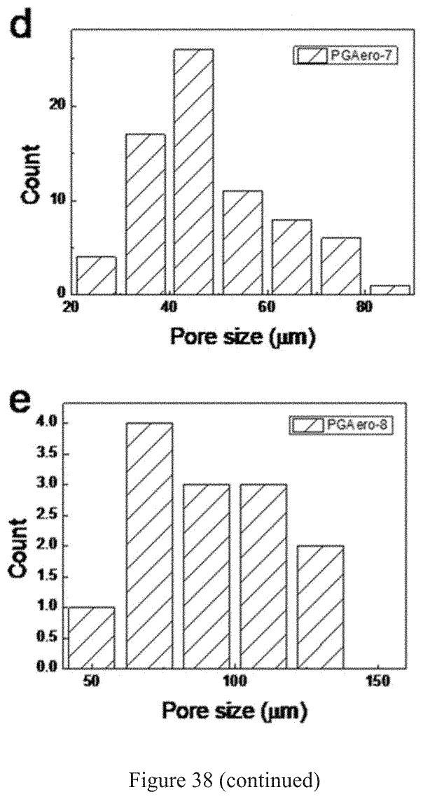

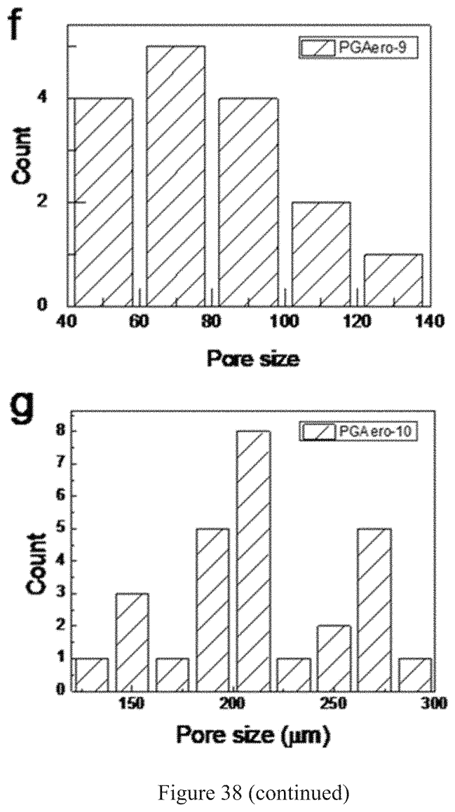

The average pore size and porosities was investigated by tuning the reaction conditions and their correlation with thermal conductivity of PGAeros (FIG. 37). Typical SEM cross-sectional images of silica PGAeros are shown in FIG. 33a-33f. The average pore size of each sample was calculated by counting more than 100 pores via SEM images as shown in FIG. 38a-g. Increasing the concentration of TEOS from 1.4 mol L⁻¹ of the PGAero-1 sample (with the average pore size of 138.3 μm and porosity of 94.1%) to 2.1 mol L⁻¹ and 2.8 mol L⁻¹ corresponding to PGAero-5 and PGAero-6, resulting in enhanced average pore sizes of 85.0 μm and 68.4 μm and porosities of 89% and 88% (FIG. 33a-33c). The increase of TEOS concentrations decreases the average pore size and porosity, leading to a highly densified silica PGAeros which bring a higher thermal conductivity from 0.040 W m⁻¹ K⁻¹ to 0.049 W m⁻¹ K⁻¹ (PGAero-5) and 0.055 W m⁻¹ K⁻¹ (PGAero-6). The increase of thermal conductivity mainly because the increase of solid thermal transport through the high-component silica network. The concentration of CTAB initially determines the pore size of the silica PGAeros, in which less CTAB component results in a smaller average pore size of PGAeros by comparing FIGS. 33a and 33d (PGAero-7). The urea addition serves as a mineralizing chemical and in-situ gas bubble foaming agent, and therefore increasing the urea addition can result in a larger pore size and lower mass density. As shown in FIGS. 33f and 33g, changing the urea from 1.5 mol L⁻¹ (PGAero-8) to 4.5 mol L⁻¹ (PGAero-9), the pore size of as-formed silica PGAeros can be significantly increased from 38.65 μm to 110.39 μm. The thermal insulating performance is highly correlated with the pore sizes and porosities of silica PGAeros. FIG. 33g shows the thermal conductivities of different silica PGAeros, dependent on the pore sizes and porosities. Large pore size and high porosity bring a low thermal conductivity of PGAeros. The lowest thermal conductivity of 0.040 W m⁻¹ K⁻¹ can be achieved by the silica PGAeros synthesized by TEOS:CTAB:Urea=27.8:1:60.7.

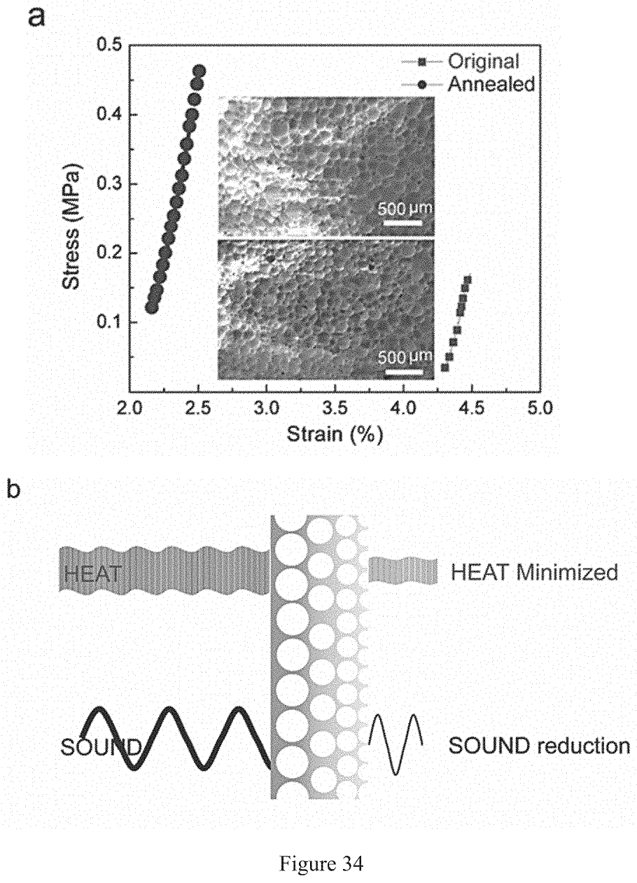

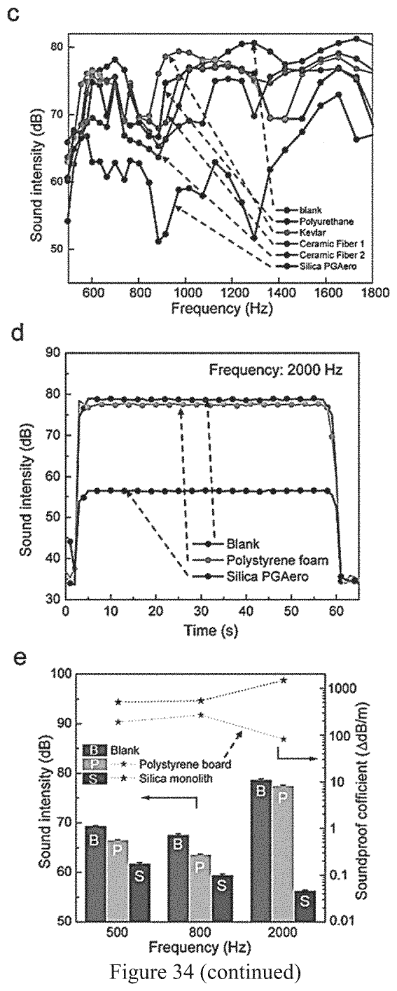

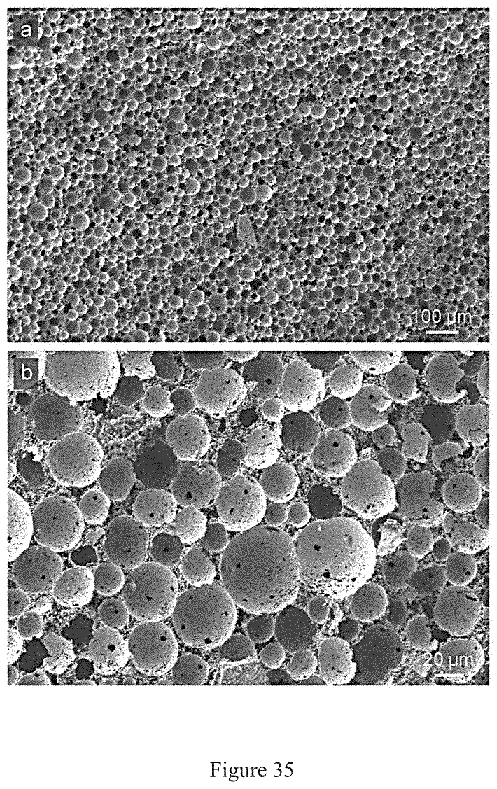

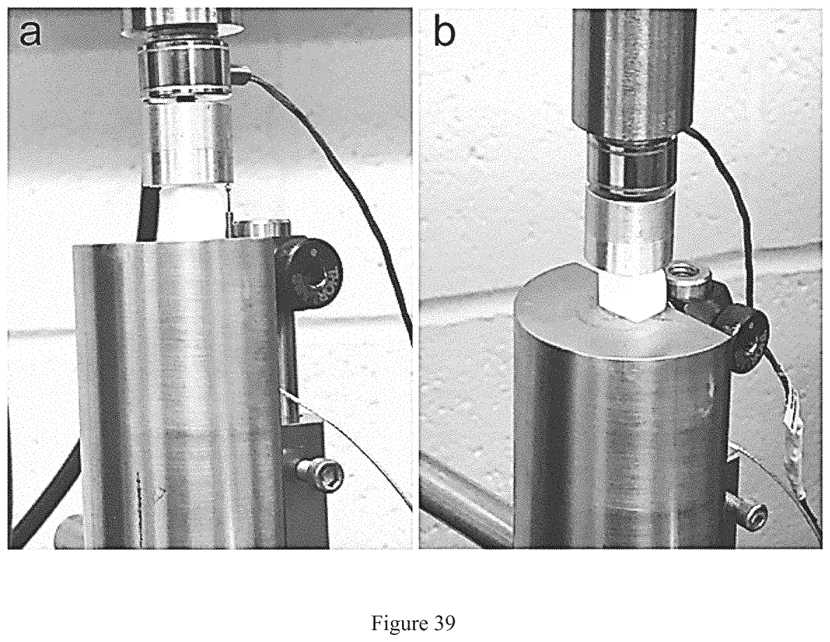

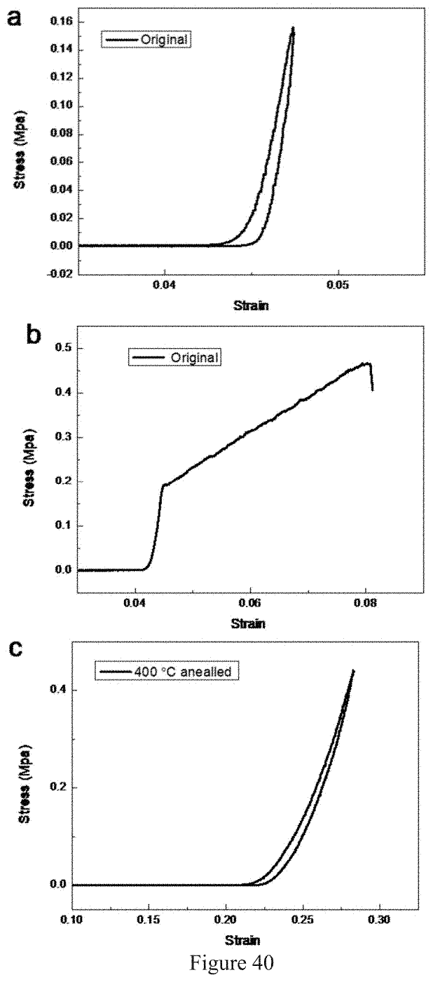

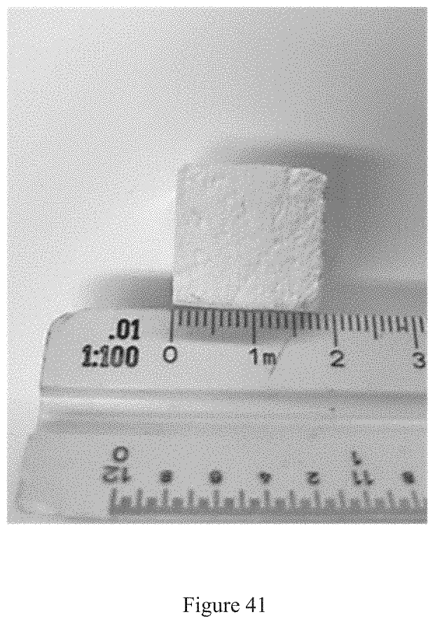

Mechanical stability of silica aerogels is key to its large-scale commercial applications. The gradient pore structure has been reported with a great advantage on optimizing the mechanical performance. The silica PGAeros with pore gradient were synthesized as a monolithic form has a high mechanical strength, which was characterized by the uniaxial compression test (FIG. 39). The stress-strain curve of silica PGAero-1 indicates a high mechanical strength with a high Young's module of 81.33 MPa which can be further increased to 100.56 MPa by a post annealing treatment at 400° C. for 2 h (FIGS. 34a and 40a-c). The inset of FIG. 34a shows the SEM images of silica PGAeros before (upper) and after (bottom) annealing, the robust pore structure renders the silica PGAeros with a good mechanical integrity. The silica PGAeros before and after annealing has a thermal conductivity of 0.040 W m⁻¹ K⁻¹ and 0.044 W m⁻¹ K⁻¹, respectively. The annealing treatment improves the mechanical property without compromising the insulating performance. Importantly, the mechanically robust foam can maintain the low thermal conductivity of 0.060 W m⁻¹ K⁻¹ after a long-term annealing at 1000° C. for 24 h as shown in FIG. 41. The highly mechanical robustness and thermal stability render the synthesized silica PGAero show great promising for the increased demanding of insulation materials applied to extreme environment.

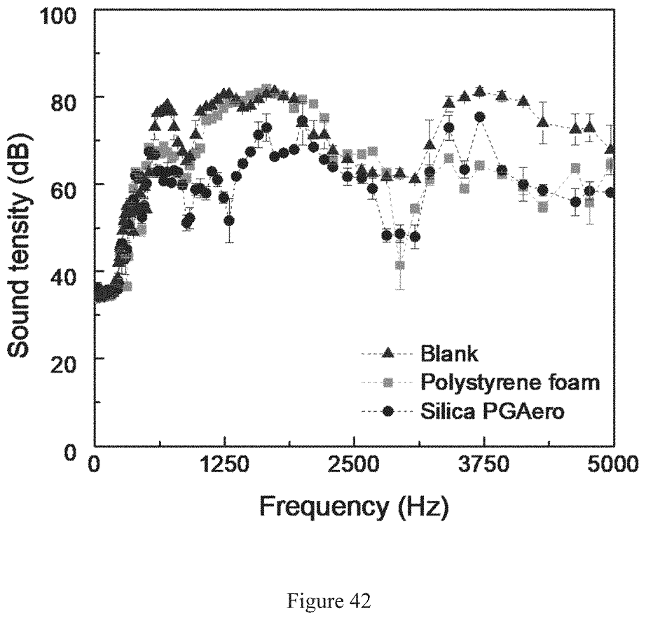

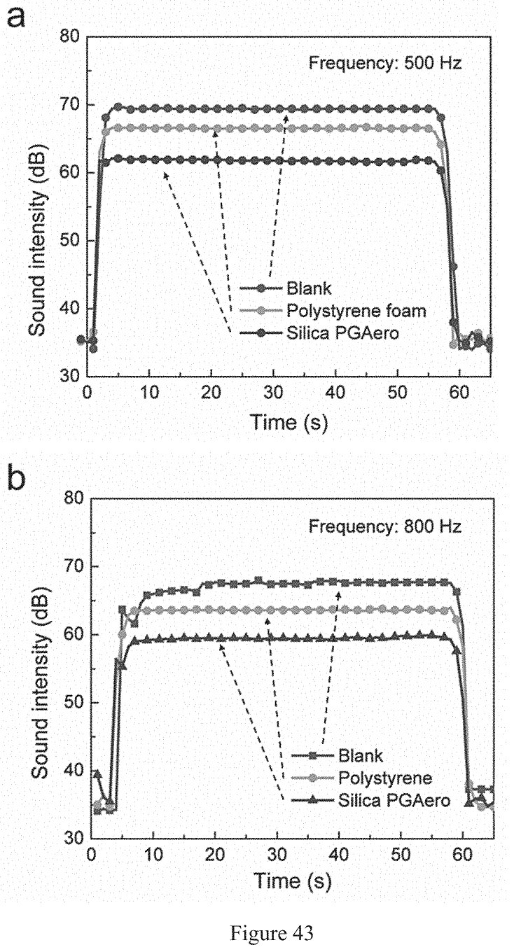

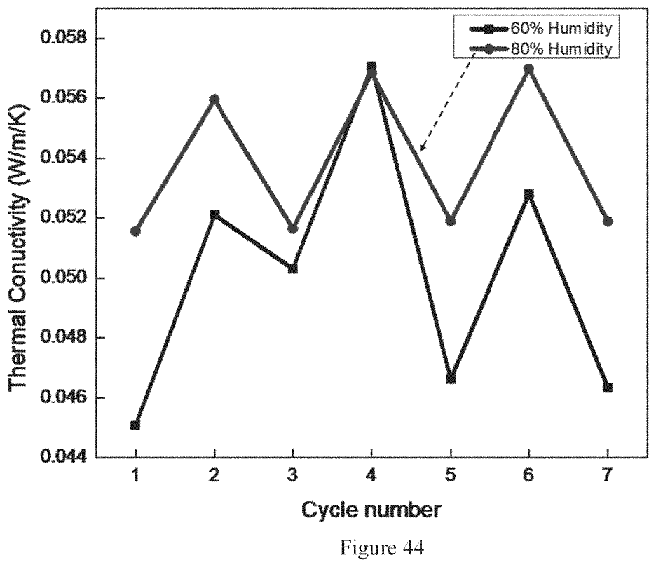

The acoustic insulation for soundproof plays an important role in superinsulation applications. The sound wave and heat both could be significantly reduced by the silica PGAero with pore gradient structure, shown in FIG. 34b. The detected sound intensities without any sample (blank control) and through a silica PGAeros and polystyrene reference are plotted as shown in FIG. 42. Furthermore, several commonly used commercial soundproof material like polyurethane, Kevlar and two types of ceramic fiber blankets. The silica PGAero shows a low detected sound intensity across the whole frequency range from (500 Hz to 1800 Hz) indicating a much better soundproof performance compare to all those common used commercial soundproof materials shown in FIG. 34c. The silica PGAeros with a thickness of 0.014 m has a better soundproof performance comparing with the reference PS foam at different frequencies of 500 Hz, 800 Hz, and 2000 Hz, showing the noise reductions of 10.9%, 12.0%, and 28.4%, respectively (FIG. 34e, 43a, b). Especially under the sound frequency of 2000 Hz, FIG. 34d). To calibrate the thickness-independent soundproof performance, a soundproof coefficient is defined by dividing the noise reduction with the sample thickness. The soundproof coefficients of silica PGAeros show 2.7, 2.0, and 18.2 times higher than those of the reference sample at 500 Hz, 800 Hz, and 2000 Hz, respectively. Besides mechanical and acoustic soundproof properties, the hygroscopic performance of silica PGAeros was investigated under a humid environment. Two kinds of PGAeros with an initial thermal conductivity of 0.045 W m⁻¹ K⁻¹ and 0.052 W m⁻¹ K⁻¹ were selected for the hygroscopic experiments under the humidity of 60% and 80%, respectively. High humidity condition results in an increased thermal conductivity, which can be recovered after drying at 60° C. (FIG. 44). The cycling experiments show that the thermal conductivity of PGAeros can be restored back to the initial point with a loss of less than 16%.

Light-weight silica PGAeros with a high porosity and large pore gradient for thermal and acoustic superinsulation were developed. Micelle-mediated growth of silica and gas foaming process due to the thermal hydrolysis of urea together lead to the pore generation and gradient formation. The well-designed monolithic geometry with unique pore structures and ceramic nature provide such PGAeros with a superior thermal insulation and fire-resistant performance across a wide temperature range with a thermal conductivity as low as 0.040 W m⁻¹ K⁻¹ and high mechanical integrity of the compressive strength of 100.56 MPa. Such silica PGAeros also show a better soundproof property under different frequencies with sound reduction by 28.3%, or 22.3 db at a thickness of 15 mm at frequency of 2,000 Hz higher than that of the reference insulating foam. Stability under humidity environment also has been proven to be reliable for long-term period. It is considered that a material with high thermal insulation and soundproof performance and in the meantime maintain the thermal conductivity could be suitable for next generation construction material and other applications.

Materials and Experiment. Experimental: Preparation: Add in 3 mol L⁻¹ g Urea (Sigma-Aldrich), 0.3 mol L⁻¹ CTAB (VWR), 1 mmol Acetic Acid (EMD Millipore Corporation) dissolved with distilled water to 100 ml in beaker Stirring for 3 h till to all transparent solution. Then 1.4 mol L⁻¹ TEOS (Sigma-Aldrich) was add into the solution. Continue stirring for 10 minutes, the solution turns to homogeneous semitransparent. Then transfer the solution to plastic bottle, and tightly seal the container. Then place the container into the oven which preheated to 60° C. for 4 days. After this gelation process, sample was taken out from the container to distilled water preheated to 60° C. for two days. During this washing process, water has been changed several times till the supernatant water is clear and all ammonia is removed. The sample was placed into the preheated oven at 60° C. for two days for drying purpose right after the washing step completed.

Characterization: Thermal conductivity measurement home customized follow the ASTM C518 standard thermal conductivity procedure. Using heat flux sensor bought from Fluxtaq Company and calibrated with reference polystyrene commercial heat insulation material.

Acoustic test, home customized sound box with sound insulation material inside and sound detector bought from Kasuntest. Different thickness sample test under different frequency generate by the sound source.

Pycnometer test using helium gas to penetrate the porous sample in the chamber to get the volume of the solid part of the sample. With known the solid part of the sample we can calculate the porosity of the silica foam sample.

Mechanical test, both original silica foam sample and after 400° C. heat synthesis bulk sample with compression test under different load with multiple cycling times.

Humidity aging cycling test measures the thermal conductivity of the sample. The sample was placed under each humidity environment for 24 h and dried in the preheated oven for another 24 h and repeat the cycling.

### Example 7

This example provides a description of making ceramic foams materials of the present disclosure and characterization of same.

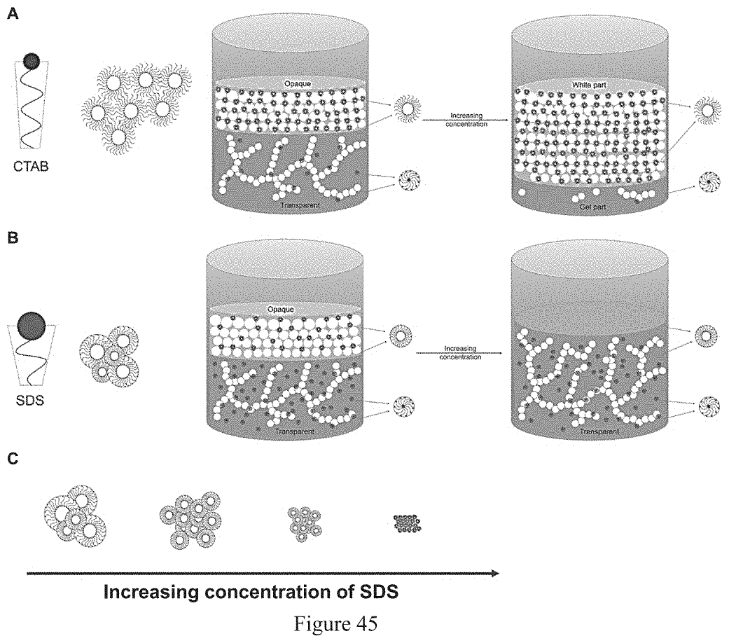

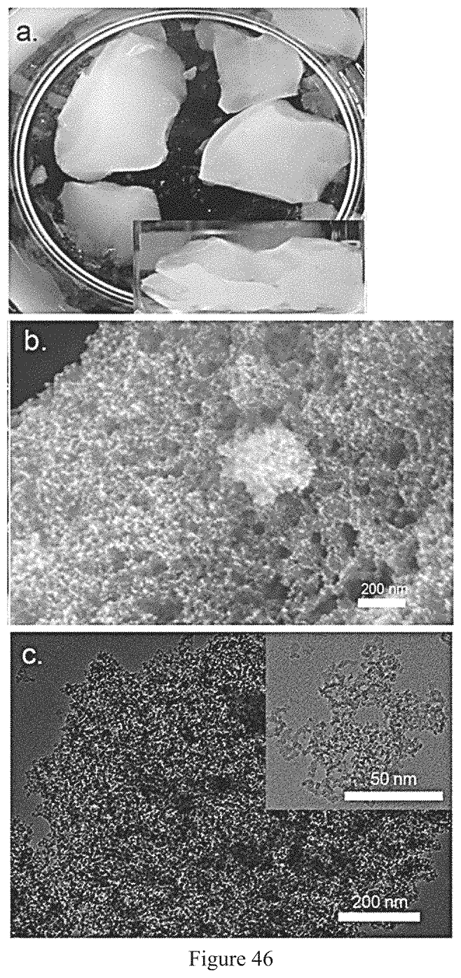

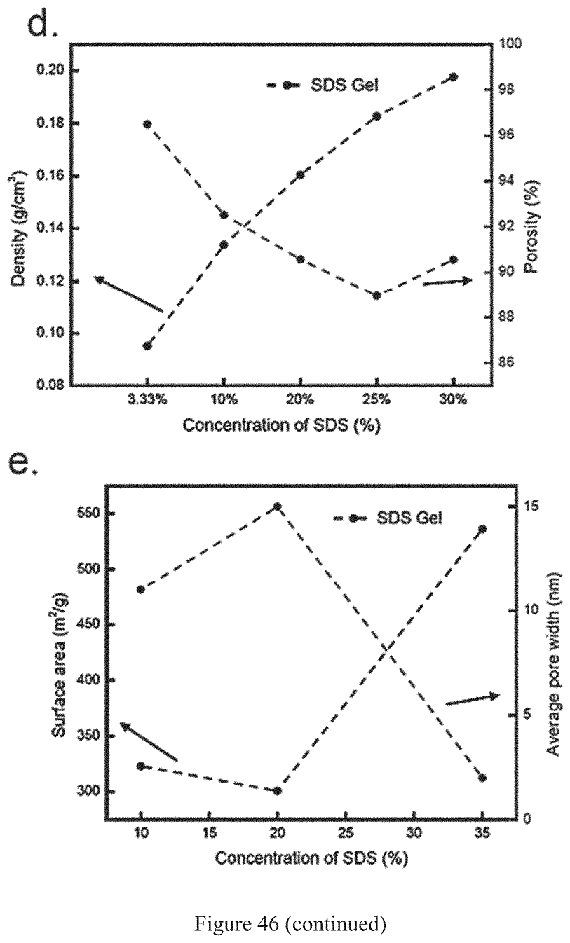

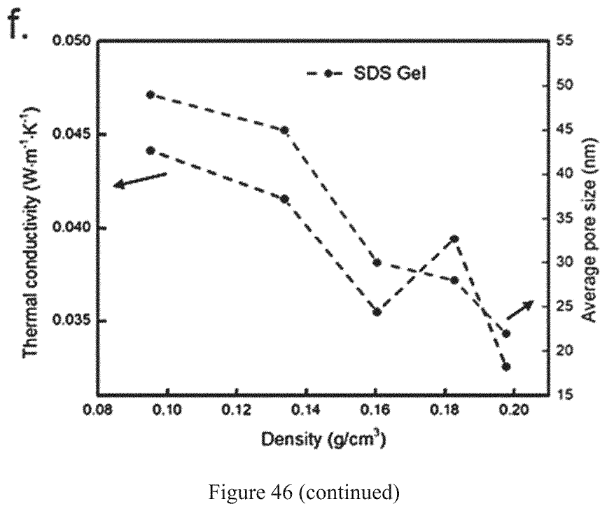

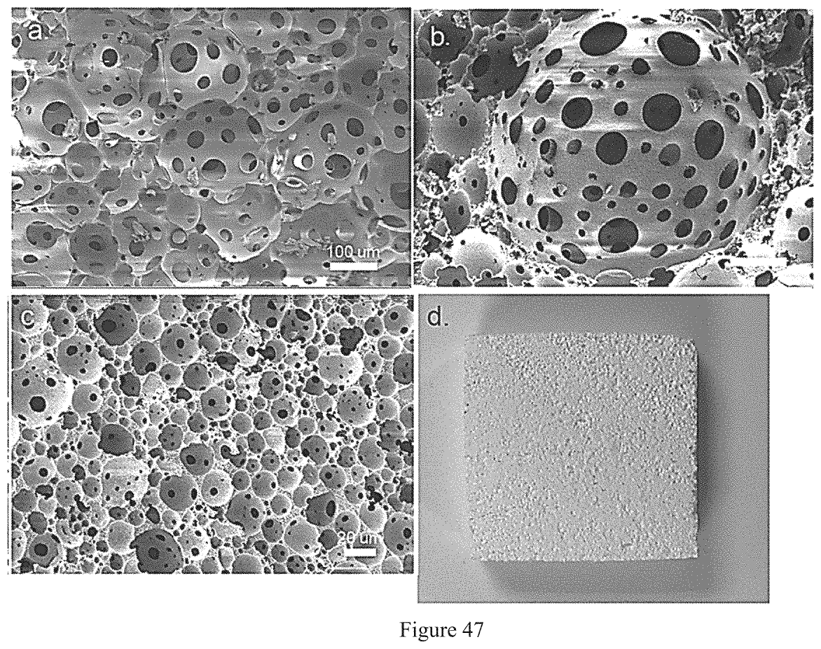

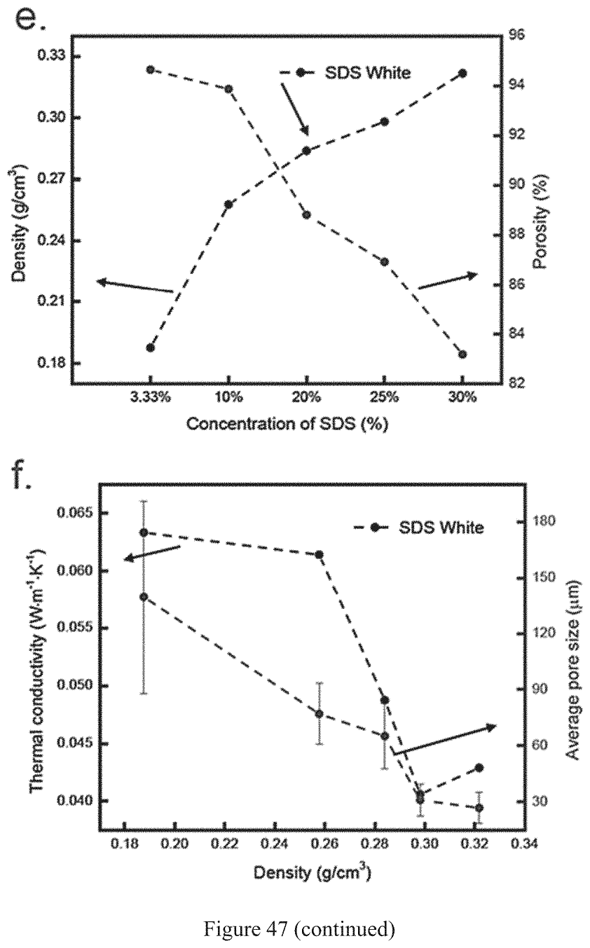

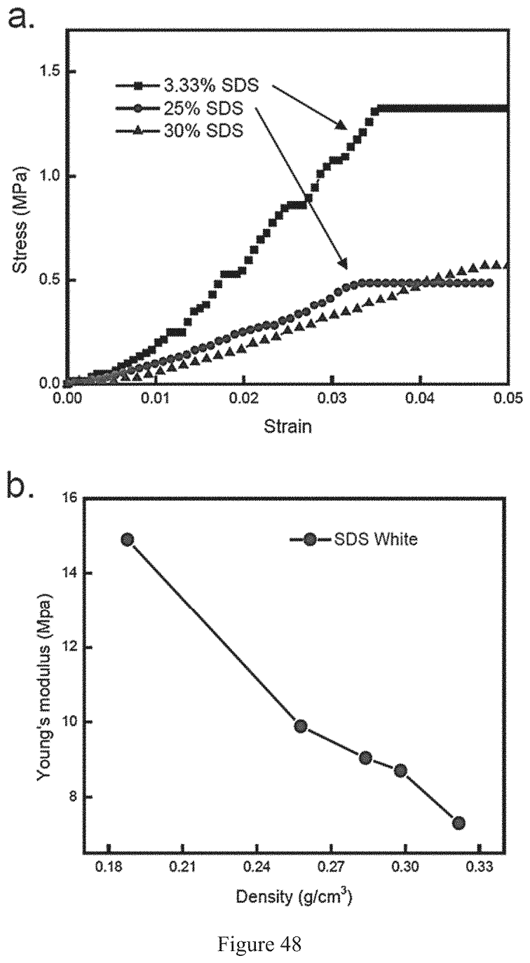

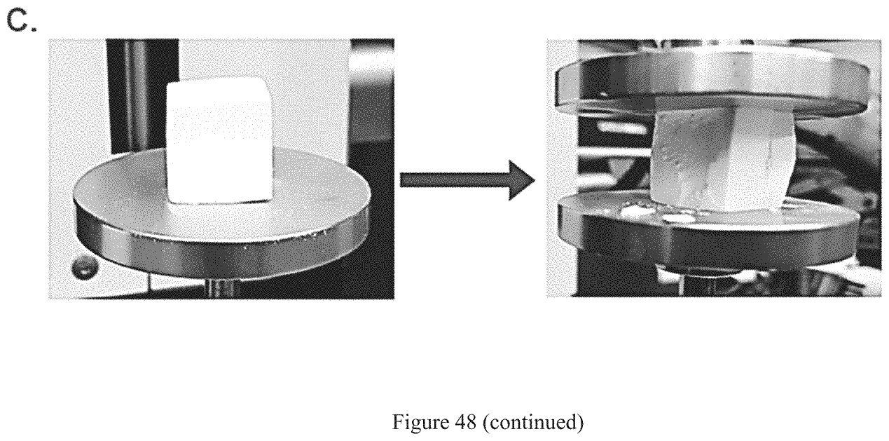

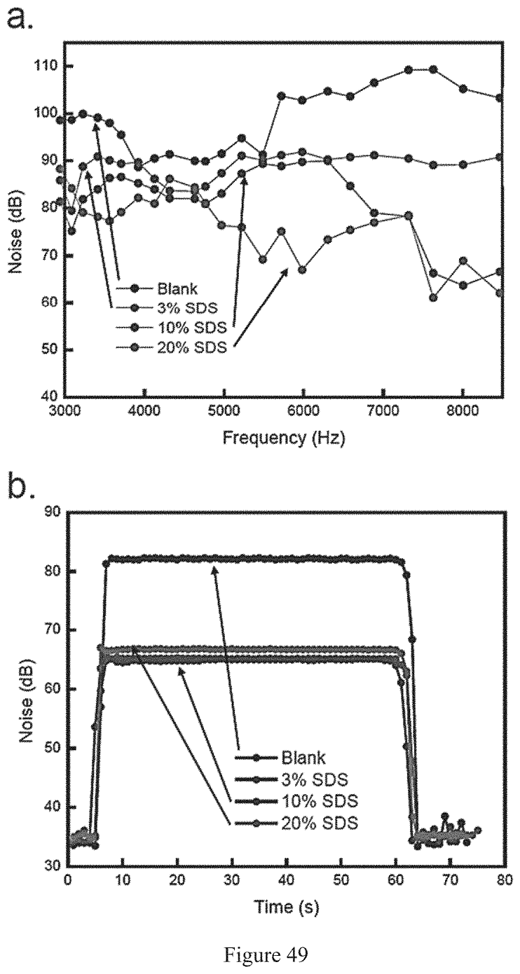

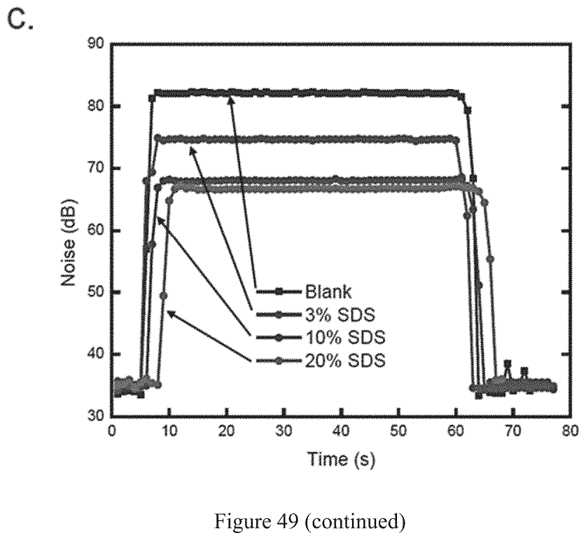

Experimental method: Add in 3 mol L⁻¹ g Urea (Sigma-Aldrich), 0.3 mol L⁻¹ CTAB, Cetyltrimethylammonium bromide (VWR)/SDS, Sodium dodecyl sulfate (Sigma-Aldrich), 1 mmol Acetic Acid (EMD Millipore Corporation) dissolved with distilled water to 100 ml in beaker Stirring for 3 hours till the solution became all transparent. Then 1.4 mol L⁻¹ TEOS (Sigma-Aldrich) was add into the solution. Continue stirring for 10 minutes, the solution turns to homogeneous semi-transparent. Then transfer the solution to aluminum vessel, and tightly seal the container. Then place the container into the oven which preheated to 60° C. for 4 days. After this gelation process, sample (monolith and gel) was taken out from the container to a container filled with distilled water preheated to 60° C. for two days. During this washing process, water has been changed several times until the supernatant water is clear and all ammonia is removed. Then sample (gel) was stored in a sealed container for further application. See FIGS. 45-49.

### Example 8

This example provides a description of making ceramic foams materials of the present disclosure and characterization of same.

Described herein are flexible high-temperature superhydrophobic ceramic insulation nanocomposites, in which the architectured nanostructures, radiative insulation coating, and interfacial cross-linking between ceramic fiber and aerogel are critical for its high-temperature insulation. The lightweight flexible aerogel nanocomposites exhibit a density of 0.1 g/cm³, high temperature-resistance above 500° C., and fire resistance with thermal conductivity of 0.023 W m⁻¹ K⁻¹, and super-hydrophobicity with the water contact angle of 152°. The mechanical elasticity and high-temperature thermal insulation, together with its soundproof performance, shed light on the low-cost flexible aerogel manufacturing with scalability for high-temperature thermal insulation applications.

Described are all-ceramic high-temperature thermal insulation nanocomposites through compression molding (HT-Aero) by tuning the microstructure density and in-situ crosslinking between aerogel and fibers, to build flexible aerogel and nanofiber networks. Compression molding, which is ever applied to build bulk materials, is used here to reinforce the interfacial bonding between aerogel and fibers at an elevated temperature and to control the pressure-dependent density and cross-linking reaction of HT-Aero nanocomposites. In addition, high-temperature thermal radiation could be further reduced by superhydrophobic carbon porous coating. Benefiting from its hierarchical structure framework, the as-prepared superhydrophobic nanocomposites show a flyweight density of 0.1 g/cm³, temperature-resistance above 500° C., and fire resistance with low thermal conductivity 0.023 W m⁻¹ K⁻¹, indicating that they can be perceived as promising candidates for the next-generation high-temperature thermal insulation materials in extreme environments.

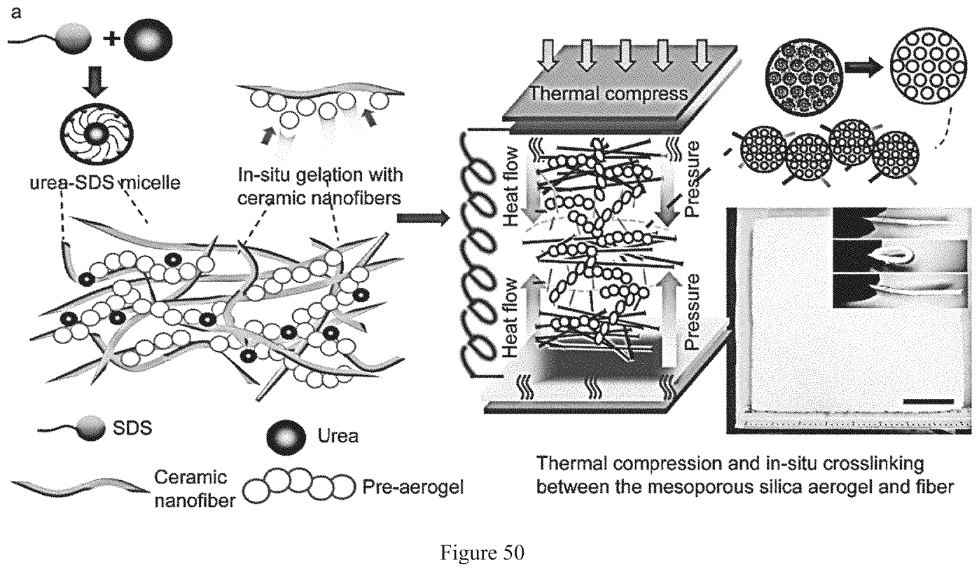

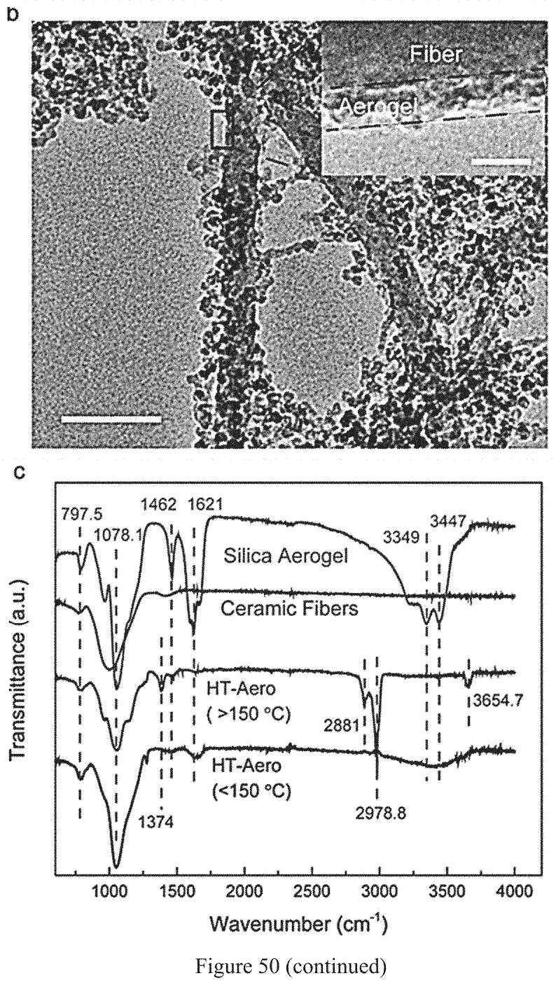

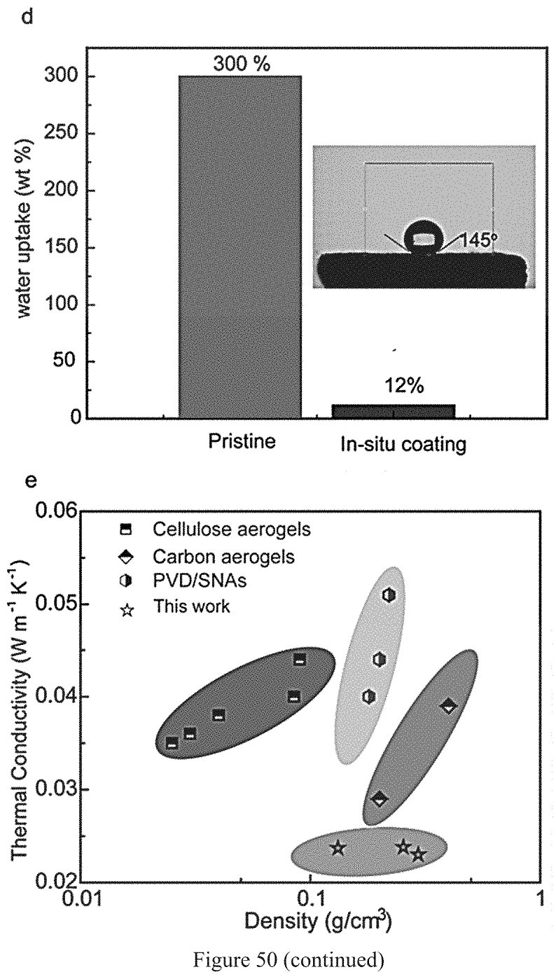

Results and Discussion. FIG. 50a shows the manufacturing scheme of a flexible ceramic aerogel-fiber nanocomposite sheet with controllable density and cross-linking networks through thermal compression. The inset shows a large-sized flexible thermal-compressed composite sheet with a lateral dimension larger than 20 cm. The silica pre-aerogel precursor is a mixture of the sodium dodecyl sulfate (SDS) surfactant micelles, in-situ foaming agent urea, sodium silicate (water glass), and hydrogen chloride solution. The urea could accelerate the polymerization of silicon alkoxides, while its decomposition of carbon dioxide and ammonia gas bubbles works as an in-situ foaming agent to support pore formation during ambient pressure drying. During thermal compression, the hydrolysis and condensation for silica aerogel are further performed, while the applied load compresses the nanocomposites with controllable density and thermal treatment reinforces the interfacial bonding between silica aerogel and ceramic fibers. The porous silica aerogel networks and ceramic fibers could be observed in transmission electron microscopy (FIG. 50b), while the inset figure shows the interface between the aerogel and fiber networks. To confirm the cross-linking induced interfacial bonding, the Fourier-transform infrared spectroscopy (FTIR) is performed on silica aerogel, ceramic fiber, and the aerogel-fiber nanocomposites (FIG. 50c). The FTIR spectra of these materials share the same absorption region from 1,100 cm-1 to 1,000 cm⁻¹, which is the prominent peak corresponding to the asymmetric and symmetric modes of silicon dioxide, and 797.5 cm⁻¹ is associated with symmetric Si—O—Si stretching or vibrational modes of ring structures. The peak around 1,621 cm⁻¹ and the broad absorption band around 3,447 cm⁻¹ in the spectra of silica aerogel are resulted from the Si—OH groups, while these peaks become faint for the thermally compressed composites when the temperature increases above 150° C. Since the high temperature enhance the in-situ cross-linking reaction, the new peaks around 1,374 cm⁻¹, 2,881 cm⁻¹, 2,978 cm⁻¹, and 3,654 cm⁻¹ in FTIR spectra of composites after thermal compression are observed, corresponding to ═C—H in-plane bending modes, C—H symmetrical stretching vibration mode, C—H asymmetrical stretching vibration mode and —OH stretching region, respectively. After in-situ trichlorosilane coating, the composite sheet can further improve its hydrophobicity with a water contact angle of 1420 in which the water uptake could decrease to 12 wt % from 300 wt % (FIG. 50d). This treatment provides the moisture resistance of the ceramic paper sheet under a humidified environment. Compared with other reported thermal insulation materials (e.g., cellulose aerogels, carbon aerogels, and PVD/silica aerogels), the thermally compressed HT-Aero composite materials demonstrate low density with low thermal conductivity (FIG. 50e).

The thermal conductivity k of thermal insulation materials could be expressed as

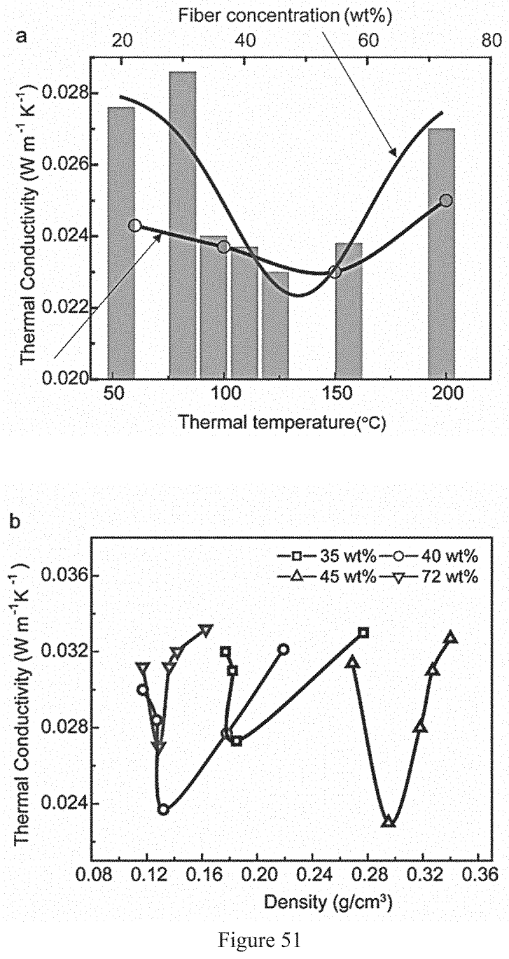

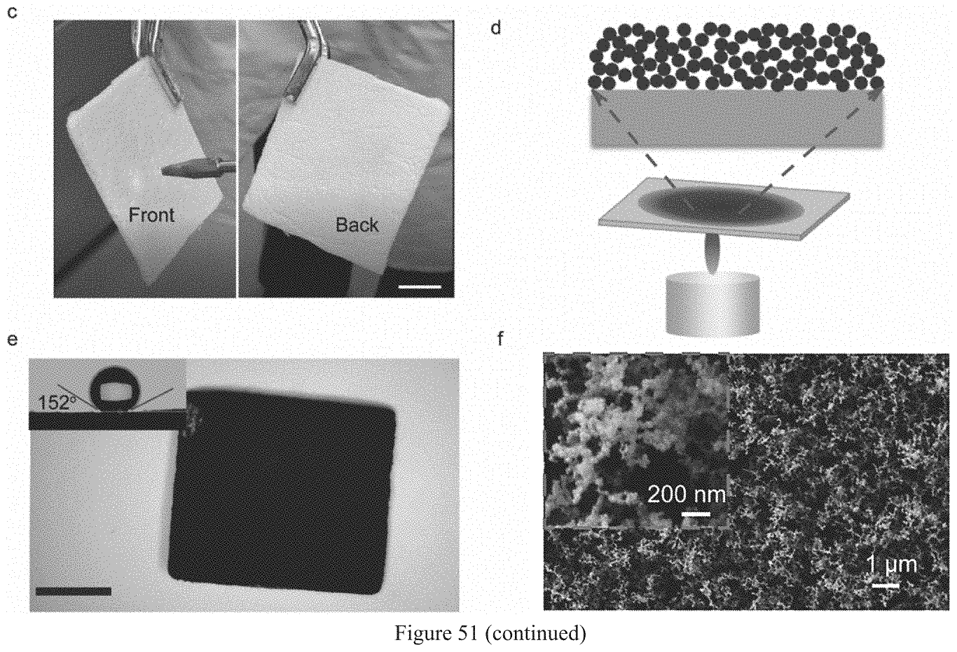

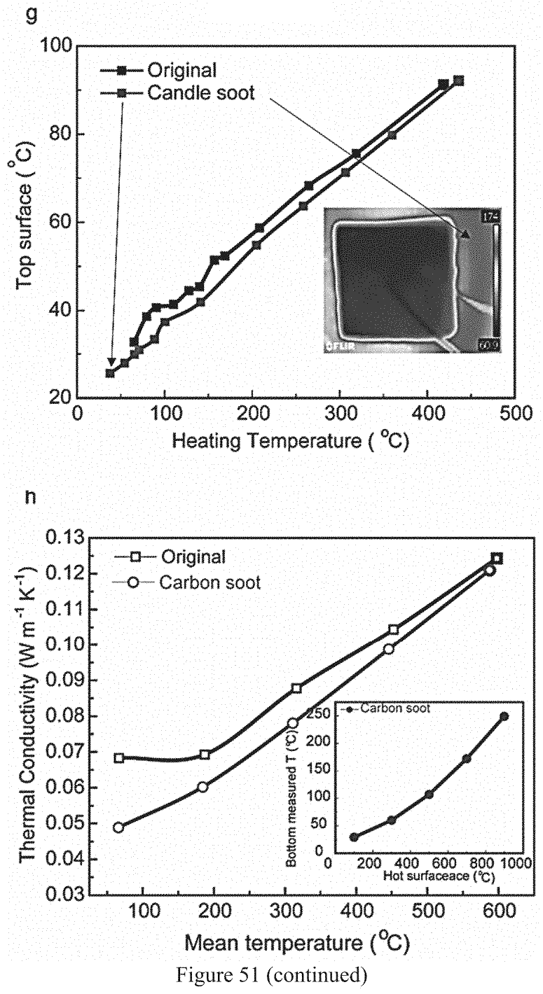

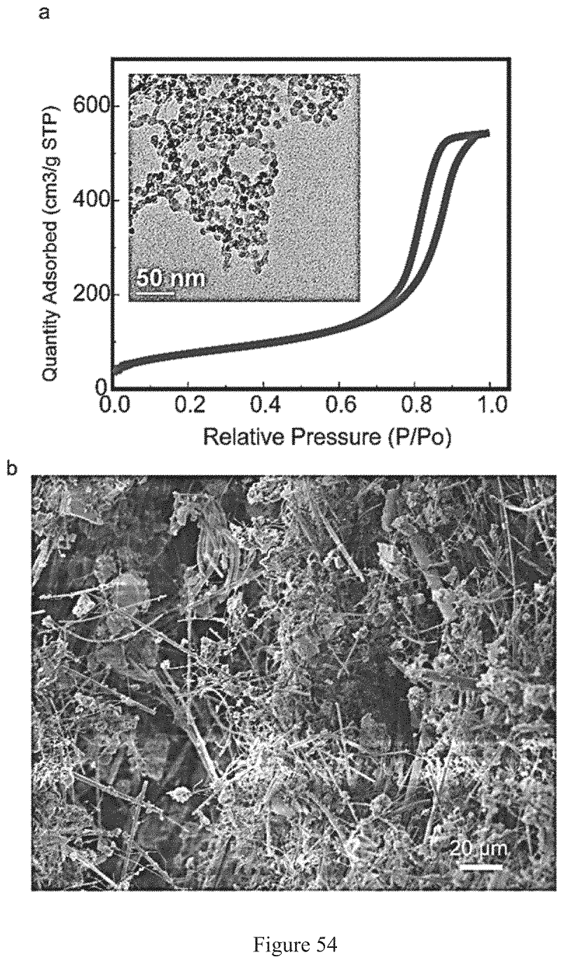

k=kᵣ+k_{c}+kₛ+k_{g},

where kᵣ is the radiative thermal conductivity, k_{c} is the convective thermal conductivity, kₛ is the conductive thermal conductivity of solid phase, and k_{g} is the conductive thermal conductivity of gas phase. The radiative thermal conductivity (kᵣ) contributes little at ambient temperature while it cannot be ignored at high temperatures. The convective thermal conductivity (k_{c}) becomes negligible when the pore size in the thermal insulation materials is <1 mm at ambient pressure. Thus, it is very critical to tune the porous microstructure and density in aerogel-fiber composites for the control of convective and conductive heat conduction in the cross-linked networks. To this end, thermal compression is applied to aerogel-fiber composite, and as shown in FIG. 51a, the thermal conductivity of 0.023 W m⁻¹ K⁻¹ occurs under an optimal compression temperature (150° C.) and fiber concentration (45 wt %). During thermal compression, a low processing temperature (e.g. 60° C.) does not reinforce the interfacial bonding between aerogel and fibers as shown in the FTIR spectra. On the other hand, a processing temperature higher than 150° C. causes network deterioration due to the increased and concentrated thermal stress during drying. At an optimum temperature of 150° C., the HT-Aero composite sheets' low thermal conductivity is attributed to the formation of mesoporous silica aerogels with the average pore size of 11 nm confirmed by Brunauer, Emmett, and Teller (BET) technique (FIG. 54), which is much smaller than the mean free path of gas molecules (˜68 nm). The k_{g} contribution can be decreased since the collisions of gas molecules within the pores are suppressed. On the other hand, the thermal conduction through the fiber networks is limited by interfacial bonded silica aerogels on fibers, resulting in a decrease of kₛ as well. However, the thermal conductivity exhibits an increasing tendency when the content of the granular silica aerogel further increases (i.e., fiber concentration decreases), which could be related to the increase in the composite density.

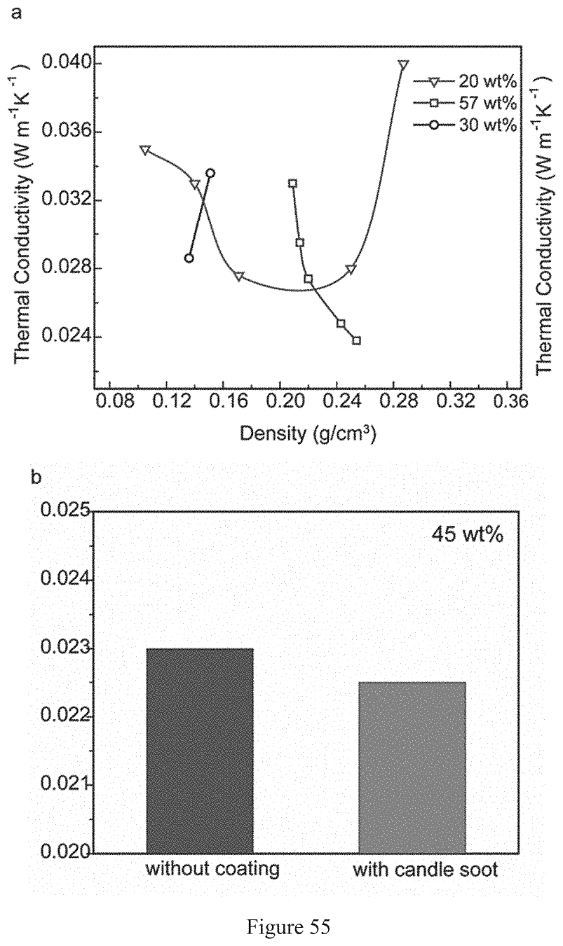

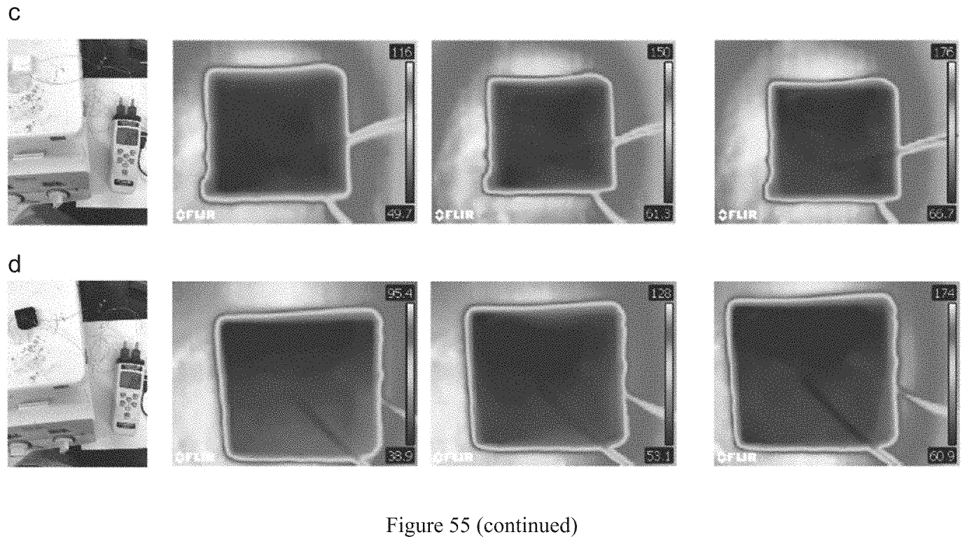

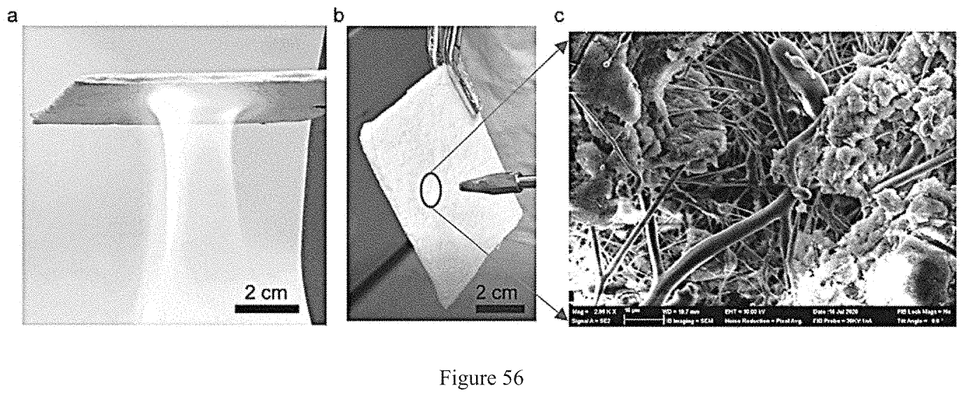

FIG. 51b shows the thermal conductivity vs. density of composite paper sheets with fiber concentrations of 35, 40, 45, and 72 wt % after 150° C. thermal compression treatment and the others are seen in FIG. 55a. By increasing the applied compression force, the density increases, while the thermal conductivity decreases to an optimum value and then increases. For HT-Aero composites with the fiber concentration of 45 wt %, as the density increases from 0.27 g/cm⁻³ to 0.295 g/cm⁻³, the thermal conductivity decreases to 0.023 W m⁻¹ K⁻¹. This could be attributed to the thermal transport pathway composed of nanoporous silica aerogel and ceramic fibers architectures. However, when the density increases further (>0.295 g/cm³), the thermal insulation performance would be reduced, since the porous networks are damaged by compression and the solid contacts would dominate the thermal transport pathway. The fire-retardant performance of the ceramic composite paper sheet is revealed as the front surface is exposed to hydrogen fire flame and the back surface remains intact (FIG. 51c and FIG. 56), which indicates the potential high-temperature thermal insulation applications.

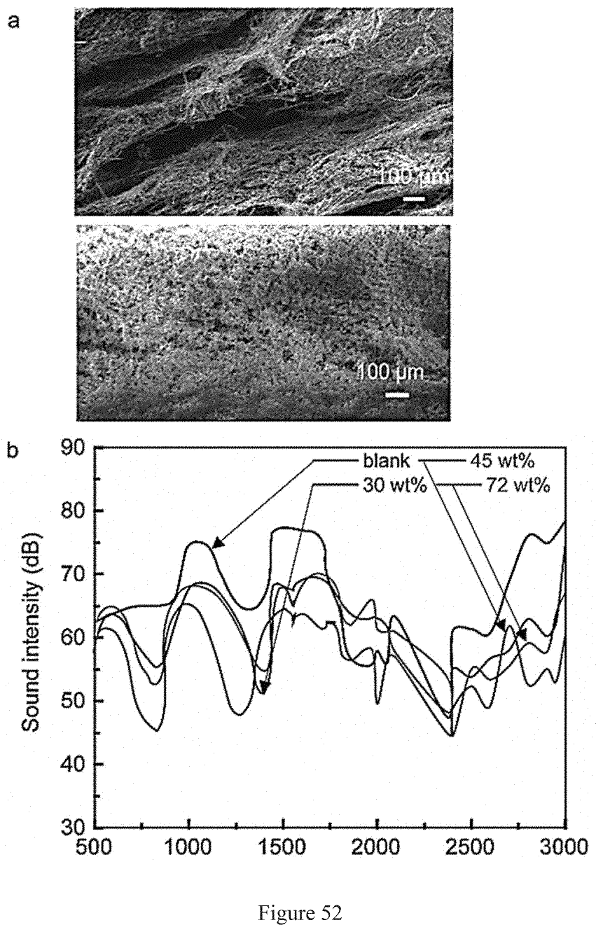

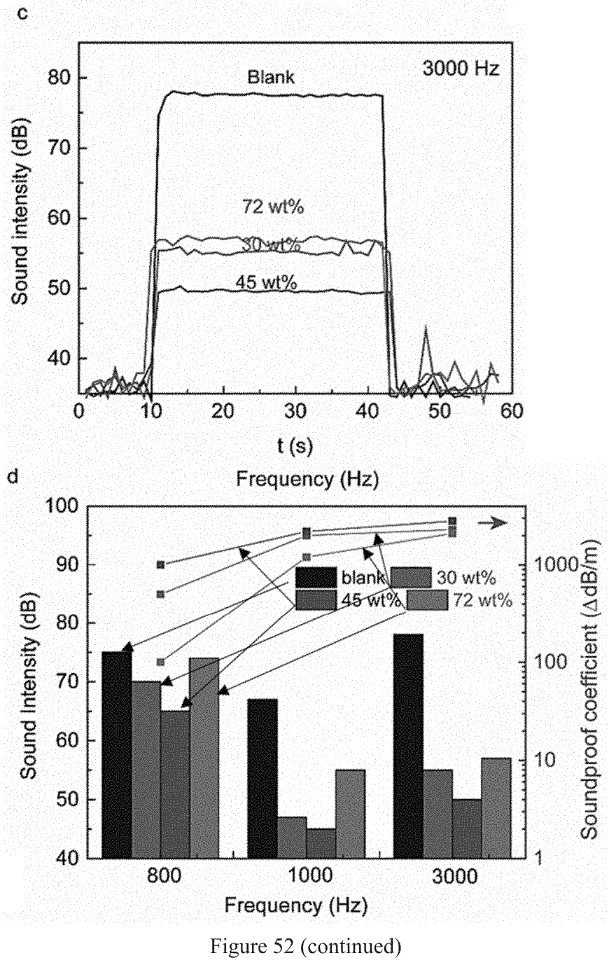

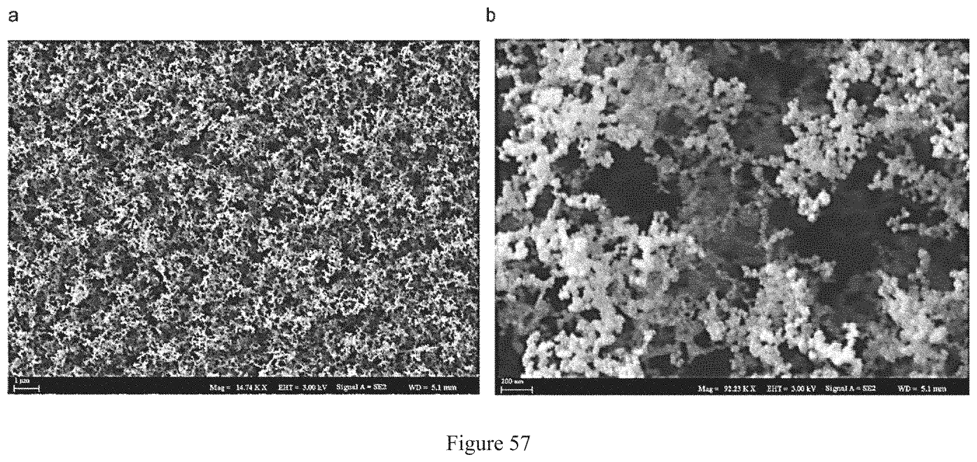

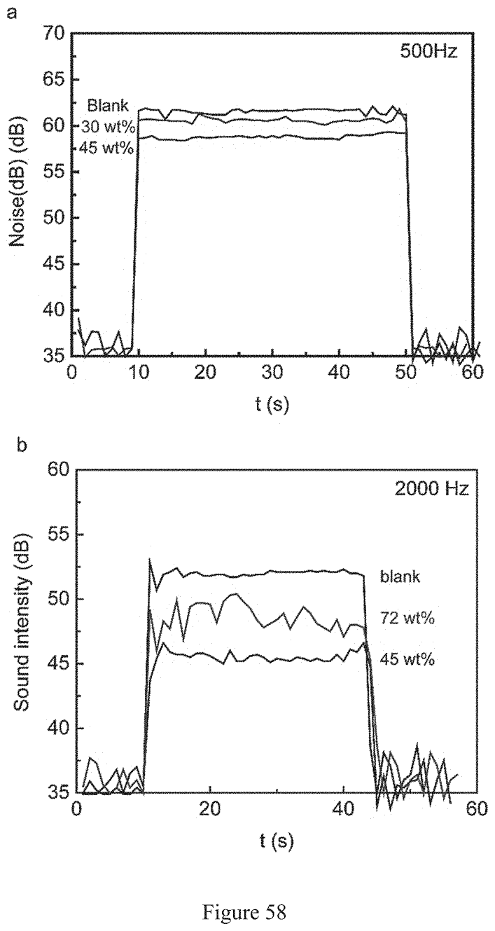

For high-temperature thermal insulation performance, radiative thermal insulation could be enhanced by the porous carbon networks through the candle soot coating. The candle soot technique has been successfully applied to insulation window materials to resist solar radiation. The scheme of the candle soot coating process is shown in FIG. 51d, where the HT-Aero composite sheets are treated above the candle flame, and the incomplete combustion of carbon nanoparticles could be deposited onto the composite paper sheet surfaces. FIG. 51e demonstrates the uniform carbon coating on thermal compressed composite surface by candle soot, which shows the superhydrophobic performance with the water contact angle of 152°, which is consistent with what is known in the art. The candle soot-coated porous carbon network with pore sizes of roughly several hundred nanometers in FIG. 51f and FIG. 57 has the potential to reduced thermal radiation under a high-temperature environment. FIG. 52g compares the top surface temperature T vs. heating temperature curves of composite sheets with and without carbon soot. With the hot surface temperature increasing from 25° C. to −430° C., both top surface temperatures increase linearly with ˜80% temperature resistance while the coated HT-Aero sample has a lower temperature curve, which is ˜7% lower than that of samples without carbon coating. The inset figure shows the IR image of samples heated under 174° C., where the top surface temperature is 60.7° C., qualitatively indicating high-temperature resistance of carbon-coated HT-Aero ceramic composite paper sheets. The related temperature evolutions of HT-Aero ceramic composite with and without candle soot coating by IR camera could be found in FIG. 55. The thermal insulation performance of HT-Aero composites at high temperatures (100-900° C.) is also explored. FIG. 51h compares the thermal conductivity vs. mean temperature of thermal compressed composite with and without carbon coating (the thickness of 12.7 mm), which indicates the linear temperature dependence compared with a parabolic relationship for pure ceramic aerogels. This is caused by the enhanced interfacial bonding between aerogels and fibers in thermal compressed HT-Aero composites. Through depositing the thermal radiative resistant carbon networks, the thermal conductivity under 300° C. decreases to 0.075 W m⁻¹ K⁻¹ from 0.09 W m⁻¹ K⁻¹ for samples without carbon coating, which indicates the porous carbon networks improve thermal insulation under high temperature. The inset shows the corresponding candle soot coated HT-Aero's hot surface temperature vs. bottom measured temperature curve, which demonstrates the excellent thermal resistance of HT-Aero samples (thickness of 12.7 mm) heated by a hot surface from 100° C. to −900° C. during high-temperature thermal conductivity measurement.

Acoustic insulation is another important feature of flexible ceramic nanocomposite sheets, in which its soundproofing results from effectively reflecting and absorbing sound waves. The aerogel and nanofiber architectures could effectively reflect sound waves and increase the airflow resistivity to reduce the transmission of sound waves. The cross-section SEM image (top) of aerogel-fiber composite in FIG. 52a displays the fiber layer stack structure with a large gap caused by the vacuum filtration during the paper sheet manufacturing, where the thermal convection and conduction from gaseous components would be significant. After thermal compression, the ceramic fiber-aerogel layers could be compressed densely as shown in the SEM image (bottom) of FIG. 52a. This induced dense microstructure could enhance soundproof resistance performance. FIG. 52b shows the soundproof performance of HT-Aero composite sheets with different fiber concentrations (30, 45, and 72 wt %) and the blank as the baseline. Compared with the blank reference, the HT-Aero sheets show an excellent soundproof performance under the sound frequency from 500 to 3,000 Hz. The 45 wt % composite sheets show an optimum and a low detected sound intensity across the full frequency range. This could result from the synergistic effect between the cross-linked aerogel and nanofibers, which is consistent with its excellent thermal insulation performance. The sound intensity vs. time curves for different samples at a frequency of 3,000 Hz are compared in FIG. 52c, indicating the optimum soundproof performance for the sample with 45 wt % fibers, which is consistent with its thermal conductivity performance. The soundproof performances under 800, 1,000, and 3,000 Hz are shown in FIG. 52d. Particularly, the noise reduction of 45 wt % nanofiber sheets shows a decrease of 15.3%, 30.0%, and 37.4% at frequencies of 800, 1,000, and 3,000 Hz, respectively, in comparison to that of the blank reference. The soundproof coefficients of the sample with 45 wt % fibers show 10, 1.8, and 1.3 times that for the sample with 72 wt % fibers at 800, 1,000, and 3,000 Hz, respectively.

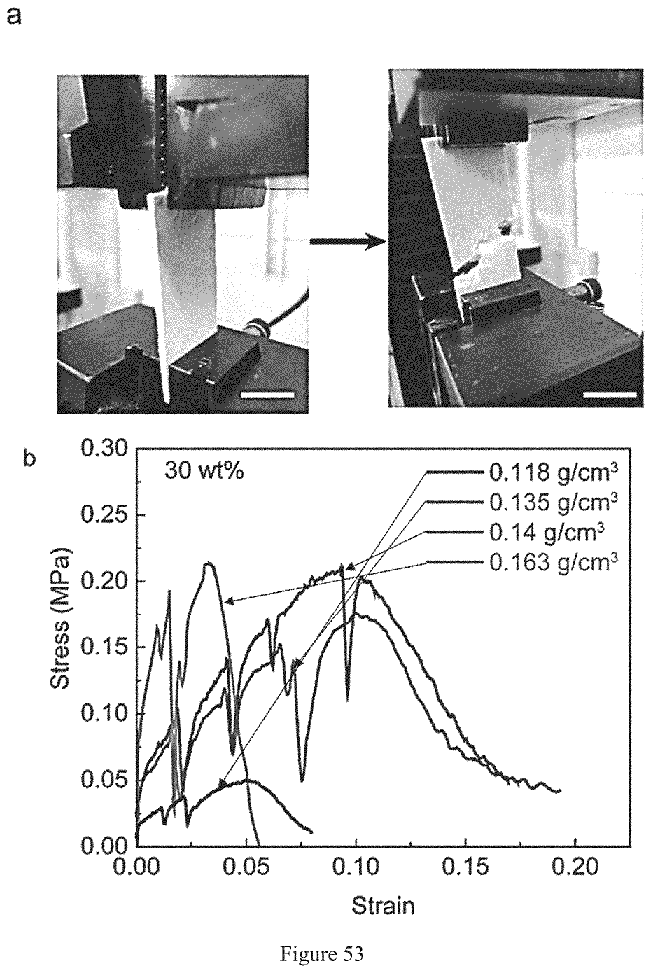

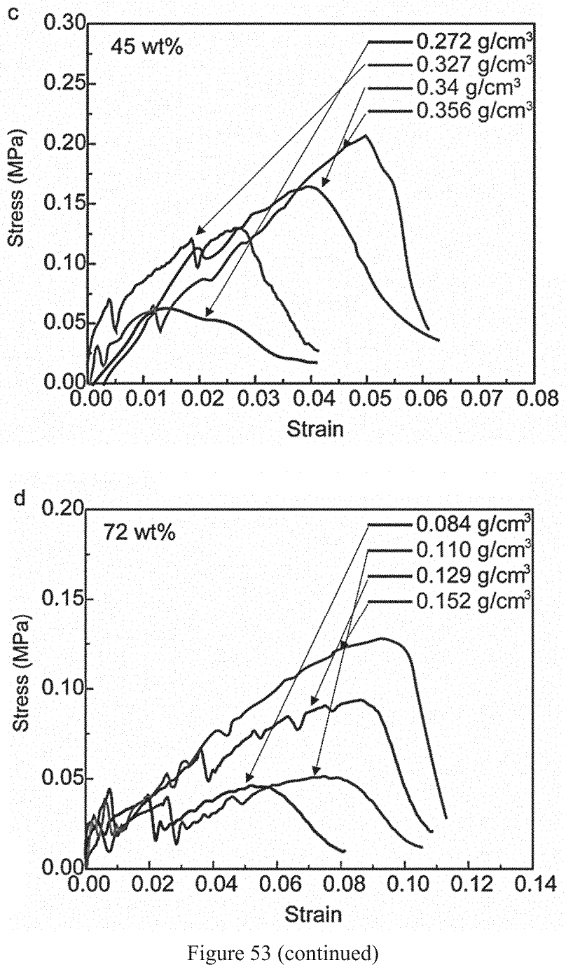

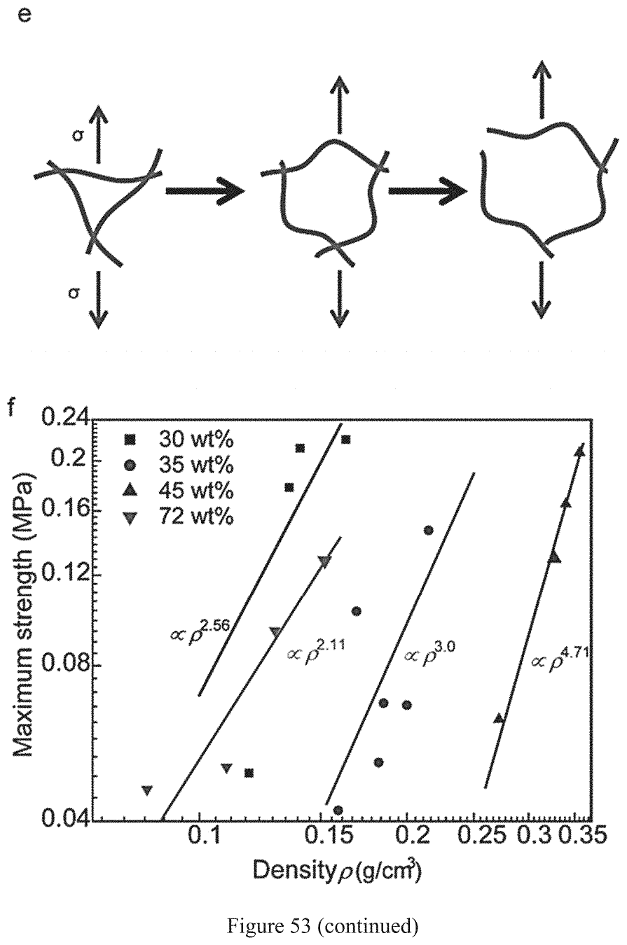

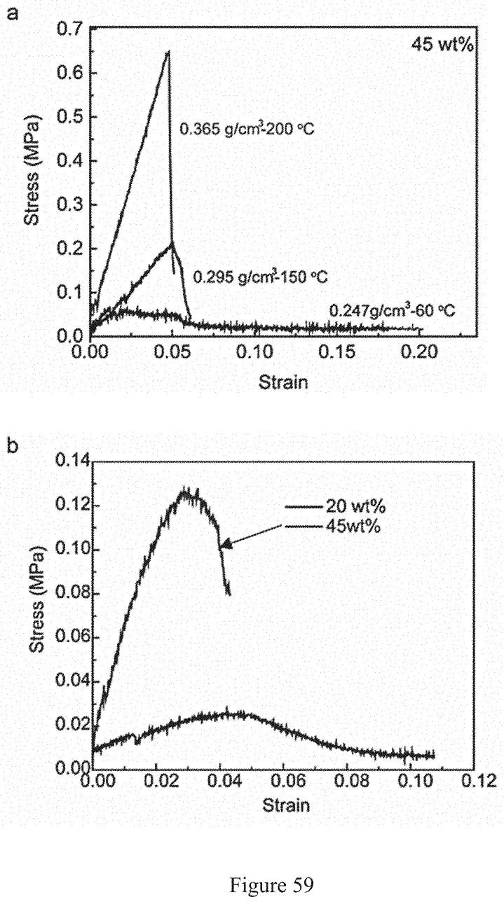

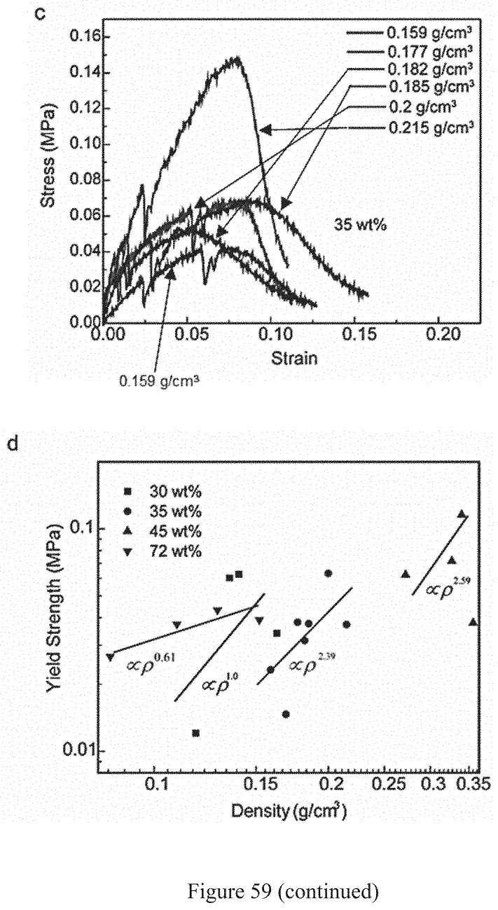

The thermally compressed HT-Aero composite sheets with different densities and fiber concentrations have different mechanical responses, which is very important for the flexible thermal insulation applications under external forces. To explore the mechanical performance of flexible HT-Aero ceramic composite paper sheets, uniaxial tensile testing is performed (FIG. 53a). The stress-strain curves for samples with 30 wt %, 45 wt %, and 72 wt % fibers are plotted in FIGS. 53b-d. Typically, as the strain increases, the stress first increases linearly, and then yield occurs immediately after the stress drops, and the sample fracture cracks start to initiate when the stress reached its maximum value. For the samples with different densities in FIG. 53b-d, the stress curve is higher under the same strain with increasing the density. For thermally compressed HT-Aero composites with 30 wt % fibers in FIG. 53b, with density increasing from 0.118 g/cm³ to 0.163 g/cm³, the maximum strength increases from 0.048 MPa to 0.22 MPa, while for HT-Aero samples with 72 wt % fibers within the similar density range (FIG. 53d), the maximum strength increases from 0.047 MPa to 0.13 MPa. This lower maximum strength is due to a lower amount of interfacial bonding between aerogel and fibers. Since the HT-Aero samples with 45 wt % fibers have relatively high densities from 0.272 g/cm³ to 0.356 g/cm³ (FIG. 53c), its maximum tensile strengths are larger, indicating its robustness performance. On the other hand, as the fiber concentration increases from 30, 45, to 72 wt % (FIG. 53b-d and FIG. 59), the maximum yield strength (i.e., 1 stress drop) from each sample decreases from 0.17 MPa, 0.075 MPa, to 0.048 MPa, which indicates the higher fractions of interfacial bonding between aerogel and fibers would contribute largely to the superior yield strength. Due to the fiber-aerogel network architecture, the tensile failure mechanism is proposed in FIG. 53e, where the sliding happens between fiber-fiber connections under tensile stress and stick-sliding mechanism for fiber-aerogel connections. The linearly increased stress at the beginning is due to the small applied force being insufficient to pull the fiber to slide beyond the contacts, and the reversible fiber networks' bend behavior dominates this stage. When the stress reaches the yield strength value, the sliding between fibers would occur. The load drops found in the stress-strain curves result from the sticking-sliding mechanism from fiber-aerogel bonded connections. The bonded fiber-aerogel connection would be the stress concentration location where the stress would be released after the sliding happens. In addition, the fracture behavior of HT-Aero in tension was different from that in compression. The tensile stress can cause a tear-like fracture, whereas compressive stress can lead to progressive crushing. After reaching the maximum stress, the fracture cracks would initiate in HT-Aero and propagate across the whole sample, during which the stress gradually decreases. FIG. 53f shows the maximum strength versus the density (φ for samples with 30, 35, 45, 72 wt % fibers, revealing a scale relationship as σ˜ρⁿ with n of 2.56-4.71. The larger n value indicates a stronger density-dependent fracture strength dominated by interfacial bonded fiber-aerogel architecture.

In summary, described are all-ceramic flexible high-temperature thermal insulation nanocomposites by tuning the microstructure density and in-situ crosslinking between aerogel and fibers through thermal compression, to build flexible aerogel and nanofiber bonding networks. Through the application of high temperature and applied load, the cross-linked interfacial interaction between nanofiber and silica aerogel could be reinforced and the microstructure porosity and density can be controlled. This approach allows the in-situ construction of the elastic bonding structure in the process. In addition, low thermal radiation could induce high-temperature thermal insulation performance by nanoporous carbon coating on the nanocomposite. Meanwhile, benefiting from the hierarchical structure framework of ceramic aerogel composite, the as-prepared superhydrophobic nanocomposites show a flyweight density of 0.1 g/cm³, temperature-resistance above 500° C., and fire resistance with low thermal conductivity of 0.023 W m⁻¹ K⁻¹, indicating that they can be perceived as promising candidates for the next-generation high-temperature thermal insulation materials in extreme environments.

Methods. Thermal Compressed Paper Sheet through Silica Aerogel Precursor. 0.3 mol Urea (Sigma-Aldrich) and 2.0 g sodium dodecyl sulfate, SDS (VWR), were dissolved in a beaker with 100 mL distilled water and then stirred for 3 h (hour) to all transparent solution. Then, 11 mL reagent grade sodium silicate solution (Sigma-Aldrich) was added, followed by the addition of 2 mol L⁻¹ HCl into the solution until it became semitransparency. Commercial ceramic fibers are added to the solution and kept in an oven under 60° C. for 2 h for further gelation. Then 1000 mL DI water was added and stirred for 3 mins (minutes) to disperse the fibers homogeneously. The wet composites were then prepared via vacuum filtration of the mixture solution containing ceramic fibers and silica pre-aerogel. Afterward, the top and bottom of the wet paper sheets were covered by aluminum foils and put on a hot press instrument. The composites were compressed under a certain high temperature for 1 h. The applied temperatures studied in this work are 60, 100, 150, and 200° C., respectively. All thermal compressed composite samples were kept in the oven for complete drying under 60° C. The different fiber concentrations were tuned by changing the ratios between fiber weight and the amount of silica precursor.

Structural characterization. The microstructures of the samples studied herein were characterized by Carl Zeiss AURIGA scanning electron microscopy (SEM) and JEOL 2010 high-resolution transmission electron microscope (HRTEM). Fourier Transform Infrared (FTIR) Spectra were acquired in attenuated total reflection mode (ATR-FTIR spectroscopy) with a Bruker VERTEX 70 on ZnSe substrate, and atmospheric compensation is implemented during the measurement. BET analysis was performed on a Tristar II 3020 (Micromeritics Corp. Atlanta, Ga.). The specific surface area (SSA) and the pore size distributions were evaluated with the low-temperature nitrogen adsorption-desorption isotherm measurement method. The pure aerogels were degassed at 300° C. for one hour before analysis. The surface areas were calculated with the Brunauer-Emmett-Teller (BET) theory using isotherm adsorption data at P/Po from 0.05 to 0.30. The water contact angle was measured by the Ossila Contact Angle Goniometer. The infrared (IR) images of composites with a thickness of 6 mm (˜4 layers of composite sheets) on a hotplate were taken by Fotric 225 Pro Thermal Camera.

Thermal property characterization. The Thermtest HFM-100 following ASTM C518 standard was used to measure the composite sheets' thermal conductivity. The calibration was performed on the standard sample (NIST SRM 1450d) before each measurement, whose thermal conductivity is 0.0325 W m⁻¹ K⁻¹. The composite thickness was automatically determined by HFM-100. The measurement began by fixing the upper and lower plates at 30° C. and 40° C., respectively, and the thermal conductivity was determined when the heat flux became a constant value. The extruded polystyrene boards with different thicknesses from 1 mm to 25 mm were used here for thermal conductivity measurement calibration. Also, the thermal conductivity measurements of small samples followed the ASTM C518 standard procedure. The reference commercial polystyrene thermal insulation material was used to calibrate the flux sensor from Fluxteq Company. After recording the temperature from the top and bottom plates, with steady heat flux through the samples, the thermal conductivity value was calculated. The high-temperature thermal conductivity measurement followed the ASTM C892 standard procedure.

Mechanical characterization. The mechanical properties of composites were studied using an MTS universal testing machine.

Although the present disclosure has been described with respect to one or more particular embodiments and/or examples, it will be understood that other embodiments and/or examples of the present disclosure may be made without departing from the scope of the present disclosure.

1. A method for forming a ceramic foam-fiber composite comprising:
contacting:
one or more fiber(s);
one or more ceramic precursor(s);
one or more pore-forming gas-forming additive(s);
one or more catalyst(s); and
optionally, one or more additive(s),
wherein the contacting results in formation of an inert gas and the ceramic foam-fiber composite comprising a ceramic foam and the one or more fiber(s).

2-43. (canceled)

44. The method of claim 1, wherein
the contacting is carried out at an initial pressure of 1-100 psi; and/or
the contacting is carried out at a temperature of room temperature to 70° C. and/or for 1 minute to 96 hours.

45. The method of claim 1, wherein
the ceramic precursor(s), the pore-forming gas-forming additive(s), and, optionally, the one or more additive(s) are contacted and then the catalyst is contacted with the one or more ceramic precursor(s), the one or more pore-forming gas-forming additive(s), and, optionally, the one or more additive(s); and/or
the contacting comprises mixing: one or more fiber(s); one or more ceramic precursor(s), one or more pore-forming gas-forming additive(s), and a catalyst.

46. The method of claim 1, wherein the ceramic precursor(s) is/are selected from silica precursors, alumina precursors, transition-metal oxide precursors, and combinations thereof;
wherein the silica precursor(s) is/are chosen from tetraalkoxysilanes, alkyltrialkoxysilanes, sodium metasilicates, and combinations thereof;
wherein the alumina precursor(s) is/are chosen from aluminum alkoxides, alumatrane, tris(alumatranyloxy-i-propyl)amine, and combinations thereof; and
wherein the transition-metal oxide precursor(s) is/are chosen from transition metal alkoxides.

47. The method of claim 1, wherein
the catalyst is a base catalyst or an acid catalyst; and/or
the pore-forming gas-forming additive is chosen from sodium bicarbonate, urea, and combinations thereof; and/or
the one or more additive(s) is/are selected from surfactants; and/or
the fiber(s) is/are solid fiber(s) or hollow fiber(s).

48. The method of claim 1, wherein
the ceramic precursor(s) is/are each present at 2 to 10% by weight (based on the total weight of the one or more ceramic precursor(s), the one or more catalyst(s), the one or more inert gas-generating agent(s), and, if present, the one or more additive(s)); and/or
the inert gas-generating agent(s) is/are present at 0.4 to 2% by weight (based on the total weight of the one or more ceramic precursor(s), the one or more catalyst(s), the one or more inert gas-generating agent(s), and, if present, the one or more additive(s)).

49. The method of claim 1, wherein
the catalyst is present at 1 to 2% by weight (based on the total weight of the one or more ceramic precursor(s), the one or more catalyst(s), the one or more inert gas-generating agent(s), and, if present, the one or more additive(s)); and/or
one or more additive(s) is/are present at 200 to 1000% by weight (based on the total weight of the one or more ceramic precursor(s), the one or more catalyst(s), and the one or more inert gas-generating agent(s)); and/or
the ratio of 5:1:10 (ceramic precursor(s):pore-forming gas-forming additive(s):catalyst(s)).

50. The method of claim 1, further comprising:
exchanging the ceramic foam-fiber composite; and/or
washing the ceramic foam-fiber composite, wherein the washing comprises contacting the ceramic foam-fiber composite with an aqueous solution;
and/or washing the ceramic foam-fiber composite with an alcohol and/or drying the ceramic foam-fiber composite.

51. The method of claim 1, further comprising forming a layer of hydrophobic carbon-containing material disposed on at least a portion or all of a surface of the ceramic foam.

52. The method of claim 1, further comprising decorating or coating at least a portion or all of a surface of the ceramic foam, wherein the ceramic foam is decorated or coated with a material.

53. The method of claim 1, wherein the ceramic foam-fiber composite further comprises a plurality of nanoparticles formed by impregnating the ceramic foam with a nanoparticle precursor and reacting the nanoparticle precursor to form a nanocomposite material.

54. A ceramic foam-fiber composite comprising a plurality of fibers and a ceramic foam.

55. The ceramic foam-fiber composite of claim 54, wherein
the ceramic foam of the composite is a silica aerogel; and/or
the ceramic foam is disposed on a least a portion of a surface of at least a portion (or all) of the fibers of the composite; and/or
the ceramic foam is a plurality of particles.

56. The ceramic foam-fiber composite of claim 54, wherein
the ceramic foam of the composite has a hierarchical pore gradient; and/or
the ceramic foam comprises a ceramic matrix.

57. The ceramic foam-fiber composite of claim 54, wherein
the ceramic foam comprises pores having a size of 500 microns to 1 micron.

58. The ceramic foam-fiber composite of claim 54, wherein
the ceramic foam is a silica aerogel and is transparent; and/or
the ceramic foam comprises a layer of carbon-containing material disposed on at least a portion or all of a surface of the ceramic foam.

59. The ceramic foam-fiber composite of claim 54, wherein
each individual fiber of the plurality of fibers is a solid fiber or a hollow fiber; and/or
at least a portion of or all of the plurality of fibers is a textile; and/or
each individual fiber of the plurality of fibers is a ceramic fiber or a polymer.

60. The ceramic foam-fiber composite of claim 54, wherein the amount of fibers is 10-90% by weight (based on the total weight of the ceramic foam-fiber composite).

61. The ceramic foam-fiber composite of claim 54, wherein the ceramic foam further comprises nanoparticles disposed on at least a portion of a surface of the ceramic foam.

62. The ceramic foam-fiber composite of claim 54, wherein the ceramic foam-fiber composite is a monolith, a free-standing film, or a film disposed on at least a portion of or all of a substrate, wherein the free-standing film or the disposed film has a thickness of 4 inch to 2 inches.
